(19) United States
(12) Patent Application Publication
(10) Pub. No.: US 2004/0245317 A1
(43) Pub. Date: Dec. 9, 2004

(54) Artificial chromosomes that can shuttle between bacteria yeast and mammalian cells

(76) Inventors: Vladimir Larionov, Potomac, MD (US); Natalay Kouprina, Potomac, MD (US); J. Carl Barrett, Rockville, MD (US)

Correspondence Address: NATIONAL INSTITUTE OF HEALTH, C/O NEEDLE & ROSENBERG, P.C., SUITE 1000, 999 PEACHTREE STREET, ATLANTA, GA, 30303, US

(21) Appl. No.: 10/474,070

(22) PCT Filed: Apr. 8, 2002
(86) PCT No.: PCT/US02/10990

(30) Foreign Application Priority Data
Apr. 6, 2001 (US) 60282010

(51) Int. Cl. B23K 1/00

(52) U.S. Cl. 228/101

(57) ABSTRACT

Disclosed are artificial chromosomes based on centromeric sequences having specific alphoid repeats and alpha satellites.

### I. CROSS REFERENCE TO RELATED APPLICATION

This application claims priority to U.S. application Ser. No. 60/282,010, filed Apr. 6, 2001, which is hereby incorporated in its entirety.

### II. STATEMENT OF GOVERNMENT RIGHTS

This invention was made with government support provided National Institutes of Health The government has certain rights in the invention.

### III. BACKGROUND OF THE INVENTION

Successful development of a Human Artificial Chromosome (HAC) cloning system would have profound effects on human gene therapy and on our understanding of the organization of human centromeric regions and a kinetochore function. Efforts so far to produce HACs have involved two basic approaches: paring down an existing functional chromosome, or building upward from DNA sequences that could potentially serve as functional elements. The first approach utilized telomere-directed chromosome fragmentation to systematically decrease chromosome size, while maintaining correct chromosomal function. The fragmentation has been targeted to both the X and Y chromosome centromere sequences by incorporating homologous sequences into the fragmentation vector. This approach has pared the Y and X chromosomes down to a minimal size of ˜2.0 Mb which can be stably maintain in culture (Heller et al., Proc. Natl. Acad. Sci. USA 93:7125-7130, 1996; Mills et al. Hum. Mol. Genet. 8: 751-761, 1999; Kuroiwa et al., Nature Biotech. 18: 1086-1090, 2000). These deleted chromosome derivatives lost most of their chromosomal arms and up to 90% of their alphoid DNA array. None of the mitotically stable derivatives contained alphoid DNA arrays shorter than ˜100 kb, suggesting that this size block of alphoid DNA alone or along with the short arm flanking sequence is sufficient for a centromere function.

The second approach was based on transfection of human cells by YAC or BAC constructs containing large arrays of alphoid DNA (Harrington et al., Nat. Genet. 15: 345-355, 1997, Ikeno et al., Nature Biotech. 16: 431439, 1998; Henning et al., Proc. Nat. Acad. Sci. 96: 592-597, 1999; Ebersole et al., Hum. Mol. Genet. 9:1623-1631, 2000). Because the formation of HACs was not observed with constructs containing random genomic fragments, these experiments clearly demonstrated an absolute requirement of alphoid DNA for centromere function. In all cases formation of HACs was accompanied by 10-50-fold amplification of YAC/BAC constructs in transfected cells.

Both approaches led to development of cell lines containing genetically marked chromosomal fragments exhibiting a stable maintenance during cell divisions. These mini-chromosomes appear to be linear and about 2-12 Mb in size. An obvious limitation of the systems described above is the large size of HACs that prohibits their cloning and manipulation in microorganisms, rendering transfer to other mammalian cell types difficult. Disclosed herein are methods and compositions which allow for the specific cloning of centromeric regions from mammalian chromosomes. Disclosed are cloned and isolated centromeric regions of human and other mammalian chromosomes. The isolation of these centromeric regions provides for mammalian artificial chromosomes (MACs) capable of being shuttled between bacterial, yeast and mammalian cells, such as human cells. The isolation of a functional centromere from centromeric regions of human chromosomes, including the mini-chromosome ΔYq74 containing 12 Mb of the Y human chromosome (Heller et al., Proc. Natl. Acad. Sci. Usa 93:7125-7130,1996), and the human chromosome 22, is disclosed. The centromeric regions were isolated from total genomic DNA by using a novel protocol of Transformation-Associated Recombination (TAR) in yeast technique which is disclosed herein. TAR is a cloning technique based on in vivo recombination in yeast (Larionov et al., Proc. Natl. Acad. Sci. USA 93:13925-13930,1996; Kouprina et al., Proc. Natl. Acad. Sci. USA 95: 4469-4474,1998; Kouprina and Larionov Current protocols in Human genetics 5.17.1-5.17.21,1999). These MACs provide useful vehicles for the delivery and expression of transgenes within cells and as tools for the isolation and characterization of genes and other DNA sequences.

### IV. SUMMARY OF THE INVENTION

In accordance with the purposes of this invention, as embodied and broadly described herein, this invention, in one aspect, relates to a mammalian artificial chromosome which in one embodiment can be represented by the structure Y-X-Z-Y.

These mammalian chromosomes function much like natural chromosomes in that they replicate and segregate appropriately during the cell cycle. As discussed below these MACs can contain DNA that is expressed within a cell. The MACs can also be configured with sequences that allow them to function as bacterial artificial chromosomes (BACs) as well as sequences that allow them to function as yeast artificial chromosomes (YACs). Thus, specialized shuttle vectors, which allow the artificial chromosomes to be replicated and segregated in either mammalian cells, such as human cells, bacterial cells, and yeast cells are disclosed.

The mammalian artificial chromosome can act as a shuttle vector which can be shuttled between BACs, YACs, and MACs, in any or all combinations.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### V. BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 shows a schematic of a selective isolation of a centromeric region by a TAR vector with a counter-selectable marker. An ARS element is included into a TAR vector containing the HIS3 selectable marker, CEN as a yeast centromeric region, and two targeting sequences (Sat). To avoid a high background resulting from re-circularization of an ARS-containing vector during yeast transformation (Noskov et al., Nucleic Acids. Res., 29(6):e32 (2001) a counter-selectable marker, SUP11, was included between specific targeting sequences in the vector. SUP11 encodes an ochre suppresses tRNA and as it was shown by, even one copy of the gene is highly toxic for a prion-containing (psi-plus) yeast strain. As a consequence, autonomously replicating plasmids carrying SUP11 transform yeast cells very poorly. In addition, SUP11 suppresses an ade2-101 mutation in a host strain. Ade2-101 cells are red while in the presence of SUP11 they are white. Homologous recombination between the targeting sequences and human centromeric DNA would result in generation of a circular YAC accompanied by a loss of the SUP11 sequence. Colonies with such YACs should be red. These two phenotypes caused by a loss of SUP11 provide a selectivity of isolation of human centromeric regions.

FIG. 2 shows a schematic of the macrostructure repeating unit that makes up the centromere region isolated from human chromosome Y.

FIG. 3 shows a sequence comparison of the 34 alpha satellites that make up a part of the repeating unit of the chromosome Y centomeric DNA. The homologies and identity of these sequences are disclosed within this figure, by looking at the variation between the various sequences. See SEQ ID NOs: 4-37.

FIG. 4 shows the sequence of the 1.6 kb minor Spe I fragment of the ΔYq74 alphoid DNA region. The junction between tandem and inverted repeats is shown by underlined letters. The sequence is read 5′ to 3′. See SEQ ID NO: 1.

FIG. 5A shows a phylogenetic tree for 30 sequences of the about 170 base alpha satellite sequences that make up the main Spe I fragments of the ΔYq74 alphoid region of the Y chromosome. FIG. 5B shows a phylogenetic tree for 30 sequences of the about 170 base alpha satellite sequences that make up the main alphoid region of chromosome 22.

FIG. 6 shows the sequence of the pVC-sat vector used for TAR cloning of centromeric regions and alphoid repeat DNA. The sequence is read 5′ to 3′. See SEQ ID NO: 51.

FIG. 7 shows the sequence of the 2.9 kb major fragment of the SpeI digestion of the chromosome Y alphoid region. The sequence is read 5′ to 3′. See SEQ ID NO:3.

FIG. 8 shows the sequence of the 2.8 kb major fragment of the SpeI digestion of the chromosome Y alphoid region. The sequence is read 5′ to 3′. See SEQ ID NO:2.

FIG. 9A shows comparison of alphoid DNA units from alphoid DNA array isolated from the Y chromosome. These repeat units were selected from the beginning of five 2.9 kb alphoid DNA unit (SpeI fragment). The sequences are read 5′ to 3′.

FIG. 9B shows a comparison of 4 inverted repeat units from the 1.6 kb alphoid DNA unit of the Y chromosome.

FIG. 10 shows how a 2.8 kb Y chromosome alphoid DNA unit was sequenced. There are a lot of base changes in the repeats resulting in a loss or generation of new restriction sites. This polymorphism helped to read through all repeats in the units.

FIG. 11 shows how a 2.9 kb Y chromosome alphoid DNA unit was sequenced. There are a lot of base changes in the repeats resulting in a loss or generation of new restriction sites. This polymorphism helped to read through all repeats in the units.

FIG. 12 shows the orientation of the 34 alpha satellites that make up the 5.7 kb I EcoRI fragment of the chromosome Y alphoid region. Comparison of these units are shown in FIG. 3.

FIG. 13 shows two color FISH of BACs (Spectrum Orange) and (Spectrum Geeen) to normal human metaphase hybridization of both probes to centromere of chromosome 22. Fiber FISH using the same probes (bottom) demonstrates and overlap of BACs and presence of two separate tandem blocks. FIG. 14 shows a gel indicating that alphoid DNA arrays isolated from chromosome 22 consist of two main units, 2.1 kb and 2.8 kb.

FIG. 15 shows a FISH mapping of TAR isolates from the human chromosome 15.

FIG. 16 shows a schematic of the principal of TAR cloning.

FIG. 17 shows a scheme of retrofitting vectors containing different mammalian selectable markers.

FIG. 18 shows a schematic of the macrostructure repeating unit that makes up the centromere region isolated from chromosome 13.

FIG. 19 shows a schematic of the macrostructure repeating unit that makes up the centromere region isolated from chromosome 22.

FIG. 20 shows different TAR isolates of alphoid DNA arrays from chromosome 22. EcoRI digestion of BAC DNAs identifies the presence of regular and unregular blocks of alphoid DNA in the centromeric region of this chromosome.

FIGS. 21A and 21B show FISH analysis of metaphase chromosome spreads of HAC cell line generated with the chromosome 22 alphoid HAC construct. Position of HAC (shown by arrow) was detected loose on co-localization of the 22 alphoid DNA probe and vector probe (i.e., BAC vector used for cloning of alphoid DNA array), which colocolize at minichromosome (shown by arrow).

FIG. 22 shows a digestion of the BACs by SpeI that produced two fragments with size 2.8 kb and 2.9 kb.

FIG. 23 shows the position of the Autonomously Replicating Sequence (ARS) within the alphoid DNA array isolated from human chromosome 22. This alphoid DNA array can form artificial chromosomes in human cells (as shown in FIG. 21). The ARS consensus that is required to initiate DNA replication in yeast is shown on the top.

### VI. DETAILED DESCRIPTION

The present invention may be understood more readily by reference to the following detailed description of preferred embodiments of the invention and the Examples included therein and to the Figures and their previous and following description.

Before the present compounds, compositions, articles, devices, and/or methods are disclosed and described, it is to be understood that this invention is not limited to specific synthetic methods, specific recombinant biotechnology methods unless otherwise specified, or to particular reagents unless otherwise specified, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

In this specification and in the claims which follow, reference will be made to a number of terms which shall be defined to have the following meanings:

“Optional” or “optionally” means that the subsequently described event or circumstance may or may not occur, and that the description includes instances where said event or circumstance occurs and instances where it does not.

Reference will now be made in detail to the present preferred embodiments of the invention, an examples of which is are illustrated in the accompanying drawings. Wherever possible, the same reference numbers are used throughout the drawings to refer to the same or like parts.

A. Compositions

Disclosed are mammalian artificial chromosomes comprising the structure Y-X-Z-Y, wherein the mammalian artificial chromosome can be shuttled between bacteria, yeast, or mammalian cells without alteration of the mammalian chromosome. Also disclosed are mammalian artificial chromosomes comprising the structure Y-X-Z-Y, wherein Z comprises a sequence less than about 250 kb and which is capable of correctly segregating the mammalian artificial chromosome. Also disclosed are mammalian artificial chromosomes wherein Z further comprises a sequence less than about 150 kb. Mammalian artificial chromosome of wherein Z further comprises a sequence less than about 100 kb are also disclosed.

Disclosed are mammalian artificial chromosomes wherein Z comprises an inverted repeat sequence having at least 80% identity to SEQ ID NO: 1.

Disclosed are mammalian artificial chromosomes wherein Z comprises a nucleic acid sequence that lacks a functional CENP-B box sequence.

Disclosed are mammalian artificial chromosomse, wherein Z further alphoid DNA. Also disclosed are mammalian artificial chromosomes, wherein the alphoid DNA is derived from the chromosome 22 centromere and the Y-chromosome centromere.

Disclosed are mammalian artificial chromosomes, wherein the alphoid DNA consists of 12, 16, 23, 28 or 34 alpha satellite repeats.

Disclosed are mammalian artificial chromosomes comprising the structure Y-X-Z-Y, wherein Z comprises an inverted repeat sequence.

Disclosed are mammalian artificial chromosomes comprising the structure Y-X-Z-Y, wherein Z comprises a nucleic acid sequence that lacks a functional CENP-B box sequence.

Disclosed are shuttle vectors comprising the disclosed mammalian artificial chromosomes which can be shuttled between BACs, YACs, and MACs, in any or all combinations.

Also disclosed are methods for isolating repeat sequence comprising using a TAR cloning method further comprising a selectable marker for non-insert recombinants and sequence capable of hybridizing to the target repeat sequence.

Also disclosed are cloning vectors comprising alphoid specific DNA hooks and a marker which indicates whether the vector has recombined with the target sequence or has recombined with itself.

Disclosed are mammalian artificial chromosomes (MAC). These mammalian chromosomes function much like natural chromosomes in that they replicate and segregate appropriately during the cell cycle. As discussed below these MACs can contain DNA that is expressed within a cell. The MACs can also be configured with sequences that allow them to function as bacterial artificial chromosomes (BACs) as well as sequences that allow them to function as yeast artificial chromosomes (YACs). Thus, specialized shuttle vectors, which allow the artificial chromosomes to be replicated and segregated in either mammalian cells, such as human cells, bacterial cells, and yeast cells are disclosed.

1. Mammalian Artificial Chromosomes

The disclosed MACs consist of a number of different parts and can range in size. The disclosed MACs also have a number of properties and characteristics which can be used to describe them. MACs would include for example, artificial chromosomes capable of being used in humans, monkeys, apes, chimpanzees, bovines, ovines, ungulates, murines, mice, and rat.

a) Size

The size of the MACs is dictated by, for example, the size of the parts that are required for the MAC to function as a MAC and the size of the parts which are make up the MAC, but which are not required for the MAC to function as a MAC. The size is also dictated by how the MACs are going to be used, for example whether they will be shuttled between bacterial and/or yeast cells. Typically the MACs will range from about 1 mega bases to about 10 mega bases. They can also range from about 10 kb to about 30 mega bases bases. They can still further range from about 50 kb to about 12 mega bases or about 100 kb to about 10 mega bases or about 25 kb to about 500 kb or about 50 kb to about 250 kb or about 75 kb to about 200 kb or about 85 kb to about 150 kb.

Typically if the MACs are going to be shuttled between mammalian and bacterial cells they should be less than 300 kb in size. This type of MAC can also be less than about 750 kb or about 600 kb or about 500 kb or about 400 kb or about 350 kb or about 250 kb or about 200 kb or about 150 kb. If the MACs are going to be shuttled between mammalian and yeast cells they are typically less than 1 mega base in size. This type of MAC can also be less than about 5 mega bases or about 2.5 mega bases or about 1.5 mega bases or about 900 kb or about 800 kb or about 700 kb or about 600 kb or about 500 kb or about 400 kb or about 400 kb or about 200 kb or about 100 kb.

The size of the MACs is described in base pairs, but it is understood that unless otherwise stated, these numbers are not absolutes, but rather represent approximations of the sizes of the MACs. Thus, for each size of the MAC described it is understood that this size could be “about” that size. There is little functional difference between a nucleic acid molecule of 1,500,000 bases and one that is 1,500, 342 bases. Those of skill in the art understand that the sizes and ranges are given as direction, but do not necessarily functionally limit the MACs.

b) Form

The disclosed MACs can take a variety of forms. The form of the MAC refers to the shape of the artificial chromosome. The parts of the MAC that are required for the MAC to function depend on the form that the MAC takes. Thus, is when designing MACs as disclosed it is important to be aware of what form the MAC will take inside of the target cell.

(1) Linear

MACs can be linear. A linear MAC is an artificial chromosome that has the form or shape of a natural chromosome. This type of MAC has “ends” to the chromosome, much like most naturally occurring chromosomes. When a MAC is a linear MAC it must have telomeres. Telomeres are specialized purine rich sequences that are thought to protect the ends of a chromosome during replication, segregation, and mitosis. Telomere sequences and uses are well known in the art and are discussed below.

(2) Circular

The disclosed MACs can also be circular. Circular MACs do not have a “beginning” or “ending,” rather they are connected. There is no terminus to a circular MAC. When a MAC is circular, it does not need telomere sequence because there is no end of the chromosome that must be protected during replication, segregation, and mitosis. A circular MAC may contain telomere sequence so that if it is linearized it can function as a linear MAC, but the telomere sequence is not required for the circular MAC to function.

c) Content

The content of the MACs is varied. The content can be characterized by sequence, requisite parts, size, and function. The content of the MACs depends on a number of things, for example, the form that the MACs will take, whether the MACs are going to be shuttled between bacterial and/or yeast cells, and the type of mammalian cell that the MAC will target. A general formula for the disclosed MACs is Y-X-Z-Y which represents the three parts of a MAC which must be required if the MAC is linear. If the MAC is circular, the formula for the required parts is X-Z. In this formula X represents an origin of replication. Z represents a centromeric region, or a region capable of ordering and segregating the artificial chromosome appropriately during a cell cycle. Y represents teleomeric sequence. When the MAC takes the form of a circular chromosome, Y is not required. Each of these parts has specific characteristics, properties, and requirements which are discussed below.

(1) Y-X-Z-Y

The Y-X-Z-Y nomenclature is used for ease of understanding of the structure of the MACs. While the functions provided by each part are necessary in each MAC or in each MAC their function must specifically be accounted for by, for example circularizing the MAC, the nomenclature is not intended to imply that the structure of the MAC always must be or arise from separate parts. If all of the functions are contained in one of the parts these MACs are an embodiment of the disclosed MACs. For example, as discussed in Example 1 the origin of replication and centromeric function are contained in the mammalian alphoid constructs used in the MACs and because the MACs are circular, they do not require a telomere sequence, but yet they function as MACs and these are considered an embodiment of the disclosed MACs.

(a) X Part—Origin of Replication

In the Y-X-Z-Y formula for a MAC X represents an origin of replication. Origins of replication are regions of DNA from which DNA replication during the S phase of the cell cycle is primed. While the origins of replication, termed autonomously replicating sequence (ARS) are fully defined in yeast (Theis et al. Proc. Natl. Acad. Sci. USA 94: 10786-10791.1997) there does not appear to be a specific corresponding origin of replication sequence in mammalian DNA. Grimes and Cooke, Human Molecular Genetics, 7(10):1635-1640 (1998) There are, however, numerous regions of mammalian DNA which can function as origins of replication. (Schlessinger and Nagaraja, Ann. Med., 30:186-191 (1998); Dobbs et al., Nucleic Acids Res. 22:2479-89 (1994); and Aguinaga et al., Genomics 5:605-11 (1989)). It is known that for every 100 kb of mammalian DNA sequence there is a sequence that will support replication, but in practice sequences as short as 20 kb can support replication on episomal vectors. Calos, Trends Genet. 12:463-66 (1996). This data indicates that epigentic mechanisms, such as CpG methylation patterning likely play some role in replication of DNA. Rein et al., Mol. Cell. Biol. 17:416-426 (1997).

(i) Size

The X-part of the disclosed MACs can be any size that supports replication of the MAC. One way of ensuring that the MAC has a functional X sequence is to require that the Y-X-Z-Y contain at least 5 kb of mammalian genomic DNA. In other embodiments the Y-X-Z-Y structure contains at least 10 kb, 15 kb, 20 kb, 25 kb, 30 kb, 35 kb, 40 kb, 45 kb, 50 kb, 60 kb, 70 kb, 80 kb, 90 kb, or 100 kb of mammalian genomic DNA. In general any region of mammalian DNA could be used as origin of replication. If you have replication of the MAC then the origin of replication is functioning as desired.

(ii) Source

The X-part of the Y-X-Z-Y MAC can be obtained from any number of sources of mammalian DNA. In general it can be any region of mammalian DNA that is not based on a repeat sequence, such as the alphoid DNA sequence

Typically an alphoid sequence of DNA does not have origins of replication in it, because the repeat sequences are so small, for example about 170 base pairs, and which can be repeated many times that there is not enough variation for the origin of replication sequences to be present. However, based on the disclosed compositions, these regions can function as origins of replication in mammalian, such human, cells.

(b) Z-part—Centromere Region

The Z-part of the Y-X-Z-Y MAC represents a centromere region. It is understood that a centromere region, broadly defines a functional stretch of nucleic acid that allows for segregation of the MAC during the cell cycle and during mitosis. This region can be isolated using the methods described herein, or can now be engineered based on the information obtained from the cloned natural centromere regions. For example, the centromere region can now be obtained from a Y chromosome or chromosome 22. It is understood that each chromosomal centromere region has unique properties, however, each region also has properties and structural features in common with the other centromeric regions. In some embodiments, the disclosed MACs contain Z-parts that are derived from specific centromeric regions, and in other configurations the MACs contain Z-parts that are made up of the common elements, shared between the centromeres isolated from different chromosomes. The Z-parts can be characterized by their size, by their content, function, and by their origin, for example.

(i) Source

One way to determine the size of the Z-part is to look at what gets cloned from specific centromeric regions. The Z-part is not limited to what is cloned from a centromeric region, but this is one way to describe and certainly to obtain the Z-part. For example, starting with the mini chromosome generated by Brown et al. (Brown et al., Human Molec Gen., 3(8):1227-1237 (1994)) using one of the vectors disclosed herein alphoid regions derived from the Y chromosome have been isolated. Regions, of 250 kb, 170 kb, and 100 kb have been isolated.

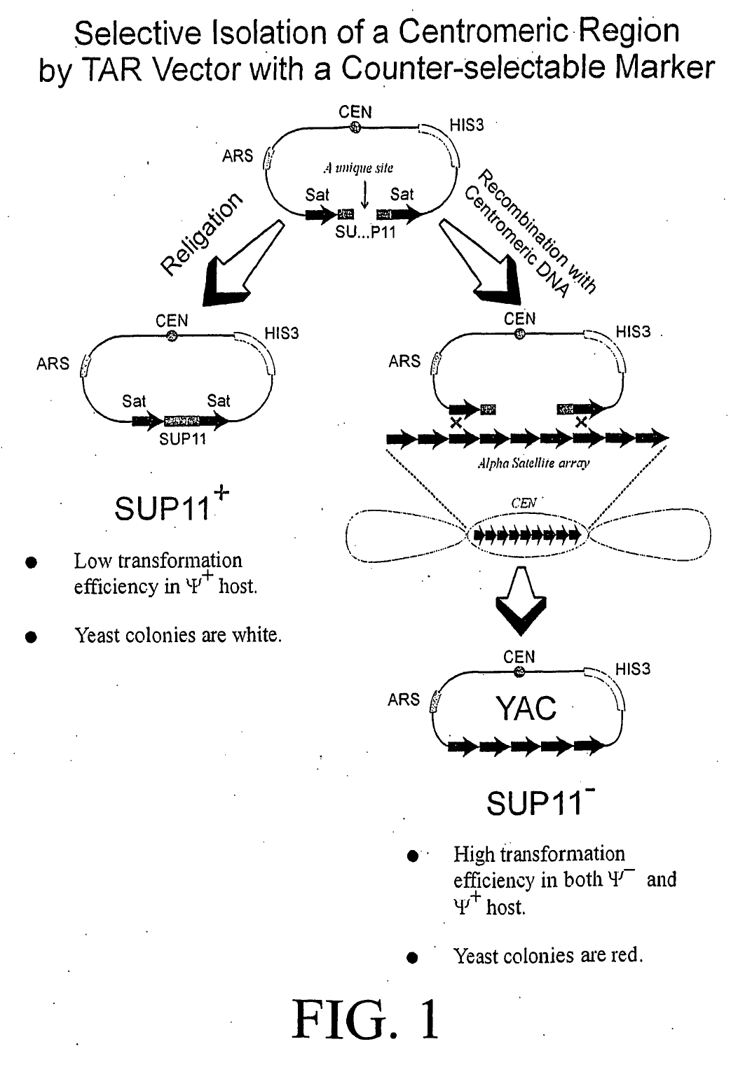

Z-part regions have also been isolated from a number of other chromosomes. For example, regions have been isolated from chromosomes 2, 10, 11, 13, 15, 21, and 22. See Table 1. Table 1 characterizes, by size, YAC clones obtained with a disclosed TAR vector containing alphoid DNA as the targeting sequences. The clones were isolated by a TAR cloning system based on a counter-selectable marker as described in FIG. 1 and Example 1. Table 1 shows that the regions isolated from the various chromosomal centromeres can vary in size. For example, various size fragments from a centromeric region of the chromosome 22 have been isolated. These fragments either contain different size blocks of alphoid DNA or alphoid DNA and non-alphoid DNA from pericentromeric regions. Isolation of YACs containing different regions of a centromere would allow to clarify what sequences are critical for efficient MAC formation

TABLE 1
Characterization of YAC Clones Obtained with a TAR Vector Containing
Alphoid DNA as Targeting Sequences

| | | | YAC end | |
|---|---|---|---|---|
| YAC | SIZE | FISH | Sequences | BAC size |
| Chr22#3 | 50 kb | Nd | | 50 kb |
| Chr22#5 | 140 kb | chr22/CEN | 3-5 satellites | 80 kb |
| | | | (EcoR1) | |
| Chr22#6 | 120 kb | chr22/CEN | | 120 kb |
| Chr22#9 | 90 kb, 170 kb | chr22/CEN | | 110 kb |
| Chr22#10 | 80 kb | nd | | 80 kb |
| Chr22#11 | 60 kb, 140 kb | chr22/CEN | | 140 kb |
| Chr22#14 | 50 kb, 100 kb, | chr22/CEN | | 70 kb |
| | 200 kb | | | |
| Chr22#15 | 100 kb | chr22/CEN | | 100 kb |
| Chr22#19 | 70 kb | chr22/CEN | | 110 kb |
| Chr22#20 | 60 kb | nd | | 60 kb |
| Chr22#29 | 70 kb, 200 kb | chr22/CEN | 3-4 satellites | 180 kb |
| | | | (EcorR1) | |
| Chr22#35 | 60 kb | chr22/CEN | | 60 kb |
| Chr22#11 | 60 kb, 100 kb | chr22/CEN | | 100 kb |
| Chr11#2 | 75 kb, 150 kb, | chr11/CEN | 4-3 satellites | 150 kb |
| | 400 kb | | (EcorR1) | |
| MRC5#8 | 75 kb | nd | | nd |
| MRC5#11 | 140 kb | chr8/CEN | | 120 kb |
| MRC5#13 | 140 kb, 220 kb, | chr13, 21/CEN | 2—2 satellites | 140 kb |
| | 270 kb | | (EcoR1) | |
| MRC5#16 | 90 kb | nd | | nd |
| MRC5#25 | 220 kb | chr2/CEN | | 220 kb |
| MRC5#26 | 140 kb | chr15/CEN | | 120 kb |
| MRC5#41 | 120 kb | nd | | nd |
| MRC5#59 | 150 kb | chr5/CEN, | | 150 kb |
| | | 19/CEN | | |

(ii) Size

The size of the Z-part can range from very small (for example about 1.6 kb) to very large (for example, about 500 kb). The size of the Z-part is determined by whether the Z-part is capable of causing the MAC to appropriately segregate the MAC during the cell cycle.

The size of the Z-part can range from about 170b to about 10 mega bases. The size of the Z-part can range from about 1.6 kb to about 4 kb, 2.8 kb to about 4 mega bases, 2.9 kb to about 4 mega bases, 5.7 mega bases to about 4 mega bases, 20 kb to about 1 mega base, 40 kb to about 1 mega base kb, 60 kb to about 1 mega base. In some embodiments the ranges can be from about 70 kb to about 200 kb, about 250 kb to about 600 kb, or about 150 kb to about 300 kb, or from about 100 to 250 kb. In some embodiments the Z-part can be less than or equal to about 300 kb between because MACs of such size can be shuttled between bacterial, yeast and mammalian and can be used as a gene delivery system. In some embodiments the MACs are less than or equal to about 550 kb or about 500 kb or about 450 kb or about 400 kb or about 350 kb or about 300 kb or about 250 kb or about 225 kb or about 200 kb or about 175 kb or about 150 kb or about 125 kb or about 100 kb or about 95 kb or about 90 kb or about 85 kb or about 80 kb or about 75 kb or about 70 kb or about 65 kb or about 60 kb or about 55 kb or about 50 kb or about 45 kb or about 40 kb or about 35 kb or about 30 kb or about 25 kb or about 20 kb or about 15 kb or about 10 kb or about 5 kb. In some embodiments, the Z-part is about 600 kb, about 300 kb, about 260 kb, about 250 kb, about 240 kb, about 200 kb, about 150 kb, about 140 kb, about 100 kb, or about 70 kb.

(iii) Content

Another way of characterizing the Z-part of the Y-X-Z-Y MAC is by the content of the Z-part. By content is meant the sequence or other structural attributes that define the Z-part. The Z-parts in some embodiments contain alphoid DNA in general, and in other embodiments contain specific alphoid regions, unique to the particular chromosome they were isolated from. The Z-part could also contain alphoid DNA sequences along with non-alphoid DNA incorporated into alphoid DNA arrays.

(a) Alphoid DNA

Alphoid DNA refers to DNA that is present near all known mammalian centromeres. Alphoid DNA is highly repetitive DNA, and it is made up generally of alpha satellite DNA. Alphoid DNA is typically AT rich DNA and also typically contains CENPB protein binding sites. (Barry et al. Human Molecular Genetics, 8(2):217-227 (1999); Ikeno et al., Nature Biotechnology, 16:431-39 (1998)). While the alphoid DNA of each chromosome has common attributes, each chromosomal centromere also has unique features. For example alphoid DNA of the human chromosome 22 consists of two units 2.1 kb and 2.8 kb. These units can be identify by EcoRI digestion. In the human Y chromosome alphoid DNA arrays consists off two diferent size units, 2.8 kb and 2.9 kb that can be identified by SpeI digestion.

(b) Chromosome Y Alphoid DNA

The centromere defined as ΔYq74 is the alphoid centromeric region that was isolated from the mini chromosome constructed by Brown et al. Human Molec Gen., 3(8):1227-1237 (1994). The isolation and characterization of this region are described in Example 1. This region has a number of attributes, such as inverted repeats and a lack of any consensus CENP-B protein binding sites.

(1) Macrostructure

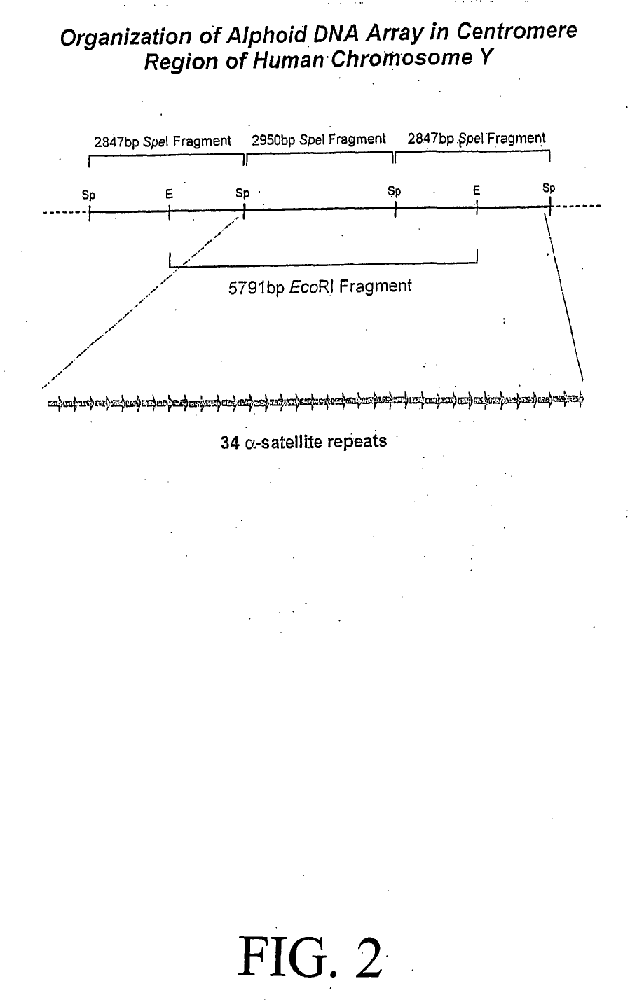

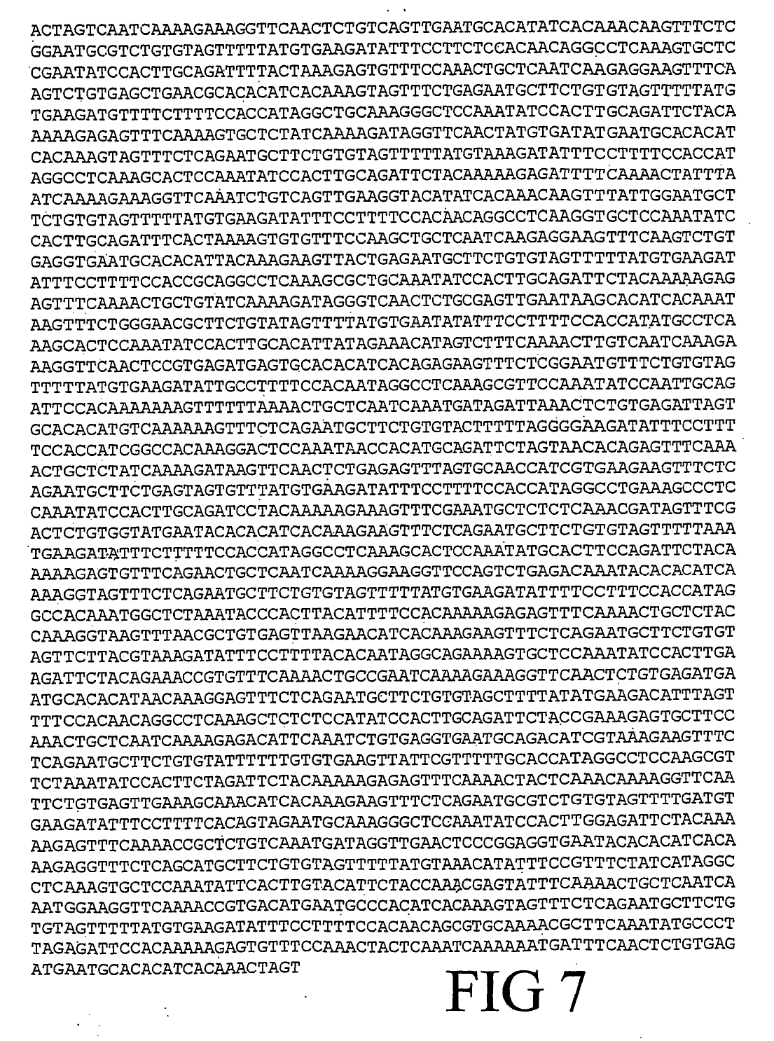

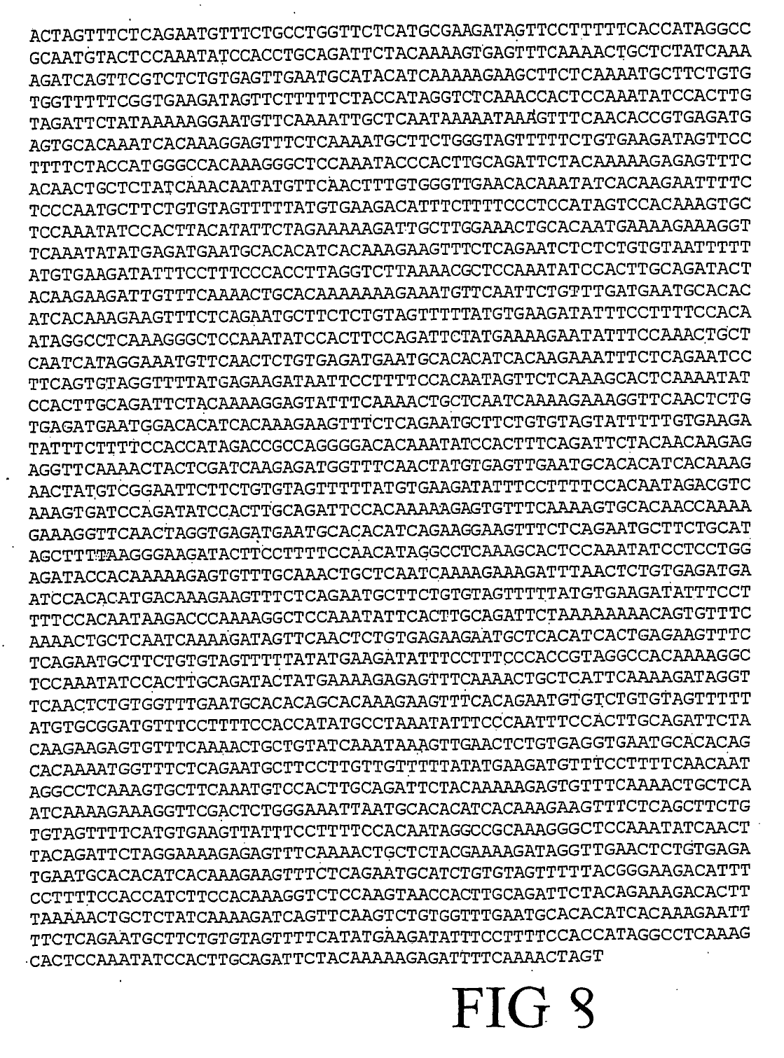

The chromosome Y centromeric region is made up of two repeating units where each repeating unit is represented by a 2950 bp fragment (SEQ ID NO:3 and FIG. 7) and a 2847 bp fragment (SEQ ID NO:2 and FIG. 8) (FIG. 2.). As discussed in Example 1, these fragments that make up the macrostructure of the repeating unit of the chromosome Y alphoid DNA are determined by a Spe I digestion of the isolated alphoid DNA. In the centromeric region each unit is repeated 23 times forming a 140 kb alphoid DNA array. The units are organized as tandem repeats. Each of these fragments itself is made up of a smaller divergent repeating unit This repeating unit is about 170 bases long and is described in detail below. The number of repeating units may vary and is ultimately dependent on the structure needed for appropriate segregation of the HACs. In some embodiments the repeating unit may be as small as one of the specific alpha satellite monomers, and in other embodiments, for example, the size may correspond to one of the major Spe I fragments, such as the 2.8 kb or 2.9 kb fragments. As discussed herein these characteristics may be applicable for other alphoid satellite and centromeric regions, and this is most appropriately determined by the functions of these regions as discussed.

4 Y Chromosome Alpha Satellite Structure

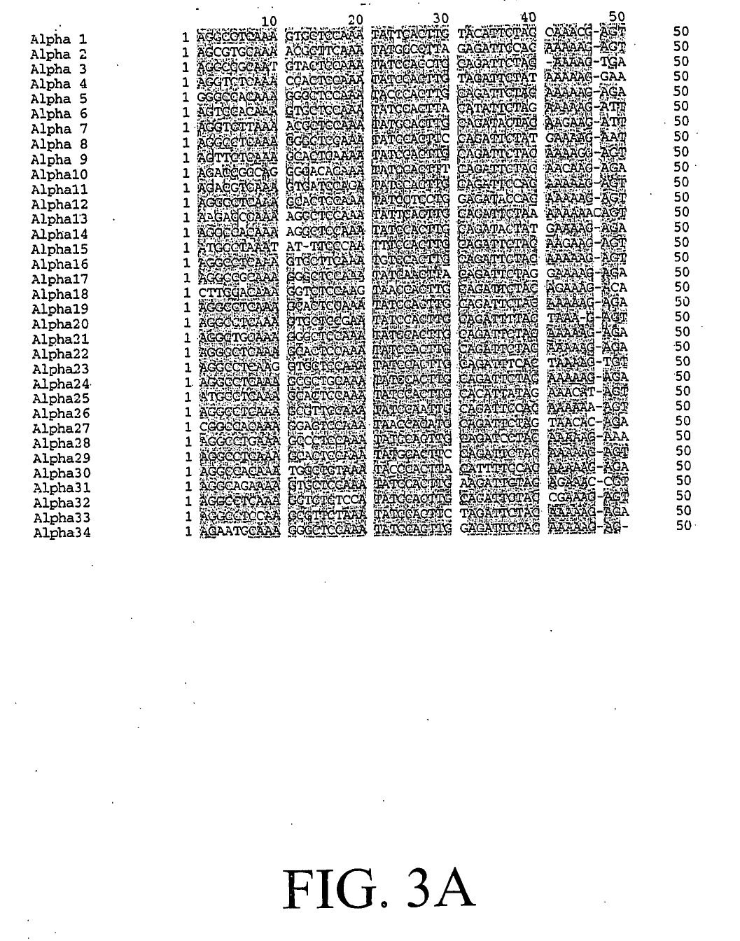

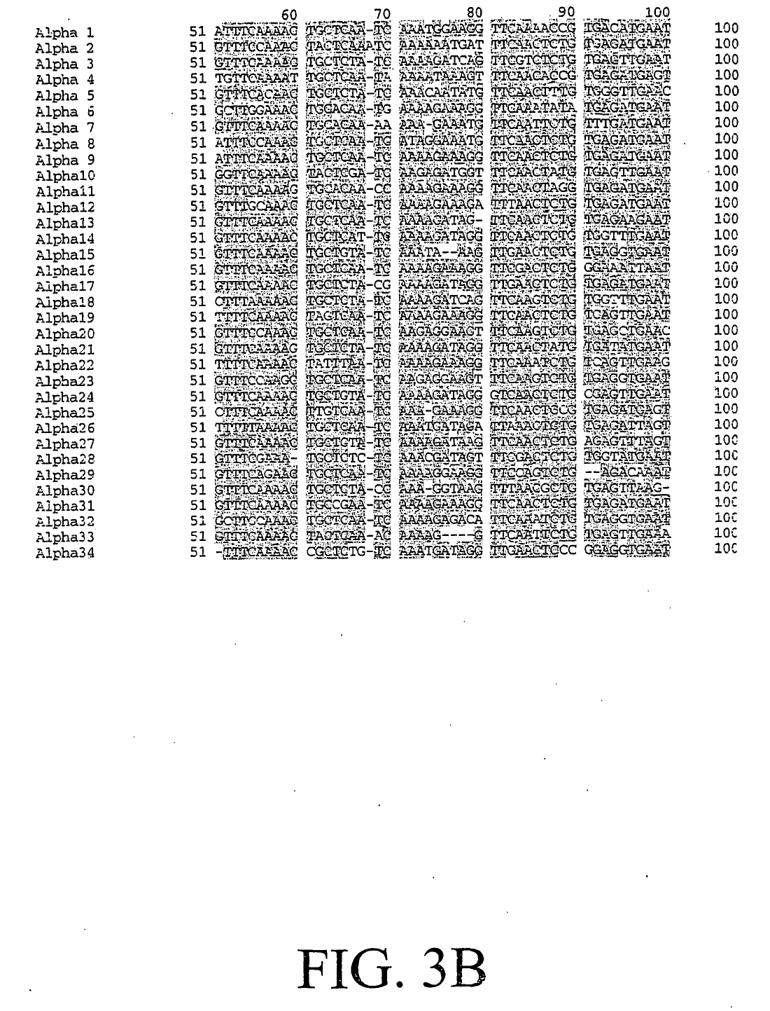

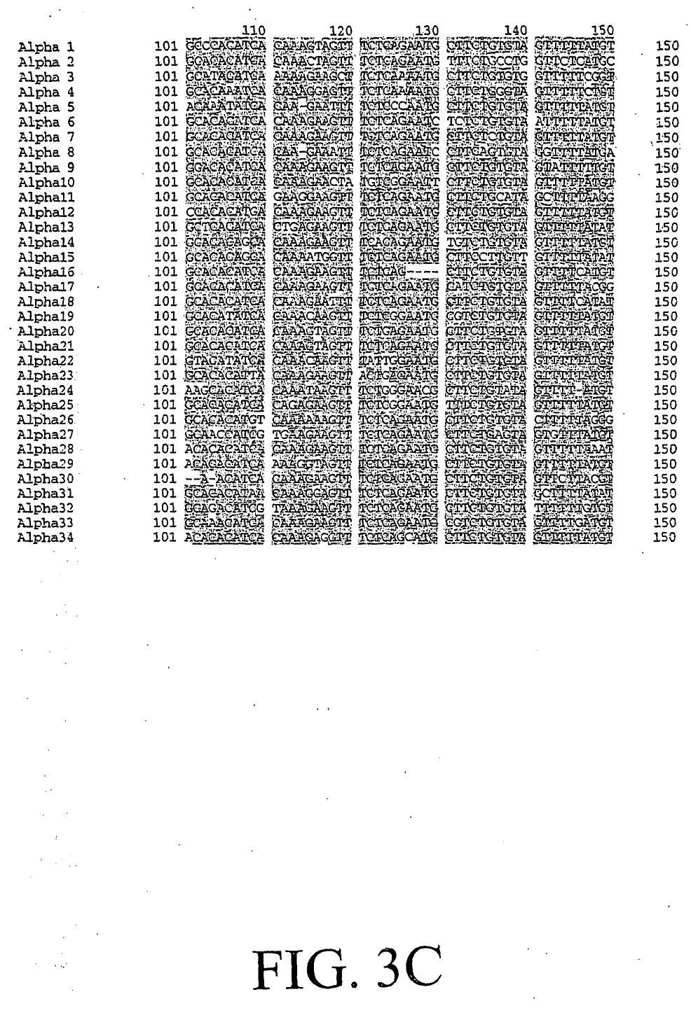

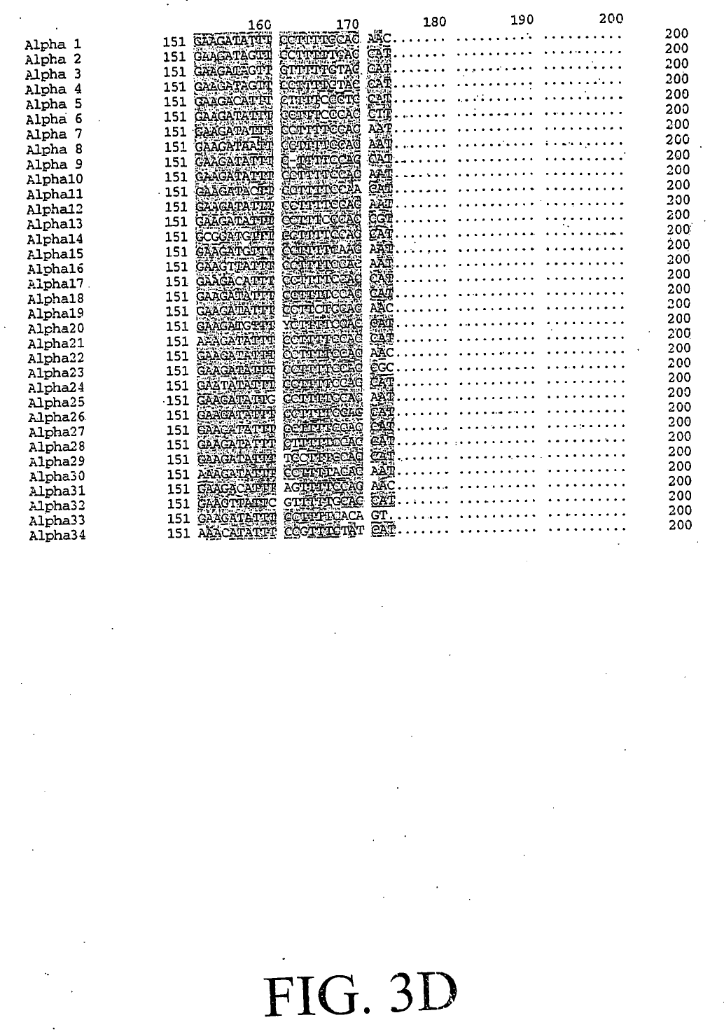

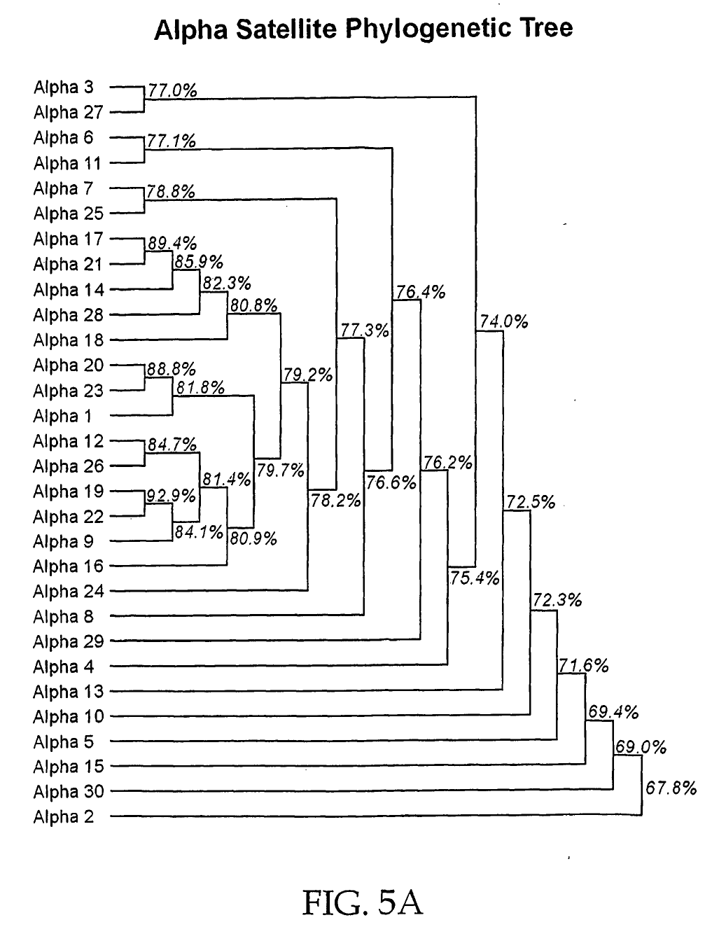

The macrostructure of the Y chromosome centromeric region is made up of a smaller alpha satellite region that is about 170 base pairs. Specifically, one 2950 bp fragment and one 2847 bp fragment in that order are made up of 34 variants of the about 170 bp alpha satellite region. These alpha satellites are number 1-34 and the specific sequence of each of these satellites is shown as SEQ ID NOs: 4-37 respectively and are also shown in comparative form in FIG. 3 and in FIG. 5A. The identity of these sequences amongst each other can be determined by tabulating the variations and similarities of the various sequences. The variation within the sequences represents the divergence that has taken place within these regions.

Identity to the Chromosome Y Sequences

In one embodiment of the MACs, the Z-part of the Y-X-Z-Y MACs is defined by specific levels of identity to the specific alpha satellites defined by SEQ ID NOs: 4-37. For example, in some embodiments the Z-part can have or be greater than or equal to about 99.99%, about 99.95% identity, about 99.90% identity, about 99.80% identity, about 99.70% identity, about 99.60% identity, about 99.50% identity, about 99.40% identity, about 99.30% identity, about 99.20% identity, about 99.10% identity, about 99.00% identity, about 98.00% identity, about 97.00% identity, about 96.00% identity, about 95.00% identity, about 94.00% identity, about 93.00% identity, about 92.00% identity, about 91.00% identity, about 90.00% identity, about 85.00% identity, or about 80.00% identity to any of SEQ ID NO:1-46 or 51-56. The identity of sequences can be compared by looking at the sequence of a given molecule and then comparing it to the sequence of choice, disclosed herein, for example in FIGS. 3 and 5. Embodiments of the disclosed MACs specifically include identities that are greater than about the specific recitations of homology between certain disclosed alpha satellite regions in FIG. 5. For example, FIG. 5 discloses that there is 77.0% homology between alpha satellites 3 and 27, 89.4% homology between alpha satellites 17 and 21. Therefore, MACs having identities of about 89.4% and about 77.0% to SEQ ID NOs:4-37 are disclosed. Also it is understood that the sequence variation between the alpha satellite regions, SEQ ID NOs:4-37, 53 and 54 can be carried through to the larger repeat units that make up the Z-part of the MAC.

1.6 kb structure of ΔYq74 Having Inverted Repeats

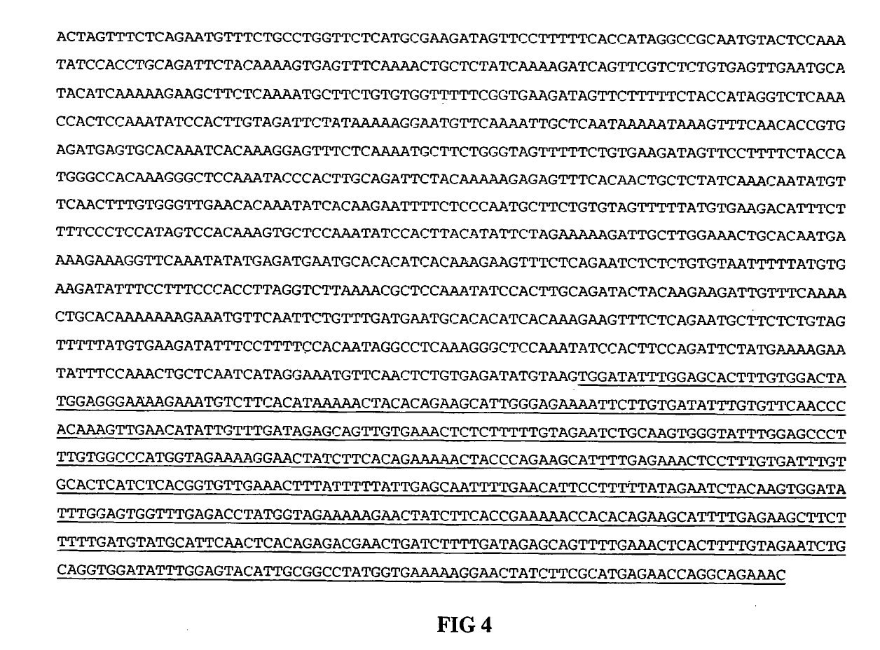

The macrostructure defined by the 2847-2950 repeating unit which can be isolated by a Spe I digestion of the isolated ΔYq74 region is the dominant structure that is present. A minor Spe I product that is shown in FIG. 4 and represented by SEQ ID NO:1 is approximately 1800 bases long. (The fragment moves as 1.6 kb fragment during electrophoresis. An abnormal mobility of the fragment is explained by the presence of palindromic sequence) This minor 1.6 kb fragment contains specific alpha satellite DNA also, but rather than having the alpha satellites arranged in a tandem array as the major repeating unit does, the minor fragment has 6 full alpha satellite repeats which are in tandem and 3 which are inverted repeats. The variation between these repeats can also be defined and each individual repeat is defined in SEQ ID NOs: 38-46. Because this fragment was not detected in normal (i.e. non truncated) chromosome Y, the fragment arose during truncation of the chromosome. It is known that chromosome truncation is often accompanied by rearrangement of the targeted region. These rearrangements occurred near the end of an alphoid DNA array.

No CENP-B Boxes

The chromosome Y centromeric DNA region as well as large blocks of alphoid DNA from chromosome 22 do not have any CENP-B boxes. CENP-B boxes are specific DNA binding sites for the DNA binding protein, CENP-B (Masumoto et al., J. Cell Biol., 109:1963-1973 (1998)). It has been suggested that CENP-B boxes are necessary for centromere function, however, as disclosed here MACs containing the disclosed centromere regions can function without these binding DNA binding protein sites. Thus, in some embodiments the Z-part of the Y-X-Z-Y MAC does not require a functional CENP-B protein binding site, which can be obtained by not having the sequence described as a CENP-B site in the literature.

(c) Other Centromeres

The Z-part can also be derived from the centromeric regions of other chromosomes. These centromere regions can be isolated using the methods and vectors discussed in the Examples.

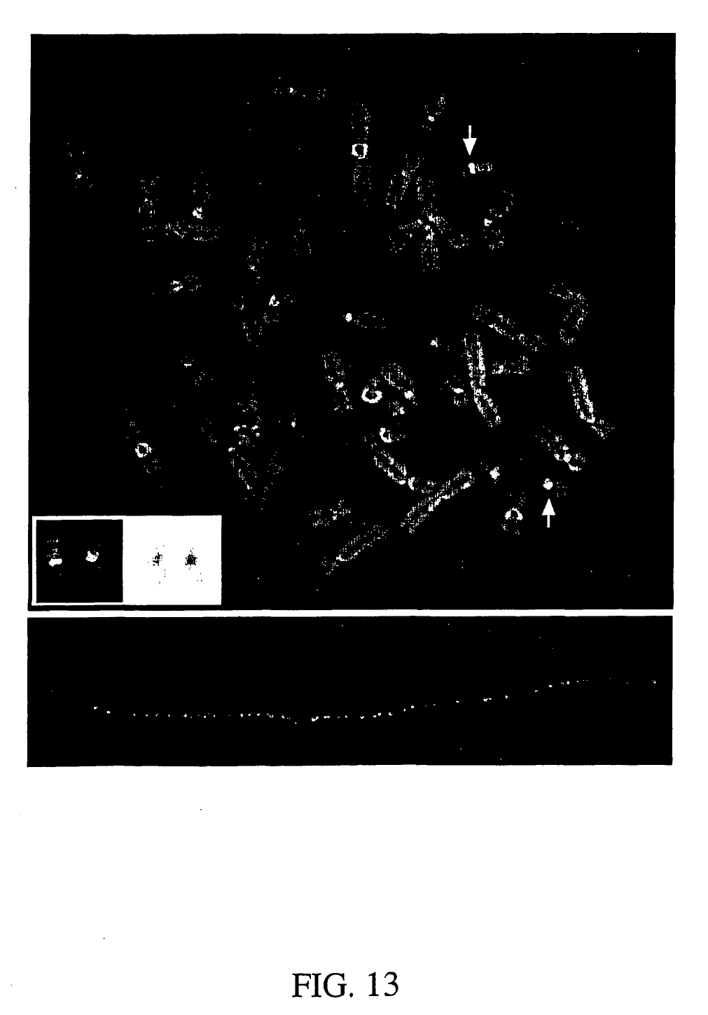

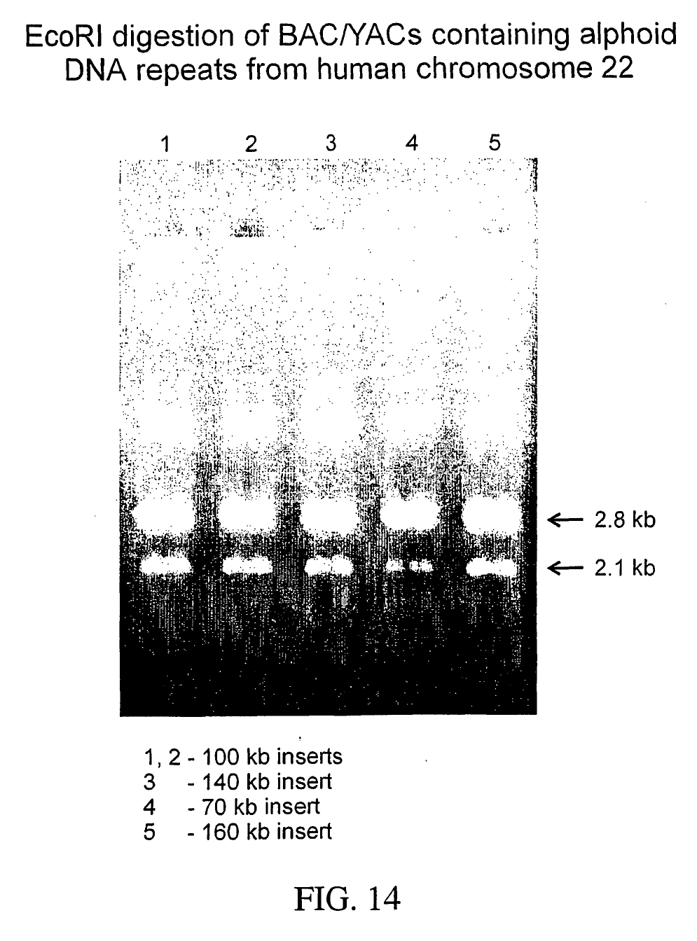

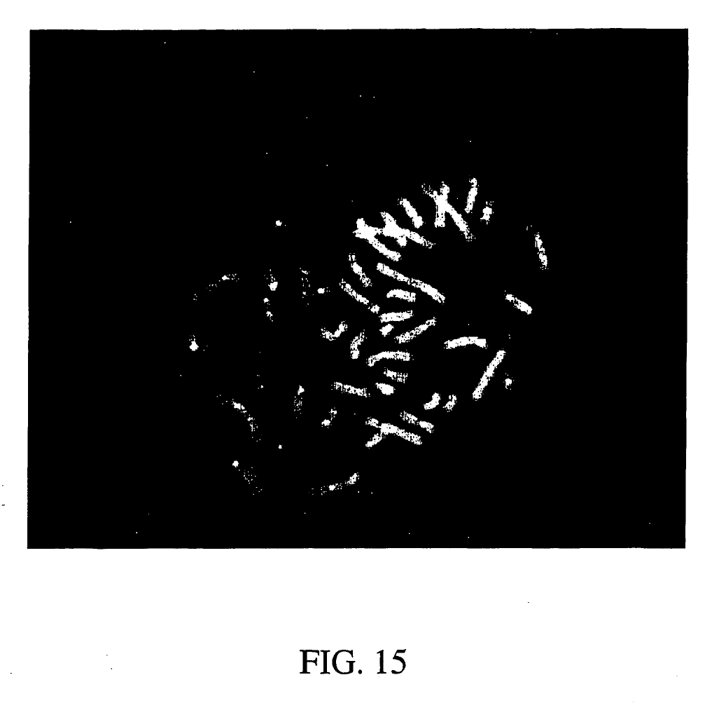

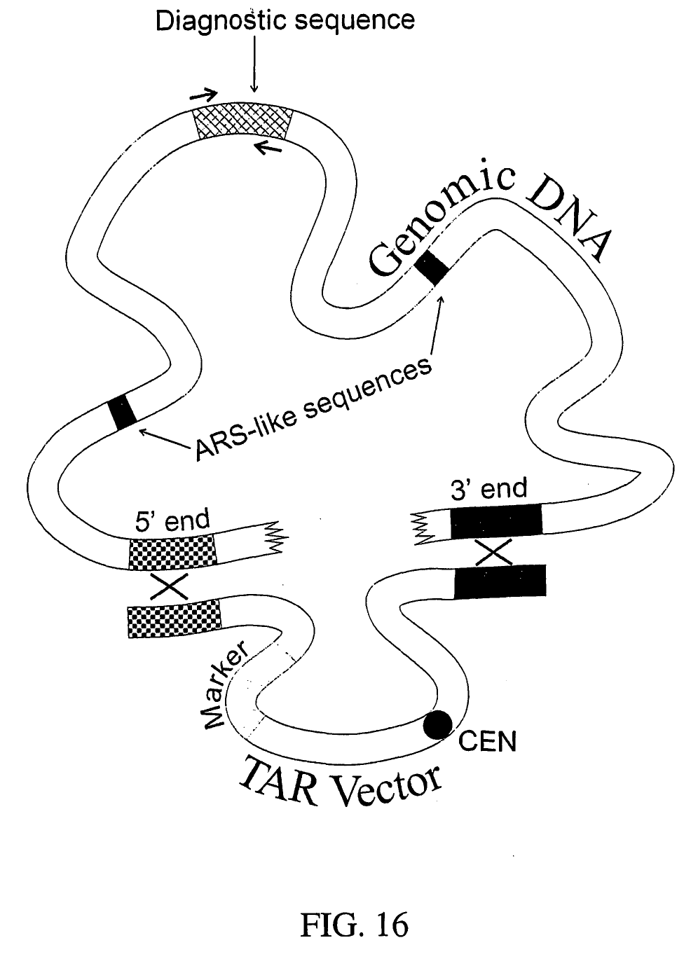

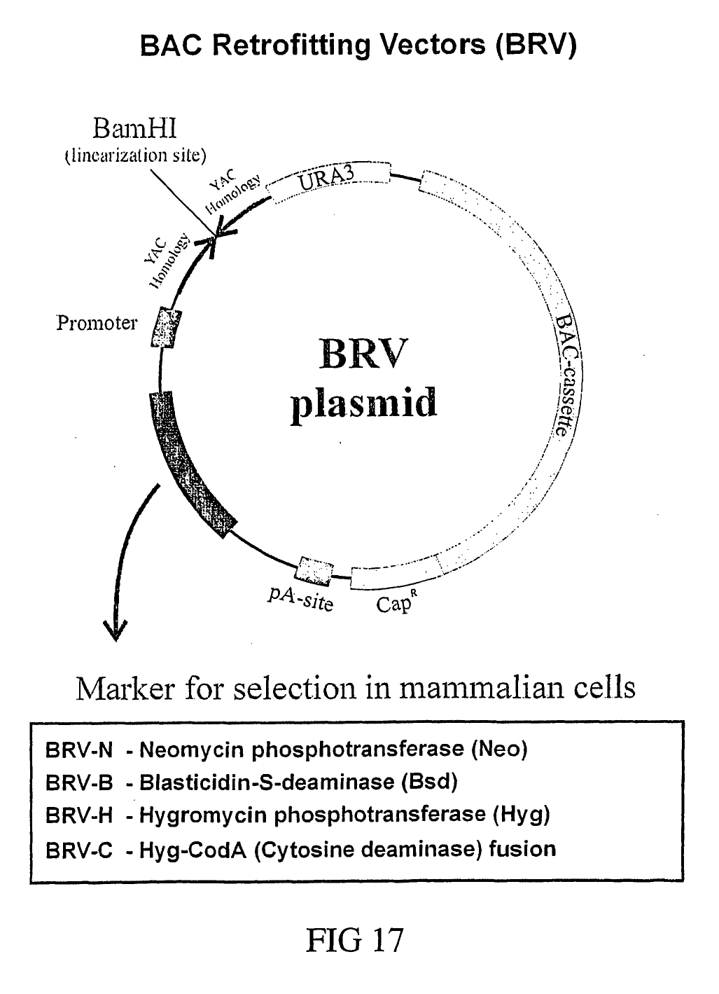

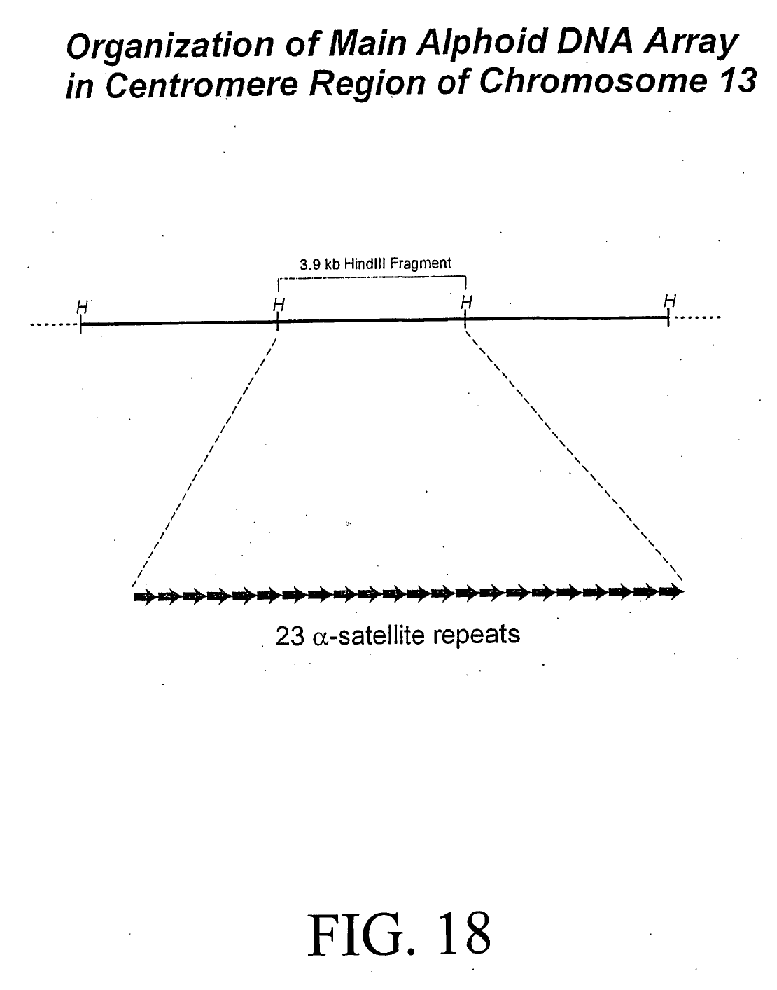

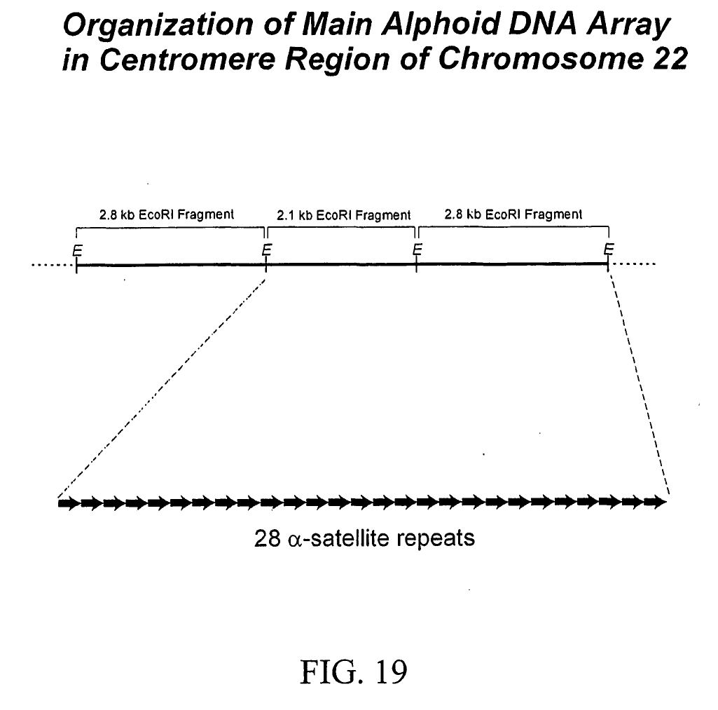

Also disclosed is the isolation of alphoid DNA arrays from non-Y based human chromosomes by TAR cloning. A TAR cloning strategy has also been applied for the isolation of centromeric DNAs from several human chromosomes including chromosome 22, 11, 2, 15, and 13. Consensus alphoid DNA sequences or chromosome-specific alphoid DNA sequences were included into a TAR vector as targeting sequences (hooks). Isolation was highly selective and specific when a SUP11-based counter-selectable marker was included into the TAR vector. Isolation of chromosome-specific alphoid DNA arrays was confirmed by in situ hybridization and restriction analysis of YAC/BAC isolates. FIGS. 13 and 15 show FISH mapping of YACs containing alphoid DNA from two human chromosomes, (chromosome 15 and chromosome 22). Physical mapping data were further confirmed by detailed restriction analysis. An alphoid DNA array of each human chromosome exhibits a specific restriction pattern due to the presence of a chromosome-specific alphoid DNA unit. For example, for chromosome 11 this unit is a 0.8 kb fragment that can be identified by Xba I digestion. For chromosome 2 the unit is a 0.68 kb fragment that can be identified by Xba I digestion. For chromosome 13 the unit is a 3.9 kb fragment that can be identified by Hind III digestion. In the human chromosome 22 there are two units, 2.1 kb and 2.8 kb in size. These units can be identified by EcoRI digestion. FIG. 15 shows digestion of YAC/BACs isolated from chromosome 22 by EcoRI. The restriction profile is specific for chromosome 22, indicating that a TAR cloning procedure provides a powerful tool for selective cloning of centromeric regions. Any of these YAC/BAC isolates can be used for construction of MACs.

In some embodiments alphoid arrays which are derived from either human chromosome 17 or human chromosome 21 are not included in the Z-part of the disclosed MACs. In other embodiments, chromosomes that lack a CENP-B protein binding site are included, and thus, human chromosome 17 and 21 alphoid arrays lacking a CENP-B protein binding site are included, when they function as the disclosed MACs.

The Z-part of the MAC can also be further defined by the function that it performs. This function is related to the appropriate segregation of the MAC of which it is a part during mitosis. Proper segregation is a main function of the centromere. This segregation results in a maintenance of MAC as an extrachromosomal element in a single copy number in transfected cells. Formation of MACs can be detected either by FISH (as an additional chromosome on the metaphase plate) or by immunofluorescence using kinetohore-specific antibodies. Alternatevely the MAC can be rescued by E. coli or yeast transformation if the MAC contains YAC and BAC cassettes.

The main function of the Z-part is to be provide a centromere like activity to the MACs, which means that the MACs are able to appropriately replicate and segregate. Also disclosed, however, are embodiments where the Z-part is also functioning as an origin of replication, i.e. the X-part. Thus, as discussed in the examples, the disclosed alphoid regions, particularly the alphoid regions isolated from the Y chromosome and chromosome 22 can function without a separate origin of replication, or in other words can function as an origin of replication in mammalian cells.

(c) Y part—Telomeres

The Y-part of the Y-X-Z-Y MAC represents the telomere region. Telomeres are regions of DNA which help prevent the unwanted degradation of the termini of chromosomes. The teleomere is a highly repetitive sequence that varies from organism to organsim. For example, in mammals the most frequent telomere sequence repeat is (TTAGGG)ₙ and the repeat structures can be from for example 2-20 kb. The following publications and patents discuss telomeres, telomerase and methods and reagents related to telomers: U.S. Pat. Nos. 6,093,809, 6,007,989, 5,695,932, 5,645,986, 4,283,500 which are herein incorporated by reference.

(2) Additions

The MACs in addition to the required parts, such as a centromere type region and a sequence capable of being replicated can include other sequences. In this situation the MAC is acting much like a vector, as a vehicle for delivery and expression of exogenous DNA in a cell. The added benefit of the disclosed MACs is that they are stably replicated and propagated with the dividing cell. Thus there are a number of additions that be added onto the MACs which either provide a new use for the MAC or which aid in the use of the MAC. A few non-limiting examples of these types of additions are Marker regions, transgenes, and tracking motifs.

(a) Markers

The MACs can include nucleic acid sequence encoding a marker product. This marker product is used to determine if the MAC has been delivered to the cell and once delivered is being expressed. Examples of marker genes are the E. Coli lacZ gene which encodes b-galactosidase and green fluorescent protein.

In some embodiments the marker may be a selectable marker. Examples of suitable selectable markers for mammalian cells are dihydrofolate reductase (DHFR), thymidine kinase, neomycin, neomycin analog G418, hydromycin, and puromycin. When such selectable markers are successfully transferred into a mammalian host cell, the transformed mammalian host cell can survive if placed under selective pressure. There are two widely used distinct categories of selective regimes. The first category is based on a cell's metabolism and the use of a mutant cell line which lacks the ability to grow independent of a supplemented media. Two examples are: CHO DBFR—cells and mouse LTK-cells. These cells lack the ability to grow without the addition of such nutrients as thymidine or hypoxanthine. Because these cells lack certain genes necessary for a complete nucleotide synthesis pathway, they cannot survive unless the missing nucleotides are provided in a supplemented media. An alternative to supplementing the media is to introduce an intact DHFR or TK gene into cells lacking the respective genes, thus altering their growth requirements. Individual cells which were not transformed with the DHFR or TK gene will not be capable of survival in non-supplemented media.

The second category is dominant selection which refers to a selection scheme used in any cell type and does not require the use of a mutant cell line. These schemes typically use a drug to arrest growth of a host cell. Those cells which have a novel gene would express a protein conveying drug resistance and would survive the selection. Examples of such dominant selection use the drugs neomycin, (Southern P. and Berg, P., J. Molec. Appl. Genet. 1: 327 (1982)), mycophenolic acid, (Mulligan, R. C. and Berg, P. Science 209: 1422 (1980)) or hygromycin, (Sugden, B. et al., Mol. Cell. Biol. 5: 410-413 (1985)). The three examples employ bacterial genes under eukaryotic control to convey resistance to the appropriate drug G418 or neomycin (geneticin), xgpt (mycophenolic acid) or hygromycin, respectively. Others include the neomycin analog G418 and puramycin.

The use of Markers can be tailored for the type of cell that the MAC is in and for the type of organism the MAC is in. For example, if the MAC is to be a MAC which can shuffle between bacterial and yeast cells as well as mammalian cells, it may be desirable to engineer a Marker specific for the bacterial cell, for the yeast cell, and for the mammalian cell. Those of skill in the art, given the disclosed MACs are capable of selecting and using the appropriate Marker for a given set of conditions or a given set of cellular requirements.

The Markers can be useful in tracking the MAC through cell types and to determine if the MAC is present and functional in different cell types. The Markers can also be useful in tracking any changes that may take place in the MACs of over time or over a number of cell cycle generations.

(b) Transgenes

The transgenes that can be placed into the disclosed MACs can encode a variety of different types of molecules. For example, these transgenes can encode genes which will be expressed and produce a protein product or they can encode an RNA molecule that when it is expressed will encode functional nucleic acid, such as a ribozyme.

Functional nucleic acids are nucleic acid molecules that have a specific function, such as binding a target molecule or catalyzing a specific reaction. Functional nucleic acid molecules can be divided into the following categories, which are not meant to be limiting. For example, functional nucleic acids include antisense molecules, aptamers, ribozymes, triplex forming molecules, and external guide sequences. The functional nucleic acid molecules can act as affectors, inhibitors, modulators, and stimulators of a specific activity possessed by a target molecule, or the functional nucleic acid molecules can possess a de novo activity independent of any other molecules.

Functional nucleic acid molecules can interact with any macromolecule, such as DNA, RNA, polypeptides, or carbohydrate chains. Thus, functional nucleic acids can interact with a target mRNA of the host cell or a target genomic DNA of the host cell or a target polypeptide of the host cell. Often functional nucleic acids are designed to interact with other nucleic acids based on sequence homology between the target molecule and the functional nucleic acid molecule. In other situations, the specific recognition between the functional nucleic acid molecule and the target molecule is not based on sequence homology between the functional nucleic acid molecule and the target molecule, but rather is based on the formation of tertiary structure that allows specific recognition to take place.

Antisense molecules are designed to interact with a target nucleic acid molecule through either canonical or non-canonical base pairing. The interaction of the antisense molecule and the target molecule is designed to promote the destruction of the target molecule through, for example, RNAseH mediated RNA-DNA hybrid degradation. Alternatively the antisense molecule is designed to interrupt a processing function that normally would take place on the target molecule, such as transcription or replication. Antisense molecules can be designed based on the sequence of the target molecule. Numerous methods for optimization of antisense efficiency by finding the most accessible regions of the target molecule exist. Exemplary methods would be in vitro selection experiments and DNA modification studies using DMS and DEPC. It is preferred that antisense molecules bind the target molecule with a dissociation constant (k_{d}) less than 10⁻⁶. It is more preferred that antisense molecules bind with a k_{d} less than 10⁻⁸. It is also more preferred that the antisense molecules bind the target molecule with a k_{d} less than 10⁻¹⁰. It is also preferred that the antisense molecules bind the target molecule with a k_{d} less than 10⁻¹². A representative sample of methods and techniques which aid in the design and use of antisense molecules can be found in the following non-limiting list of U.S. Pat. Nos. 5,135,917, 5,294,533, 5,627,158, 5,641,754, 5,691,317, 5,780,607, 5,786,138, 5,849,903, 5,856,103, 5,919,772, 5,955,590, 5,990,088, 5,994,320, 5,998,602, 6,005,095, 6,007,995, 6,013,522, 6,017,898, 6,018,042, 6,025,198, 6,033,910, 6,040,296, 6,046,004, 6,046,319, and 6,057,437, which are herein incorporated by reference.

Aptamers are molecules that interact with a target molecule, preferably in a specific way. Typically aptamers are small nucleic acids ranging from 15-50 bases in length that fold into defined secondary and tertiary structures, such as stem-loops or G-quartets. Aptamers can bind small molecules, such as ATP (U.S. Pat. No. 5,631,146, herein incorporated by reference) and theophiline (U.S. Pat. No. 5,580,737, herein incorporated by reference), as well as large molecules, such as reverse transcriptase (U.S. Pat. No. 5,786,462, herein incorporated by reference) and thrombin (U.S. Pat. No. 5,543,293, herein incorporated by reference). Aptamers can bind very tightly with k_{d}s from the target molecule of less than 10-12 M. It is preferred that the aptamers bind the target molecule with a k_{d} less than 10⁻⁶. It is more preferred that the aptamers bind the target molecule with a k_{d} less than 10⁻⁸. It is also more preferred that the aptamers bind the target molecule with a k_{d} less than 10⁻¹⁰. It is also preferred that the aptamers bind the target molecule with a k_{d} less than 10⁻¹². Aptamers can bind the target molecule with a very high degree of specificity. For example, aptamers have been isolated that have greater than a 10000 fold difference in binding affinities between the target molecule and another molecule that differ at only a single position on the molecule (U.S. Pat. No. 5,543,293, herein incorporated by reference). It is preferred that the aptamer have a k_{d} with the target molecule at least 10 fold lower than the k_{d} with a background binding molecule. It is more preferred that the aptamer have a k_{d} with the target molecule at least 100 fold lower than the k_{d} with a background binding molecule. It is more preferred that the aptamer have a k_{d} with the target molecule at least 1000 fold lower than the k_{d} with a background binding molecule. It is preferred that the aptamer have a k_{d} with the target molecule at least 10000 fold lower than the k_{d} with a background binding molecule. It is preferred when doing the comparison for a polypeptide for example, that the background molecule be a different polypeptide. Representative examples of how to make and use aptamers to bind a variety of different target molecules can be found in the following non-limiting list of U.S. Pat. Nos. 5,476,766, 5,503,978, 5,631,146, 5,731,424, 5,780,228, 5,192,613, 5,795,721, 5,846,713, 5,858,660, 5,861,254, 5,864,026, 5,869,641, 5,958,691, 6,001,988, 6,011,020, 6,013,443, 6,020,130, 6,028,186, 6,030,776, and 6,051,698, which are herein incorporated by reference.

Ribozymes are nucleic acid molecules that are capable of catalyzing a chemical reaction, either intramolecularly or intermolecularly. Ribozymes are thus catalytic nucleic acid. It is preferred that the ribozymes catalyze intermolecular reactions. There are a number of different types of ribozymes that catalyze nuclease or nucleic acid polymerase type reactions which are based on ribozymes found in natural systems, such as hammerhead ribozymes, (for example, but not limited to the following U.S. Pat. Nos. 5,334,711, 5,436,330, 5,616,466, 5,633,133, 5,646,020, 5,652,094, 5,712,384, 5,770,715, 5,856,463, 5,861,288, 5,891,683, 5,891,684, 5,985,621, 5,989,908, 5,998,193, 5,998,203, WO 9858058 by Ludwig and Sproat, herein incorporated by reference, WO 9858057 by Ludwig and Sproat, herein incorporated by reference, and WO 9718312 by Ludwig and Sproat, herein incorporated by reference) hairpin ribozymes (for example, but not limited to the following U.S. Pat. Nos. 5,631,115, 5,646,031, 5,683,902, 5,712,384, 5,856,188, 5,866,701, 5,869,339, and 6,022,962, which are herein incorporated by reference), and tetrahymena ribozymes (for example, but not limited to the following U.S. Pat. Nos. 5,595,873 and 5,652,107, which are herein incorporated by reference). There are also a number of ribozymes that are not found in natural systems, but which have been engineered to catalyze specific reactions de novo (for example, but not limited to the following U.S. Pat. Nos. 5,580,967, 5,688,670, 5,807,718, and 5,910,408, which are herein incorporated by reference). Preferred ribozymes cleave RNA or DNA substrates, and more preferably cleave RNA substrates. Ribozymes typically cleave nucleic acid substrates through recognition and binding of the target substrate with subsequent cleavage. This recognition is often based mostly on canonical or non-canonical base pair interactions. This property makes ribozymes particularly good candidates for target specific cleavage of nucleic acids because recognition of the target substrate is based on the target substrates sequence. Representative examples of how to make and use ribozymes to catalyze a variety of different reactions can be found in the following non-limiting list of U.S. Pat. Nos. 5,646,042, 5,693,535, 5,731,295, 5,811,300, 5,837,855, 5,869,253, 5,877,021, 5,877,022, 5,972,699, 5,972,704, 5,989,906, and 6,017,756, which are herein incorporated by reference.

Triplex forming functional nucleic acid molecules are molecules that can interact with either double-stranded or single-stranded nucleic acid. When triplex molecules interact with a target region, a structure called a triplex is formed, in which there are three strands of DNA forming a complex dependant on both Watson-Crick and Hoogsteen base-pairing. Triplex molecules are preferred because they can bind target regions with high affinity and specificity. It is preferred that the triplex forming molecules bind the target molecule with a k_{d} less than 10⁻⁶. It is more preferred that the triplex forming molecules bind with a k_{d} less than 10⁻⁸. It is also more preferred that the triplex forming molecules bind the target moelcule with a k_{d} less than 10⁻¹⁰. It is also preferred that the triplex forming molecules bind the target molecule with a k_{d} less than 10⁻¹². Representative examples of how to make and use triplex forming molecules to bind a variety of different target molecules can be found in the following non-limiting list of U.S. Pat. Nos. 5,176,996, 5,645,985, 5,650,316, 5,683,874, 5,693,773, 5,834,185, 5,869,246, 5,874,566, and 5,962,426, which are herein incorporated by reference.

External guide sequences (EGSs) are molecules that bind a target nucleic acid molecule forming a complex, and this complex is recognized by RNase P, which cleaves the target molecule. EGSs can be designed to specifically target a RNA molecule of choice. RNAse P aids in processing transfer RNA (tRNA) within a cell. Bacterial RNAse P can be recruited to cleave virtually any RNA sequence by using an EGS that causes the target RNA:EGS complex to mimic the natural tRNA substrate. (WO 92/03566 by Yale, and Forster and Altman, Science 238:407-409 (1990), which are herein incorporated by reference).

Similarly, eukaryotic EGS/RNAse P-directed cleavage of RNA can be utilized to cleave desired targets within eukarotic cells. (Yuan et al., Proc. Natl. Acad. Sci. USA 89:8006-8010 (1992); WO 93/22434 by Yale; WO 95/24489 by Yale; Yuan and Altman, EMBO J. 14:159-168 (1995), and Carrara et al., Proc. Natl. Acad. Sci. (USA) 92:2627-2631 (1995), which are herein incorporated by reference). Representative examples of how to make and use EGS molecules to facilitate cleavage of a variety of different target molecules be found in the following non-limiting list of U.S. Pat. Nos. 5,168,053, 5,624,824, 5,683,873, 5,728,521, 5,869,248, and 5,877,162, which are herein incorporated by reference.

The transgenes can also encode proteins. These proteins, can either be native to the organism or cell type, or they can be exogenous. Typically, for example, if the transgene encodes a protein, it may be protein related to a certain disease state, wherein the protein is underproduced or is non-functional when produced from the native gene. In this situation, the protein encoded by the MAC is meant as a replacement protein. In other situations, the protein may be non-natural, meaning that it is not typically expressed in the cell type or organism in which the MAC is found. An example of this type of situation, may be a protein or small peptide that acts as mimic or inhibitor or inihibtor of a target molecule which is unregulated in the cell or organism possessing the MAC.

(c) Control Sequences

The transgenes, or other sequences, in the MACs can contain promoters, and/or enhancers to help control the expression of the desired gene product or sequence. A promoter is generally a sequence or sequences of DNA that function when in a relatively fixed location in regard to the transcription start site. A promoter contains core elements required for basic interaction of RNA polymerase and transcription factors, and may contain upstream elements and response elements.

(I) Viral Promoters and Enhancers

Preferred promoters controlling transcription from vectors in mammalian host cells may be obtained from various sources, for example, the genomes of viruses such as: polyoma, Simian Virus 40 (SV40), adenovirus, retroviruses, hepatitis-B virus and most preferably cytomegalovirus, or from heterologous mammalian promoters, e.g. beta actin promoter. The early and late promoters of the SV40 virus are conveniently obtained as an SV40 restriction fragment which also contains the SV40 viral origin of replication (Fiers et al., Nature, 273: 113 (1978)). The immediate early promoter of the human cytomegalovirus is conveniently obtained as a HindIII E restriction fragment (Greenway, P. J. et al., Gene 18: 355-360 (1982)). Of course, promoters from the host cell or related species also are useful herein.

Enhancer generally refers to a sequence of DNA that functions at no fixed distance from the transcription start site and can be either 5′ (Laimins, L. et al., Proc. Natl. Acad. Sci. 78: 993 (1981)) or 3′ (Lusky, M. L., et al., Mol. Cell Bio. 3: 1108 (1983)) to the transcription unit. Furthermore, enhancers can be within an intron (Banerji, J. L. et al., Cell 33: 729 (1983)) as well as within the coding sequence itself (Osborne, T. F., et al., Mol. Cell Bio. 4: 1293 (1984)). They are usually between 10 and 300 bp in length, and they function in cis. Enhancers function to increase transcription from nearby promoters. Enhancers also often contain response elements that mediate the regulation of transcription. Promoters can also contain response elements that mediate the regulation of transcription. Enhancers often determine the regulation of expression of a gene. While many enhancer sequences are now known from mammalian genes (globin, elastase, albumin, -fetoprotein and insulin), typically one will use an enhancer from a eukaryotic cell virus. Preferred examples are the SV40 enhancer on the late side of the replication origin (bp 100-270), the cytomegalovirus early promoter enhancer, the polyoma enhancer on the late side of the replication origin, and adenovirus enhancers.

The promotor and/or enhancer may be specifically activated either by light or specific chemical events which trigger their function. Systems can be regulated by reagents such as tetracycline and dexamethasone. There are also ways to enhance viral vector gene expression by exposure to irradiation, such as gamma irradiation, or alkylating chemotherapy drugs.

The promoter and/or enhancer region act as a constitutive promoter and/or enhancer to maximize expression of the region of the transcription unit to be transcribed. It is further preferred that the promoter and/or enhancer region be active in all eukaryotic cell types. A preferred promoter of this type is the CMV promoter (650 bases). Other promoters are SV40 promoters, cytomegaloviris (full length promoter), and retroviral vector LTF.

It has been shown that specific regulatory elements can be cloned and used to construct expression vectors that are selectively expressed in specific cell types such as melanoma cells. The glial fibrillary acetic protein (GFAP) promoter has been used to selectively express genes in cells of glial origin.

Expression vectors used in eukaryotic host cells (yeast, fungi, insect, plant, animal, human or nucleated cells) may also contain sequences necessary for the termination of transcription which may affect mRNA expression. These regions are transcribed as polyadenylated segments in the untranslated portion of the mRNA encoding tissue factor protein. The 3′ untranslated regions also include transcription termination sites. It is preferred that the transcription unit also contain a polyadenylation region. One benefit of this region is that it increases the likelihood that the transcribed unit will be processed and transported like mRNA. The identification and use of polyadenylation signals in expression constructs is well established. It is preferred that homologous polyadenylation signals be used in the transgene constructs. In one embodiment of the transcription unit, the polyadenylation region is derived from the SV40 early polyadenylation signal and consists of about 400 bases. It is also preferred that the transcribed units contain other standard sequences alone or in combination with the above sequences improve expression from, or stability of, the construct.

d) Function

The disclosed MACs can further be characterize by their function. The MACs should be able to both replicate and segregate normally during a cell cycle i.e. MAC should be mitotically stable. MACs should be maintained in a single copy number in a transfectant cell. There should be no inhibition of expression of genes cloned in MACs MACs should not integrate into mammalian chromosomes. The MACs also can optionally have a number of other functional properties.

(1) Can Shuttle Between BAC, YAC, and MAC

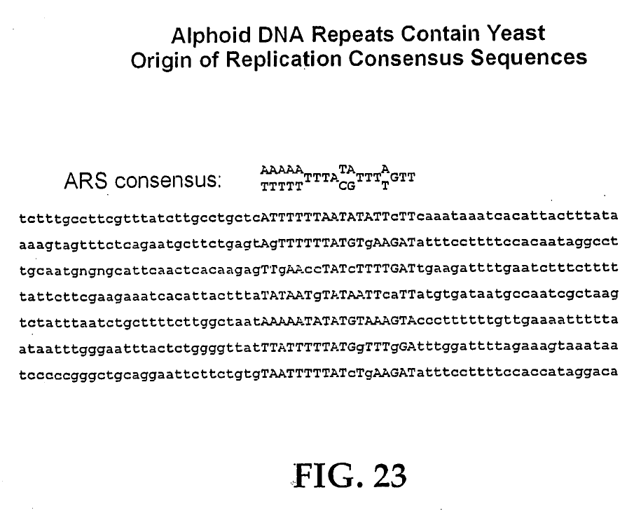

One beneficial property that the disclosed MACs can possess is the ability to be shuttled back and forth between mammalian, bacterial, and yeast cells. The MACs that have this property will have specialized structural features that for example, allow for replication in all three types of cells. For example, DNA sequence that has origins of replication sufficient to promote replication in mammalian cells will typically not support replication in yeast cells. Yeast cells typically require ARS sequences for replication. In contrast to other MACs, the disclosed MACs contain criptic ARS sequences present within alphoid DNA array (FIG. 23). The ability to shuttle between these three different organisms allows for a broad range of recombinant biology manipulations that would not be present or as easily realized if the MACs only functioned in mammalian cells. For example, homologous recombination techniques, available in yeast, but not typically available in mammalian cells, can be performed on a MAC that can be shuttled back and forth between a yeast cell and a mammalian cell. For example, an alphoid DNA array can be modified by homologous recombination in yeast (deletions of one type of units or insertion of another type of units) to study a function of centromere. Moreover, a transgene cloned in a MAC could be mutated by homologous recombination in yeast to study a gene expression.

Typically MACs capable of shuttling between bacterial, yeast, and mammalian cells will be circular or possess the ability to be circularized and linearized by discreet manipulations of the MAC. Linear pieces of DNA do not replicate well in bacterial or yeast cells. A linear MAC can be engineered so that it can be circularized. Such circularization can be easily carried out by homologous recombimbination in yeast similar to that has been done for linear YACs (Cocchia et al. Nucl. Acids Res.28:E81, 2000.). Alternatively the circularization could be induced using Lex-Cre site-specific recombination system (Qin et al., Nucl. Acids Res. 23: 1923-1927.)

(2) Does Not Increase Size When Amplified

Another beneficial property that the MACs can possess is the ability to maintain there size and structure when being shuttled between bacterial, yeast, and mammalian cells. This property is due in part to the high divergence that can exist in the alpha satellite regions of the disclosed Z-part of the MAC. In certain constructs, the greater the internal homology, the greater the chance that homologous recombination events can arise in the host yeast cell, for example. Especially in yeast and bacteria, the more divergent the sequences the more stable the MAC will be in yeast and bacteria. Thus, variation between the alpha satellites that make up the Z-part of the MAC can be a desirable goal.

(3) Can Carry Transgenes

As discussed the disclosed MACs can optionally carry a variety of transgenes which are discussed below. These transgenes can perform a variety of functions, including but not limited to, the delivery of some type of pharmaceutical product, the delivery of some type of tool which can be used for the study of cellular function or the cell cycle.

2. Shuttle Vectors

The basic TAR cloning vector pVC-ARS is a derivative of the Bluscript-based yeast-E. coli shuttle vector pRS313 (Sikorski and Hieter, Genetics 122:19-27,1989). This plasmid contains a yeast origin of replication (ARSH4) from pRS313. pVC604 has an extensive polylinker consisting of 14 restriction endonuclease 6- and 8 bp recognition sites for flexibility in cloning of particular fragments of interest.

The functional DNA segments of the plasmid are indicated as follows: CEN6 a 196 bp fragment of the yeast centromere VI; HIS3=marker for yeast cells; Amp^{R}=ampicilline-resistance gene. This part of the vector allows it to be cloned and to propagate human DNA inserts as YACs. Construction of a TAR vector for isolation of centromeric regions includes cloning of short specific alphoid DNA sequences (hooks) and a counter-selectable marker SUP11.

Other counter-selectable markers could be other yeast suppressor t-RNA genes or genes that are toxic for yeast (for example a gene encoding a killer-factor toxin (Suzuki et al. Protein Eng. 13:73-76, 2000.). These genes could be used in the same way to achieve the same result. Those of skill in the art can readily supply this part of the shuttle vector, and they can determine if the SUP11 substitute is functioning as the disclosed vectors and MACs.

To propagate isolated centromeric DNAs in E. coli cells a set of retrofitting vectors is disclosed. A typical retrofitting vector contains two short (approximately 300 bp each) targeting sequences, A and B, flanking the ColE1 origin of replication and the AmP^{R} gene in the pVC604-based TAR cloning vectors (Kouprina et al., Proc. Natl. Acad. Sci. USA 95: 4469-4474,1998). These targeting sequences are separated by a unique BamHI site. Recombination of the vector with a YAC during yeast transformation creates the shuttle vector construct: following the recombination event, the ColE1 origin of replication in the TAR cloning vector is replaced by a cassette containing the F-factor origin of replication, the chloramphenicol acetyltransferase (Cm^{R}) gene, a mammalian genetic marker and the URA3 yeast selectable marker. The presence of a mammalian marker (such as Neo_{R} gene or HygroR gene or BsdR gene) allows for the selection of the construct during transfection into mammalian cells. There are numerous other yeast markers that can be substituted for the specific markers disclosed, and as discussed herein the functionality of these substitutions can be determined. Some embodiments will incorporate these substitutions as long as they retain the desired property of the various MACs and shuttle vectors disclosed herein.

It is understood that the shuttle vectors have the properties of either shuttling between yeast and mammalian cells, such as human cells, or yeast and bacteria cells, or mammalian cells, such as human and bacteria cells, or between all three different sets of cells. The cloning vectors which are described herein often are designed so that they can be shuttle vectors as well as cloning vectors. Thus, there are parts of shuttle vectors in general and the disclosed cloning vectors that can be similar or the same. However, it is specifically contemplated that the shuttle vectors can be engineered such that they do not have the any parts derived from or even necessartily related to the parts of the cloning vectors. Likewise the cloning vectors typically will contain the parts necessary for acting as a shuttle vector, in any of the ways disucssed herein. However, the cloning vectors can also be designed to function only in yeast, for example, and then later retrofitted if desired to function in other systems.

a) Size

The size of the vector construct can vary from 10 kb to 30 kb. The size of the vector construct if it is to be a shuttle between yeast and mammalian cells would be based on the largest chromosome that can be maintained in the yeast. This is typically around 300 kb. In some embodiments it is less than or equal to about 1 mega base, or 900 kb, or 850 kb, or 800 kb, or 750 kb, or 700 kb, or 650 kb, or 600 kb, or 550 kb, or 500 kb, or 450 kb, or 400 kb, or 350 kb, or 250 kb, or 200 kb, or 150 kb, or 100 kb, or 50 kb.

When the vector is to be suttled between a BAC and a YAC or a BAC and a MAC the size typically is controlled by the bacterial reuqirments. This size is typically less than or eaul to about 500 kb, 450 kb, or 400 kb, or 350 kb, or 250 kb, or 200 kb, or 150 kb, or 100 kb, or 50 kb.

b) Content

The cloning vectors should contain a yeast cassette (i.e. a yeast selectable marker, a yeast origin of replication and a yeast centromere), a bacterial cassette (i.e. E. coli selectable marker, and E. coli origin of replication; colE1 or F-factor) and a mammalian selectable marker. Some additional sequences that simplify manipulation with constructs can be included (such as rare cutting recognition sites, or lox sites) as well as sequences that would be required for proper replication of MAC in mammalian cells. These vectors can also have recombination sequences which are discussed herein.

3. Cloning Vectors

Construction of a TAR vector for isolation of centromeric regions includes cloning of short specific alphoid DNA sequences (hooks) and a counter-selectable marker SUP11. The hook sequences of the cloning vectors can be designed for othe repeat DNA. The hooks, as discussed herein, are specific for the target sequence for cloning. The key point is that there are numerous repetitive sequences known to those of skill in the art which can be cloned using the disclosed vectors and methods.

It needs to be emphasized that selectivity of cloning is due to the use of a combination of a SUP11 gene and specific host strain (i.e. containing yeast prion (Kochneva-Pervukhova et al. Yeast 18:489-497, 2001. Other counter-selectable markers could be other yeast suppressor t-RNA genes or genes that are toxic for yeast (for example a a gene encoding a killer-factor toxin (Suzuki et al. Protein Eng. 13:73-76, 2000.). These genes could be used in the same way to achieve the same result. The limiting factor is whether the selectable marker, such as Sup11 is capable of overcoming the hurdles related to cloning alphoid DNA and other repetitive DNA sequences.

B. Methods of Making the Compositions

The TAR method allows for the selective isolation of centromeric regions from any cell line and from any chromosome. In contrast, other methods of isolation of the Y chromosome alphoid DNA can only be applied for a cell line carrying a yeast selectable marker and yeast centromere integrated into a specific region. (Kouprina et al., Genome Research 8: 666-672, 1998).

1. TAR

Isolation of specific chromosomal regions and entire genes has typically involved a long and laborious process of identification of the region of interest among thousands random YAC clones. Using the recently developed TAR (Transformation-Associated Recombination) cloning technique in the yeast Saccharomyces cerevisiae, it has been possible to directly isolate specific chromosomal regions and genes from complex genomes as large linear or circular YACs (Kouprina and Larionov, Current protocols in Human Genetics 5.17-0.1-5.17.21, 1999). The speed and efficiency of TAR cloning, as compared to the more traditional methods of gene isolation, provides a powerful tool for the analysis of gene structure and function. Isolation of specific regions from complex genomes by Transformation-Associated Recombination (TAR) in yeast includes preparation of yeast spheroplasts and transformation of the spheroplasts by gently isolated total genomic DNA along with a TAR vector containing sequences homologous to a region of interest. Recombination between a genomic fragment and the vector results in a rescue of the region as a circular Yeast Artificial Chromosome (YAC. When both 3′ and 5′ ends sequence information is available, a gene can be isolated by a vector containing two short unique sequences flanking the gene (hooks If sequence information is available only for one gene end [for example, for the 3′ end based on Expressed Sequence Tag (EST) information], the gene can be isolated by a TAR vector that has one unique hook corresponding this end and a repeated sequence as a second hook (Alu or B1 repeats for human or mouse DNA, respectively). Because only one of the ends is fixed, this type of cloning is called radial TAR cloning. TAR cloning produces libraries in which nearly 1% of the transformants contain the desired gene. A clone containing a gene of interest can be easily identified in the libraries by PCR.

The disclosed methods utilize the vectors disclosed herein to be able to isolate the alphoid or repetitive DNA sequences.

C. Methods of Using the Compositions

1. Delivery of the Compositions to Cells

Three methods were examined for the introduction of the BAC/YACs into mammalian cells: electroporation, lipofection and calcium phosphate precipitation. The compositions can also be delivered through a variety of nucleic acid delivery systems, direct transfer of genetic material, in but not limited to, plasmids, viral vectors, viral nucleic acids, phage nucleic acids, phages, cosmids, or via transfer of genetic material in cells or carriers such as cationic liposomes. Such methods are well known in the art and readily adaptable for with the MACSs described herein. In certain cases, the methods will be modifed to specifically function wish large DNA moleculs. Further, these methods can be used to target certain diseases and cell populations by using the targeting characteristics of the carrier. Transfer vectors can be any nucleotide construction used to deliver genes into cells (e.g., a plasmid), or as part of a general strategy to deliver genes, e.g., as part of recombinant retrovirus or adenovirus (Ram et al. Cancer Res. 53:83-88, (1993)). Appropriate means for transfection, including viral vectors, chemical transfectants, or physico-mechanical methods such as electroporation and direct diffusion of DNA, are described by, for example, Wolff, J. A., et al., Science, 247, 1465-1468, (1990); and Wolff, J. A. Nature, 352, 815-818, (1991).

As used herein, plasmid or viral vectors are agents that transport the MAC into the cell without degradation and include a promoter yielding expression of the gene in the cells into which it is delivered. In some embodiments the MACs are derived from either a virus or a retrovirus. Viral vectors are Adenovirus, Adeno-associated virus, Herpes virus, Vaccinia virus, Polio virus, AIDS virus, neuronal trophic virus, Sindbis and other RNA viruses, including these viruses with the HIV backbone. Also preferred are any viral families which share the properties of these viruses which make them suitable for use as vectors. Retroviruses include Murine Maloney Leukemia virus, MMLV, and retroviruses that express the desirable properties of MMLV as a vector. Retroviral vectors are able to carry a larger genetic payload, i.e., a transgene or marker gene, than other viral vectors, and for this reason are a commonly used vector. However, they are not as useful in non-proliferating cells. Adenovirus vectors are relatively stable and easy to work with, have high titers, and can be delivered in aerosol formulation, and can transfect non-dividing cells. Pox viral vectors are large and have several sites for inserting genes, they are thermostable and can be stored at room temperature. A preferred embodiment is a viral vector which has been engineered so as to suppress the immune response of the host organism, elicited by the viral antigens. Preferred vectors of this type will carry coding regions for Interleukin 8 or 10.

Viral vectors can have higher transaction (ability to introduce genes) abilities than chemical or physical methods to introduce genes into cells. Typically, viral vectors contain, nonstructural early genes, structural late genes, an RNA polymerase III transcript, inverted terminal repeats necessary for replication and encapsidation, and promoters to control the transcription and replication of the viral genome. When engineered as vectors, viruses typically have one or more of the early genes removed and a gene or gene/promotor cassette is inserted into the viral genome in place of the removed viral DNA. Constructs of this type can carry up to about 8 kb of foreign genetic material. The necessary functions of the removed early genes are typically supplied by cell lines which have been engineered to express the gene products of the early genes in trans.

a) Retroviral Vectors

A retrovirus is an animal virus belonging to the virus family of Retroviridae, including any types, subfamilies, genus, or tropisms. Retroviral vectors, in general, are described by Verma, I. M., Retroviral vectors for gene transfer. In Microbiology-1985, American Society for Microbiology, pp. 229-232, Washington, (1985), which is incorporated by reference herein. Examples of methods for using retroviral vectors for gene therapy are described in U.S. Pat. Nos. 4,868,116 and 4,980,286; PCT applications WO 90/02806 and WO 89/07136; and Mulligan, (Science 260:926-932 (1993)); the teachings of which are incorporated herein by reference.

A retrovirus is essentially a package which has packed into it nucleic acid cargo. The nucleic acid cargo carries with it a packaging signal, which ensures that the replicated daughter molecules will be efficiently packaged within the package coat. In addition to the package signal, there are a number of molecules which are needed in cis, for the replication, and packaging of the replicated virus. Typically a retroviral genome, contains the gag, pol, and env genes which are involved in the making of the protein coat. It is the gag, pol, and env genes which are typically replaced by the foreign DNA that it is to be transferred to the target cell. Retrovirus vectors typically contain a packaging signal for incorporation into the package coat, a sequence which signals the start of the gag transcription unit, elements necessary for reverse transcription, including a primer binding site to bind the tRNA primer of reverse transcription, terminal repeat sequences that guide the switch of RNA strands during DNA synthesis, a purine rich sequence 5′ to the 3′ LTR that serve as the priming site for the synthesis of the second strand of DNA synthesis, and specific sequences near the ends of the LTRs that enable the insertion of the DNA state of the retrovirus to insert into the host genome. The removal of the gag, pol, and env genes allows for about 8 kb of foreign sequence to be inserted into the viral genome, become reverse transcribed, and upon replication be packaged into a new retroviral particle. This amount of nucleic acid is sufficient for the delivery of a one to many genes depending on the size of each transcript. It is preferable to include either positive or negative selectable markers along with other genes in the insert.

Since the replication machinery and packaging proteins in most retroviral vectors have been removed (gag, pol, and env), the vectors are typically generated by placing them into a packaging cell line. A packaging cell line is a cell line which has been transfected or transformed with a retrovirus that contains the replication and packaging machinery, but lacks any packaging signal. When the vector carrying the DNA of choice is transfected into these cell lines, the vector containing the gene of interest is replicated and packaged into new retroviral particles, by the machinery provided in cis by the helper cell. The genomes for the machinery are not packaged because they lack the necessary signals.

b) Adenoviral Vectors

The construction of replication-defective adenoviruses has been described (Berkner et al., J. Virology 61:1213-1220 (1987); Massie et al., Mol. Cell. Biol. 6:2872-2883 (1986); Haj-Ahmad et al., J. Virology 57:267-274 (1986); Davidson et al., J. Virology 61:1226-1239 (1987); Zhang “Generation and identification of recombinant adenovirus by liposome-mediated transfection and PCR analysis” BioTechniques 15:868-872 (1993)). The benefit of the use of these viruses as vectors is that they are limited in the extent to which they can spread to other cell types, since they can replicate within an initial infected cell, but are unable to form new infectious viral particles. Recombinant adenoviruses have been shown to achieve high efficiency gene transfer after direct, in vivo delivery to airway epithelium, hepatocytes, vascular endothelium, CNS parenchyma and a number of other tissue sites (Morsy, J. Clin. Invest. 92:1580-1586 (1993); Kirshenbaum, J. Clin. Invest. 92:381-387 (1993); Roessler, J. Clin. Invest. 92:1085-1092 (1993); Moullier, Nature Genetics 4:154-159 (1993); La Salle, Science 259:988-990 (1993); Gomez-Foix, J. Biol. Chem. 267:25129-25134 (1992); Rich, Human Gene Therapy 4:461-476 (1993); Zabner, Nature Genetics 6:75-83 (1994); Guzman, Circulation Research 73:1201-1207 (1993); Bout, Human Gene Therapy 5:3-10 (1994); Zabner, Cell 75:207-216 (1993); Caillaud, Eur. J. Neuroscience 5:1287-1291 (1993); and Ragot, J. Gen. Virology 74:501-507 (1993)). Recombinant adenoviruses achieve gene transduction by binding to specific cell surface receptors, after which the virus is internalized by receptor-mediated endocytosis, in the same manner as wild type or replication-defective adenovirus (Chardonnet and Dales, Virology 40:462-477 (1970); Brown and Burlingham, J. Virology 12:386-396 (1973); Svensson and Persson, J. Virology 55:442-449 (1985); Seth, et al., J. Virol. 51:650-655 (1984); Seth, et al., Mol. Cell. Biol. 4:1528-1533 (1984); Varga et al., J. Virology 65:6061-6070 (1991); Wickham et al., Cell 73:309-319 (1993)).

A viral vector can be one based on an adenovirus which has had the E1 gene removed and these virons are generated in a cell line such as the human 293 cell line. In another preferred embodiment both the E1 and E3 genes are removed from the adenovirus genome.

Another type of viral vector is based on an adeno-associated virus (AAV). This defective parvovirus is a preferred vector because it can infect many cell types and is nonpathogenic to humans. AAV type vectors can transport about 4 to 5 kb and wild type AAV is known to stably insert into chromosome 19. Vectors which contain this site specific integration property are preferred. An especially preferred embodiment of this type of vector is the P4.1 C vector produced by Avigen, San Francisco, Calif., which can contain the herpes simplex virus thymidine kinase gene, HSV-tk, and/or a marker gene, such as the gene encoding the green fluorescent protein, GFP.

The inserted genes in viral and retroviral usually contain promoters, and/or enhancers to help control the expression of the desired gene product. A promoter is generally a sequence or sequences of DNA that function when in a relatively fixed location in regard to the transcription start site. A promoter contains core elements required for basic interaction of RNA polymerase and transcription factors, and may contain upstream elements and response elements.

c) Large Payload Viral Vectors

Molecular genetic experiments with large human herpesviruses have provided a means whereby large heterologous DNA fragments can be cloned, propagated and established in cells permissive for infection with herpesviruses (Sun et al., Nature genetics 8: 33-41, 1994; Cotter and Robertson,.Curr Opin Mol Ther 5: 633-644, 1999). These large DNA viruses (herpes simplex virus (HSV) and Epstein-Barr virus (EBV), have the potential to deliver fragments of human heterologous DNA>150 kb to specific cells. EBV recombinants can maintain large pieces of DNA in the infected B-cells as episomal DNA. Individual clones carried human genomic inserts up to 330 kb appeared genetically stable The maintenance of these episomes requires a specific EBV nuclear protein, EBNA1, constitutively expressed during infection with EBV. Additionally, these vectors can be used for transfection, where large amounts of protein can be generated transiently in vitro. Herpesvirus amplicon systems are also being used to package pieces of DNA>220 kb and to infect cells that can stably maintain DNA as episomes. Other cloning systems based on mammalian viruses are also can be combined with MAC system. For example, replicating and host-restricted non-replicating vaccinia virus vectors.

The disclosed compositions can be delivered to the target cells in a variety of ways. For example, the compositions can be delivered through electroporation, or through lipofection, or through calcium phosphate precipitation. The delivery mechanism chosen will depend in part on the type of cell targeted and whether the delivery is occuring for example in vivo or in vitro. For example, a preferred mode of delivery for in vivo uses would be the use of liposomes. Lipofection has yielded ˜5×10⁻⁵ neomycin-resistant transfectants per microgram of BAC/YAC DNA. The efficiency was much lower using the other procedures.

Thus, the compositions can comprise, in addition to the disclosed MACs or vectors for example, lipids such as liposomes, such as cationic liposomes (e.g., DOTMA, DOPE, DC-cholesterol) or anionic liposomes. Liposomes can further comprise proteins to facilitate targeting a particular cell, if desired. Administration of a composition comprising a compound and a cationic liposome can be administered to the blood afferent to a target organ or inhaled into the respiratory tract to target cells of the respiratory tract. Regarding liposomes, see, e.g., Brigham et al. Am. J. Resp. Cell. Mol. Biol. 1:95-100 (1989); Felgner et al. Proc. Natl. Acad. Sci USA 84:7413-7417 (1987); U.S. Pat. No. 4,897,355. Furthermore, the compound can be administered as a component of a microcapsule that can be targeted to specific cell types, such as macrophages, or where the diffusion of the compound or delivery of the compound from the microcapsule is designed for a specific rate or dosage.

As described above, the compositions can be administered in a pharmaceutically acceptable carrier and can be delivered to the subject's cells in vivo and/or ex vivo by a variety of mechanisms well known in the art (e.g., uptake of naked DNA, liposome fusion, intramuscular injection of DNA via a gene gun, endocytosis and the like).

If ex vivo methods are employed, cells or tissues can be removed and maintained outside the body according to standard protocols well known in the art. The compositions can be introduced into the cells via any gene transfer mechanism, such as, for example, calcium phosphate mediated gene delivery, electroporation, microinjection or proteoliposomes. The transduced cells can then be infused (e.g., in a pharmaceutically acceptable carrier) or homotopically transplanted back into the subject per standard methods for the cell or tissue type. Standard methods are known for transplantation or infusion of various cells into a subject.

In the methods described above which include the administration and uptake of exogenous DNA into the cells of a subject (i.e., gene transduction or transfection), delivery of the compositions to cells can be via a variety of mechanisms. As one example, delivery can be via a liposome, using commercially available liposome preparations such as LIPOFECTIN, LIPOFECTAMINE (GIBCO-BRL, Inc., Gaithersburg, Md.), SUPERFECT (Qiagen, Inc. Hilden, Germany) and TRANSFECTAM (Promega Biotec, Inc., Madison, Wis.), as well as other liposomes developed according to procedures standard in the art. In addition, the nucleic acid or vector of this invention can be delivered in vivo by electroporation, the technology for which is available from Genetronics, Inc. (San Diego, Calif.) as well as by means of a SONOPORATION machine (ImaRx Pharmaceutical Corp., Tucson, Ariz.).

2. Delivery of Pharamceutical Products

As described above, the compositions can also be administered in vivo in a pharmaceutically acceptable carrier. By “pharmaceutically acceptable” is meant a material that is not biologically or otherwise undesirable, i.e., the material may be administered to a subject, along with the nucleic acid or vector, without causing any undesirable biological effects or interacting in a deleterious manner with any of the other components of the pharmaceutical composition in which it is contained. The carrier would naturally be selected to minimize any degradation of the active ingredient and to minimize any adverse side effects in the subject, as would be well known to one of skill in the art.

The compositions may be administered orally, parenterally (e.g.; intravenously), by intramuscular injection, by intraperitoneal injection, transdermally, extracorporeally, topically or the like, although topical intranasal administration or administration by inhalant is typically preferred. As used herein, “topical intranasal administration” means delivery of the compositions into the nose and nasal passages through one or both of the nares and can comprise delivery by a spraying mechanism or droplet mechanism, or through aerosolization of the nucleic acid or vector. The latter may be effective when a large number of animals is to be treated simultaneously. Administration of the compositions by inhalant can be through the nose or mouth via delivery by a spraying or droplet mechanism. Delivery can also be directly to any area of the respiratory system (e.g., lungs) via intubation. The exact amount of the compositions required will vary from subject to subject, depending on the species, age, weight and general condition of the subject, the severity of the allergic disorder being treated, the particular nucleic acid or vector used, its mode of administration and the like. Thus, it is not possible to specify an exact amount for every composition. However, an appropriate amount can be determined by one of ordinary skill in the art using only routine experimentation given the teachings herein.

Parenteral administration of the composition, if used, is generally characterized by injection. Injectables can be prepared in conventional forms, either as liquid solutions or suspensions, solid forms suitable for solution of suspension in liquid prior to injection, or as emulsions. A more recently revised approach for parenteral administration involves use of a slow release or sustained release system such that a constant dosage is maintained. See, e.g., U.S. Pat. No. 3,610,795, which is incorporated by reference herein.

The materials may be in solution, suspension (for example, incorporated into microparticles, liposomes, or cells). These may be targeted to a particular cell type via antibodies, receptors, or receptor ligands. The following references are examples of the use of this technology to target specific proteins to tumor tissue (Senter, et al., Bioconjugate Chem., 2:447-451, (1991); Bagshawe, K. D., Br. J. Cancer, 60:275-281, (1989); Bagshawe, et al., Br. J. Cancer, 58:700-703, (1988); Senter, et al., Bioconjugate Chem., 4:3-9, (1993); Battelli, et al., Cancer Immunol. Immunother., 35:421-425, (1992); Pietersz and McKenzie, Immunolog. Reviews, 129:57-80, (1992); and Roffler, et al., Biochem. Pharmacol, 42:2062-2065, (1991)). Vehicles such as “stealth” and other antibody conjugated liposomes (including lipid mediated drug targeting to colonic carcinoma), receptor mediated targeting of DNA through cell specific ligands, lymphocyte directed tumor targeting, and highly specific therapeutic retroviral targeting of murine glioma cells in vivo. The following references are examples of the use of this technology to target specific proteins to tumor tissue (Hughes et al., Cancer Research, 49:6214-6220, (1989); and Litzinger and Huang, Biochimica et Biophysica Acta, 1104:179-187, (1992)). In general, receptors are involved in pathways of endocytosis, either constitutive or ligand induced. These receptors cluster in clathrin-coated pits, enter the cell via clathrin-coated vesicles, pass through an acidified endosome in which the receptors are sorted, and then either recycle to the cell surface, become stored intracellularly, or are degraded in lysosomes. The internalization pathways serve a variety of functions, such as nutrient uptake, removal of activated proteins, clearance of macromolecules, opportunistic entry of viruses and toxins, dissociation and degradation of ligand, and receptor-level regulation. Many receptors follow more than one intracellular pathway, depending on the cell type, receptor concentration, type of ligand, ligand valency, and ligand concentration. Molecular and cellular mechanisms of receptor-mediated endocytosis has been reviewed (Brown and Greene, DNA and Cell Biology 10:6, 399-409 (1991)).

a) Pharmaceutically Acceptable Carriers

The compositions, including antibodies, can be used therapeutically in combination with a pharmaceutically acceptable carrier.

Pharmaceutical carriers are known to those skilled in the art. These most typically would be standard carriers for administration of drugs to humans, including solutions such as sterile water, saline, and buffered solutions at physiological pH. The compositions can be administered intramuscularly or subcutaneously. Other compounds will be administered according to standard procedures used by those skilled in the art.

Pharmaceutical compositions may include carriers, thickeners, diluents, buffers, preservatives, surface active agents and the like in addition to the molecule of choice. Pharmaceutical compositions may also include one or more active ingredients such as antimicrobial agents, antiinflammatory agents, anesthetics, and the like.

The pharmaceutical composition may be administered in a number of ways depending on whether local or systemic treatment is desired, and on the area to be treated. Administration may be topically (including ophthalmically, vaginally, rectally, intranasally), orally, by inhalation, or parenterally, for example by intravenous drip, subcutaneous, intraperitoneal or intramuscular injection. The disclosed antibodies can be administered intravenously, intraperitoneally, intramuscularly, subcutaneously, intracavity, or transdermally.

Preparations for parenteral administration include sterile aqueous or non-aqueous solutions, suspensions, and emulsions. Examples of non-aqueous solvents are propylene glycol, polyethylene glycol, vegetable oils such as olive oil, and injectable organic esters such as ethyl oleate. Aqueous carriers include water, alcoholic/aqueous solutions, emulsions or suspensions, including saline and buffered media. Parenteral vehicles include sodium chloride solution, Ringer's dextrose, dextrose and sodium chloride, lactated Ringer's, or fixed oils. Intravenous vehicles include fluid and nutrient replenishers, electrolyte replenishers (such as those based on Ringer's dextrose), and the like. Preservatives and other additives may also be present such as, for example, antimicrobials, anti-oxidants, chelating agents, and inert gases and the like.

Formulations for topical administration may include ointments, lotions, creams, gels, drops, suppositories, sprays, liquids and powders. Conventional pharmaceutical carriers, aqueous, powder or oily bases, thickeners and the like may be necessary or desirable.

Compositions for oral administration include powders or granules, suspensions or solutions in water or non-aqueous media, capsules, sachets, or tablets. Thickeners, flavorings, diluents, emulsifiers, dispersing aids or binders may be desirable.

Some of the compositions may potentially be administered as a pharmaceutically acceptable acid- or base-addition salt, formed by reaction with inorganic acids such as hydrochloric acid, hydrobromic acid, perchloric acid, nitric acid, thiocyanic acid, sulfuric acid, and phosphoric acid, and organic acids such as formic acid, acetic acid, propionic acid, glycolic acid, lactic acid, pyruvic acid, oxalic acid, malonic acid, succinic acid, maleic acid, and fumaric acid, or by reaction with an inorganic base such as sodium hydroxide, ammonium hydroxide, potassium hydroxide, and organic bases such as mono-, di-, trialkyl and aryl amines and substituted ethanolamines.

b) Therapeutic Uses

The dosage ranges for the administration of the compositions are those large enough to produce the desired effect in which the symptoms disorder are effected. The dosage should not be so large as to cause adverse side effects, such as unwanted cross-reactions, anaphylactic reactions, and the like. Generally, the dosage will vary with the age, condition, sex and extent of the disease in the patient and can be determined by one of skill in the art. The dosage can be adjusted by the individual physician in the event of any counterindications. Dosage can vary, and can be administered in one or more dose administrations daily, for one or several days.

Other MACs which do not have a specific pharmacuetical function, but which may be used for tracking changes within cellular chromosomes or for the delivery of diagnositc tools for example can be delivered in ways similar to those described for the pharmaceutical products.

The cloning vectors can used for example as tools to isolate and study target sequences necessary for the completion of the Human Genome project. Repetitive DNA is very difficult to clone, and the methods and reagents disclosed herein have made it possible to clone these types of sequences, for example alphoid sequence or alpha satellite sequence.

The MACs can also be used for example as tools to isolate and test new drug candidates for a variety of diseases. They can also be used for the continued isolation and study, for example, the cell cycle. There use as exogenous DNA delivery devices can be expanded for nearly any reason desired by those of skill in the art.

### D. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Example 1

### TAR Isolation of Y Chromosome Derived Alphoid DNA

a) Materials and Methods

(1) Yeast Strain and Transformation

The highly transformable Saccharomyces cerevisiae strain VL6-48 (MAT alpha, his3-Δ1, trp1-Δ1, ura3-52, lys2, ade2-101, met14 cir^{o}) (Kouprina and Larionov, Current Protocols in Human Genetics 1: 5.17.1-5.17.21 (1999)) was used for transformations. Spheroplasts that enable efficient transformation were prepared by using a previously described protocol Kouprina and Larionov, Current Protocols in Human Genetics 1: 5.17.1-5.17.21 (1999). For transformation experiments, the DNA-containing plugs (25 μl, containing about 5 μg of genomic DNA were melted and treated with agarase. Yeast transformants were selected on synthetic complete medium plates lacking uracil.

(2) TAR Cloning of Alphoid DNA Arrays

The vector used for cloning alphoid DNA from the Y chromosome was vector similar to the vector disclosed in Example 3. The method used for the TAR cloning was similar to the method disclosed in Example 2 and elsewhere. This vector is sufficient to clone many centromeric regions from a variety of different chromosomes, as exemplified by the multiple different centromere regions disclosed herein which were cloned with this vector.

(3) Preparation of Chromosomal-Sized DNA in Solid Agarose Plugs for the Rescue Transformation Experiments

For isolation of the chromosome Y centromeric region, agarose plugs containing a high molecular weight genomic DNA were prepared from normal human leukocytes or from ΔYp74 hybrid cells. The ΔYp74 hybrid (rodent-human) cell line containing the truncated human chromosome Y was kindly provided by Dr. William Brown (Oxford University, Heller et al., Proc. Natl. Sacad. Sci. USA 93: 7125-7130, 1996). About 4×10⁹ cells from the ΔYp74 hybrid cell line carrying a 12 Mb human mini-chromosome (Heller et al., 1996) were pelleted and resuspended in 3.0 ml of TE (50 mM EDTA, 10 mM Tris, pH 7.5). This cell mix was separated in 500 μl aliquots and placed at 42° C. An equal volume of pre-warmed 1% agarose/EDTA (low-melting agarose in 125 mM EDTA, pH 7.5) were added to each aliquot, mixed completely by vortexing and poured into Bio-Rad molds. Agarose plugs (75 μl) containing approximately 15 μg of high molecular weight DNA were prepared using a standard procedure (Kouprina and Larionov, Current Protocols in Human Genetics 1: 5.17.1-5.17.21 (1999).

(4) Characterization of YAC Clones

Chromosome size DNAs from yeast transformants carrying circular or linear YACs were separated by CHEF, blotted and hybridized with either a 5.7 kb alphoid probe which specifically hybridizes with the centromere of the chromosome Y or a Neo-specific probe. To estimate the size of circular YACs, agarose DNA plugs prepared from yeast transformants were exposed to a low dose of gamma-rays (5 krad) before TAFE analysis. At this dose approximately 10% of 100-200 kb circular DNA molecules are linearized (Larionov et al., proc. Natl. Acad. Sci. USA 93: 13925-13930, 1996).

(5) Labeling of DNA Probes

A 5.7 kb alphoid DNA fragment was labeled by nick-translation. A Neo-specific probe was labeled by PCR using a 300 bp fragment as a template. The fragment itself was amplified with a pair of primers developed for ORF of the Neo gene. By a similar way URA3 and HIS3 probes were prepared.

(6) Southern Blot Analysis

Southern blot hybridization was performed by utilizing ³²P labeled probes and the protocol described by Church and Gilbert (Proc. Natl. Acad. Sci. USA 7: 1991-1995,1984). The membrane blots were incubated for 2 hrs at 65° C. in a pre-hybridization solution: 0.5 M Na-phosphate buffer containing 7% SDS and 100 μg/ml salmon DNA. 20 μl of a labeled probe was heat denatured in a boiling water for 5 minutes and then snap cooled on ice. The Neo probe was added to the hybridization buffer and allowed to hybridize overnight at 65° C. The alphoid probe allowed to hybridize overnight at 78° C. (Oakey and Tyler-Smith, Genomics 7: 325-=330,1990). The hybridization solution was removed from blots and the blots were washed twice in 2×SSC (1×SSC is 150 mM NaCl and 15 mM sodium citrate, pH 7.0), 0.1% SDS for 30 min at room temperature. Then the blots were washed thee times in 0.1×SSC, 0.1% SDS for 30 min at 65° C. Blots were exposed to X-ray film for 24-72 h at −70° C.

(7) Fluorescent in situ Hybridization (FISH)

To analyze alphoid DNA in HT1080 fransfectants, 500 ng of a 5.7 kb alphoid DNA repeat from the Y chromosome was labeled with bio-11-dUTP using the Gibco BRL Nick Translation System. A mixture of 200 ng of biotinylated DNA and 30 μg of human CotI DNA (BRL) was hybridized to metaphase chromosomes in a volume of 27 μl under a cover slip (22×22 mm) as previously described with minor modification (McCormick et al 1993). After hybridization at 37° C. for about 19 h, slides were washed and stained using fluorescent avidin and counterstained with propidium iodide.

(8) Construction of the Vector pRS-Sat-Neo for Circularization of Linear YACs

The circularizing vector pRS-Sat-Neo was constructed as follows. First, the Neo fragment was amplified as a 2.7 kb fragment by PCR using a pair of primers containing overhanging NotI and XhoI sequences, in addition to the Neo site. PCR was performed using a BRV1 plasmid (Kouprina et al., Proc. Natl. Acad. Sci. UDA 95; 4469-4474,1998) as a template. The matched set of primers were: Neo Not Rev (5′-gcggatgaatggcagaaattcgat-3′) (SEQ ID NO:49) and Neo Xho For (5′-ccggctcgagctgtggaatgtgtgtcagttagg-3′) (SEQ ID NO:50). Then a 1.0 kb XmaI-BglII fragment was excised from the 2.7 kb Neo PCR product and cloned into SmaI-BamH sites of pRS313 (ARS-CEN6-HIS3-AmpR) (Sikorski and Hieter, Genetics 122: 19-27, 1989). The 1.0 kb fragment contains the Neo gene open reading frame but does not contain the SV40 promoter. Then a 110 bp alpha-satellite fragment was amplified by PCR using primers containing SalI sequences in addition to the satellite-specific primers. PCR was performed using human genomic DNA (Promega) as a templete. The matched set of primers were: Sat Sal Rev (5′-ACCGTCGACTCACAGAGTTGAA-3′ SEQ ID NO:47) and Sat Sal For (5′-ATTCCCGTTTCCAACGAAGG-3′ SEQ ID NO:48). Total length of the amplified alpha-satellite fragment was 117 bp. This alpha-sattelite fragment was cloned into pCRII plasmid (Invitrogen), then isolated as an EcoRI fragment and cloned into a EcoRI site of pRS-Neo. The constructed vector pRS-Sat-Neo was cut with SmaI (the site is located between the targeting sequences) before transformation to yield linear molecules bounded by the Sat and Neo hooks. Plasmid DNA isolation was performed using a Qiagen Plasmid Purification Kit. The standard lithium acetate procedure) was used for YAC circularization. Yeast transformants were selected on synthetic complete medium plates lacking histidine.

(9) Retrofitting of Circular YACs into BACs for Propagation in Bacterial and Mammalian Cells

Retrofitting of circular YACs into BACs was accomplished through the use of a yeast-bacteria-mammalian cell shuttle vector, BRV1, containing the F-factor origin of replication and the Neo^{R} gene (Kouprina et al, Proc. Natl. Acad. Sci USA 95: 4469-4474, 1998), by a standard lithium acetate transformation procedure. Yeast transformants were selected on synthetic complete medium plates lacking uracil. The retrofitted His⁺Ura⁺ YACs were moved to E. coli by electroporation.

(10) Transfer of YAC/BACs into E. coil Cells

Low-melting-point agarose plugs were prepared from yeast His⁺Ura⁺ transformants using a standard method (Kouprina and Larionov, Current Protocols in Human Genetics 1: 5.17.1-5.17.21 (1999)). One microliter of the melted and treated plug was electroporated into 20 μl of the E. coli DH10B competent cells (Gibco BRL) using a Bio-Rad Gene Pulser with the settings at 2.5 kV, 200 ohms and 25 μF. Colonies were selected on LB plates containing chloramphenicol at a concentration of 12.5 μg/ml.

(11) Restriction Analysis of BACs

BACs were isolated from E. coli utilizing a Qiagen Plasmid Purification kit (Cat # 12163, Qiagen Inc., Santa Clarita, Calif.). Restriction analysis was performed on BAC DNAs as follows. To estimate size of inserts, 5 μl of BAC DNA was digested with 0.1 U NotI restriction enzyme (New England Biolabs). The digestion was analyzed by CHEF (Clamped Homogeneous Electrical Field). To analyse the organization of the alphoid DNA inserts in BACs, 5 μl of BAC DNA was digested either with EcoRI, XbaI, SpeI or double digested with EcoRI and SpeI. Samples were loaded onto a 1.2% agarose gel in 1× TBE (0.09M Tris-borate, 0.002M EDTA).

(12) DNA Sequencing

5.7 kb EcoRI, 2.8 kb SpeI, 2.9 kb SpeI and 1.6 kb SpeI fragments containing blocks of satellite repeats were gel purified after a 250 kb BAC DNA digestion and cloned into either EcoRI or SpeI sites of the pRS313 plasmid (Sikorski and Hieter, 1989) for further sequencing analysis. DNA sequencing was performed using T3 and T7 primers and a Rhodamine Dye Terminator Cycle Sequencing Kit (Perkin Elmer, Catalog No 403 042) in conjunction with an automated DNA sequencer, Model 377 (Perkin Elmer).

b) Results

To isolate an alphoid DNA array from a functional centromere, we used normal human leukocytes and ΔYq74 hybrid cell line containing a fragment of the Y human mini-chromosome (Brown et al., Hum. Mol. Genet. 3: 1227-1237,1994; Heller et al., Proc. Natl. Acad. Sci. USA 93: 7125-7130,1996). This mini-chromosome was generated by two rounds of telomere-directed chromosome breakage (Barnett et al., Nulc. Acids Res. 21: 27-36,1993). One of the breakages that occurred within the centromeric array of alphoid satellite DNA deleted the entire long arm of the chromosome and thus generated a short arm acrocentric derivative, ΔYq74, composed of only 140 kb of alphoid DNA and the breakage construct. The resulting mini-chromosome was linear and sized at approximately 12 Mb. Cytogenetic analysis indicated that the mini-chromosome was stably maintained by cells proliferating in culture for about 100 cell divisions in the absence of any applied selection and segregated accurately at mitotic anaphase (Heller et al., Proc. Natl. Acad. Sci. USA 93: 7125-7130,1996). This result suggested that 140 kb of alphoid DNA is sufficient for accurate chromosome segregation but that other sequences may be required for full centromere function.

The strategy of isolation of the alphoid DNA arrays from the ΔYq74 hybrid cell line is based on our observation that a targeted chromosomal region can be rescued as a YAC by yeast transformation (Kouprina et al., Genome Research 8: 666-672, 1998). The truncation of the chromosome Y was done with the vector containing a human telomere, 5.7 kb of chromosome Y alphoid unit, the neomycin gene and a yeast cassette consisting of the URA3 selectable marker, an origin of replication and a centromere. Previously we have demonstrated that the targeted chromosomal region containing the minimum requirements for its propagation in yeast cells (CEN, ARS and a selectable marker) can be rescued as a YAC simply by transformation of the total genomic DNA into yeast spheroplasts and following selection for the marker. We proposed that selection for the URA3 marker present within the 12 Mb mini-chromosome would result in isolation of the chromosome region(s) containing a 140 kb block of alphoid DNA plus a flanking region in the form of linear or circular YACs. Two different scenarios for the rescue of this targeted region may be considered. The presence of multiple (TG)n telomere-like sequences that are frequent in human DNA (approximately once per 40 kb) and human telomere at the end of the mini-chromosome would provide an opportunity for circularization through homologous recombination and lead to generation of circular YACs. Alternatively, healing of only one broken end of the rescued chromosome fragment(s) in yeast by yeast-like telomeric repeats would lead to establishment of linear YACs. After transformation of yeast spheroplasts by genomic DNA isolated from the hybrid cell line ΔYq74 and following selection for the URA3 marker, we obtained a set of linear YACs of different size from 100 kb to 250 kb that suggested the second mechanism of rescue of the targeted region.

The alphoid DNA array from a normal Y chromosome has been isolated by a disclosed TAR cloning system that allows the cloning of genomic regions containing only monotonic repeats. This method utilizes a disclosed TAR vector that includes a yeast selectable marker (HIS3), a yeast centromere sequence (CEN6), a yeast origin of replication (ARSH4) and alphoid DNAs as targeting sequences. To eliminate a plasmid background during TAR cloning, a counter-selectable marker (SUP11) was incorporated between the alphoid DNA targeting sequences. Co-transformation of the vector and genomic DNA isolated from normal human leukocytes resulted in rescue of alphoid DNA arrays as circular 50-250 kb YACs. Approximately 7% of YACs contained alphoid DNA from the Y chromosomes.

To prove that the rescued YACs originated from the centromere of chromosome Y, we have used fluorescence in situ hybridization which provides a quick and direct method for localization of the YACs. Three YACs, 100 kb, 150 kb and 250 kb, chosen for this experiment exhibited one strong signal on the centromere of the chromosome Y under stringent conditions. They are in centromeric region of the Y human chromosome.

c) Retrofitting of YACs into BACs with the Mammalian Selectable Marker

BACs have advantages versus YACs because they can be easily purified by alkaline methods for further analysis. Thus, different YAC isolates containing the 100 kb, 170 kb and 250 kb alphoid DNA arrays from the Y chromosome were retrofitted by recombination with the vector BRV1 that contained a Neo^{R} marker and sequences that would enable subsequent propagation as a BAC. These BAC/YACs were then transferred to E. coli by electroporation, as described herein. CHEF analysis has shown that the alphoid DNA BACs are quite stable in bacterial cells. Digestion of the BAC DNAs with a NotI restriction enzyme gave one major predicted size band. Fractioning of the deleted BAC forms (visible as minor bands on electrophoregrams) does not exceed 5% in DNA preparations as judged by agarose electrophoresis.

d) Characterization of BACs Containing Blocks of Satellite Repeats

Tyler-Smith and Brown (1987) have shown that the alphoid DNA within the main block of chromosome Y is organized into tandemly repeating units, most of which are about 5.7 kb long. Each unit consists of 34 tandemly repeated about 170 bp monomers of alphoid DNA and contains a single EcoRI site (Tyler-Smith and Brown, J. Mol. Biol. 195: 457-470,1987). We have shown that indeed alphoid DNA arrays from the Y chromosome consists of two untis that can be identified by Spe I digection (see below). The BACs were digested with either EcoRI or SpeI and analyzed by gel electrophoresis and blot hybridization using alphoid DNA as a probe. The analysis has shown that inserts in 100 kb, 170 kb and 250 kb BACs contained exclusively alphoid DNA. EcoRI digestions generated a main 5.7 kb fragment corresponding to alphoid DNA unit. Intensity of other fragments corresponding to a vector and junction between a vector and an insert was much less. Similar results were obtained with SpeI BAC digestions. Isolation of the 250 kb alphoid DNA array which is bigger than that in the ΔYq74 suggests that this clone arose as a result of rearrangement of original material during isolation in yeast. Taking into account the number of repeats in a centromeric region, the smaller size rescued alphoid DNA arrays could also be rearranged.

During restriction analyses of the BACs we found that the alphoid 5.7 kb DNA unit contains two SpeI recognition sites. Digestion of the BACs by SpeI produced two fragments with size 2.8 kb and 2.9 kb. Because SpeI is a rare cutter enzyme, we supposed that SpeI digestion could be use to detect the chromosome Y-specific alphoid sequences in genomic DNAs. Indeed, we observed the 2.8 kb and 2.9 kb fragments seen on electrophoregrams of the SpeI digests of male genomic DNA. The complete sequence of a 5.7 kb alphoid DNA unit was not available; we therefore subcloned the SpeI fragments to determine nucleotide sequences of the entire unit. Based on sequence data, the unit consists of highly diverged monomers (FIG. 5A). This level of divergency (between 12% and 30% for different monomers) explains why large blocks of the alphoid DNA can be stably propagated both in yeast and E. coli hosts.

SpeI digestion of the BACs has also identified an additional 1.6 kb fragment containing ten alphoid DNA monomers. Sequence analysis has shown that this fragment contains palindromic duplication of alphoid DNA. Because we failed to detect this fragment in a SpeI digest of male genomic DNAs, we suggest that this inverted duplication was generated during chromosome fragmentation.

To conclude, our data indicate that in general the organization of alphoid DNA arrays in BAC isolates are similar to that in a the mini-chromosome ΔYq74. However, the isolated arrays can differ from the array in ΔYq74 by the number of alphoid DNA units.

e) Transfection of Alphoid DNA Constructs into Human Cells

Three BACs with different sized alphoid DNA arrays (100 kb, 170 kb and 250 kb) were purified as described in Materials and Methods and introduced into HT1080 cells by lipofection. Following transfection, the cells were placed on G418 selection for 14-18 days. Six drug-resistant colonies were then isolated for each BAC construct and analyzed by fluorescent in situ hybridization (FISH) after culturing off selection for 60 days using appropriate alpha-satellite and vector probes. In all 18 drug resistant clones screened by this method for identifying novel alpha-satellite containing chromosomal structures were observed. In 12 clones the transfected alpha-satellite DNA was integrated into endogenous human chromosomes. In 6 clones the transfected alpha-satellite DNA was present as a HAC as well as an integrated form on one of endogenous chromosomes. It should be noted that HACs were poorly visible after DAPI staining. Although the fraction of cells containing a HAC was variable between cell lines, HAC number per cell was most frequently one.

CENP-C has been detected only at the active centromere (Silvian and Schwartz, 1995). We therefore assayed for the presence of this protein on HACs generated by alphoid DNA constructs. Indirect immunofluorescence with CREST antibodies has shown that this protein is co-localized with a HAC.

To examine the size of HACs, genomic DNA from cell lines containing HACs was gently analyzed in agarose block, gamma-rays irradiated or digested by a rare cutting enzyme and analyzed by blot hybridization. Using these methods we failed to resolve any HAC by CHEF. Physical analysis of HACs was complicated by the presence of integrated copies of input DNA in transfectants. We can not exclude also that HACs are heterogeneous in size in cell population as a result of a loss and gain of alphoid DNA units during replication.

Because the original HAC constructs contain both BAC and YAC cassettes, the autonomously replicating forms of the HAC in human cells may be rescued by E. coli and yeast transformation with high efficiency. At the same time the rescue of integrated copies of the input DNA by transformation seems to be unlikely. Linear DNAs exhibit an extremely low transformation efficiency in E. coli and in yeast when recombination-deficient host strains are used (Larionov et al., 1994).

We decided to investigate organization of HACs by rescuing the HAC sequences by transformation. To identify optimal conditions for the rescue of HACs by transformation, all reconstruction experiments were done with HT1080 genomic DNA mixed with different amounts of the 150 kb alphoid BAC DNA (1, 2 and 10 copies per genome equivalent). These optimal conditions were used in our experiments on recovering HACs from human cells back into yeast and E. coli. A RecA bacterial strain DH10B and a RAD52 deficient yeast host strain were used for transformations. DNAs were prepared from five HAC-containing cell lines and from 5 HAC-negative cell lines carrying integrated copies of the input BAC constructs. The cells used for the rescue experiments passed 40 and 80 generations without selection. The DNAs were then transformed directly either to yeast spheroplasts or to E. coli cells using electroporation. Table 2 summarizes the results on yeast and E. coli transformation by genomic DNA isolated from HT1080 transfectants. As can be seen, both E. coli and yeast transformants can be obtained only with DNAs isolated from the cell lines positive for HACs based on FISH. No transformants were obtained with the same amount of DNA from HAC-negative clones. Based on the yield of transformants in reconstruction experiments with a known amount of BAC DNA, HAC-positive clones contained between 1 and 5 copies of autonomous form of the input DNA.

TABLE 2
Rescue of Autonomous Forms of Circular YAC/BACs After 100
Generations in Human Cells by Yeast Transformation

| | 100 kb YAC22 | 150 kb YAC11 | 250 kb YAC66 |
|---|---|---|---|
| | Neo^{R} transfectant | Neo^{R} transfectant | Neo^{R} transfectant |
| 1 | + | + | − |
| 2 | + | − | − |
| 3 | − | − | + |
| 4 | − | − | + |
| 5 | + | − | − |
| 6 | + | + | − |

Plasmid DNAs were isolated from E. coli and yeast transformants and compared with the original BAC constructs. Analysis of 30 isolates for each of the three BAC constructs (100 kb, 150 kb and 250 kb) has shown that all contain a predicted BAC/YAC cassette, the NeoR gene and the Y chromosome-specific alphoid DNA sequences. The size of the alphoid DNA arrays varied among individual isolates for each BAC construct. For DNA molecules rescued from a 100 kb MAC (e.g., HAC), the size of alphoid DNA array varied from 40 kb to 100 kb (40 kb, 50 kb, 65 kb, 70 kb; 85 kb, 90 kb and 100 kb); for DNAs rescued from a 150 kb HAC the size varied from 60 kb to 150 kb (60 kb, 70 kb, 75 kb, 85 kb, 110 kb, 130 kb, and 150 kb). Similarly, the size of BACs rescued from cells containing a 250 HAC varied from 50 kb to 250 kb (50 kb, 60 kb, 75 kb, 80 kb, 120 kb, 175 kb, 180 kb, 210 kb, 250 kb) in individual isolates. Because HACs are presumably multimers in human cells (Harrington et al., 1997, Ikeno et al., 1998; Henning et al., 1999; Ebersole et al., 2000) deletions in YAC/BAC isolates have arisen during a transformation procedure. Physical analyses of rescued BAC and YAC clones did not detect any non-alphoid DNA sequences, suggesting that HAC formation took place without an acquisition of the host DNA.

Physical analysis of the YAC clones isolated from normal Y chromosome and its deleted derivative, ΔYq74, has shown that the alphoid DNA array is not interrupted by nonhomologous sequences. Based on restriction mapping and sequencing results, the Y chromosome alphoid DNA array consists of both direct and inverted repeats of a 5.7 kb alphoid DNA unit. Comparison with the original chromosome has shown that inverted repeats identified in ΔYq74 have arisen during chromosome Y truncation. The presence of the inverted repeats indicates that the inverted nature of the repeats does not inhibit MAC function and may represent a means for inhibiting homologous recombination events that can take place with large arrays of tandem repeats.

Three different groups demonstrated the formation of HACs in HT1080 cells after transfection of constructs containing ˜a 100 kb block of alphoid DNA (Ikeno et al., Nature Biotechnol. 16: 431-439, 1998; Henning et al., Proc. Natl. Acad. Sci. USA 96: 592-597, 1999; Ebersole et al., Hu. Mol. Genet. 9: 1623-1631, 2000). Both linear YAC constructs containing telomeric sequences and circular BACs lacking telomeres were competent in MAC formation. Alphoid DNAs used for these studies were isolated from two human chromosomes (chromosome 17 and 21). The DNAs are characterized by uniform higher order repeats and frequent boxes, a conserved motif binding the CENP-B protein euro et al., J. Cell Biol. 116: 585-596, 1992). No HAC formation was observed with the construct containing a block of alphoid DNA lacking CENP-B boxes (Ikena et al., Nature Biotechnol. 16: 431-439,1998).

Our results demonstrate that the presence of a CENP-B binding sites is not required for de novo formation of kinetohore. BAC/YAC constructs with alphoid DNA arrays were isolated from chromosome 22 (this study) and from the Y human chromosome lacking the CENP-B binding sites (Floridia et al., Chromosoma 109: 318-327, 2000). Nevertheless the constructs efficiently produced HACs during transfection into HT1080 cells. The same yield of HACs was observed for constructs containing 250 kb and 100 kb of alphoid DNA, suggesting that the minimal size of alphoid DNA required for HAC formation could be even less than 100 kb.

The MAC/HAC constructs can contain both BAC and YAC cassettes, and those that do we showed that they can rescue HAC sequences from human cells by E. coli and yeast transformation. Physical analyses of the rescued BAC and YAC clones did not detect the presence of any non-alphoid DNA sequences, suggesting that HAC formation took place without an acquisition of the host DNA.

As has been shown in previous publications, formation of HACs is accompanied by multimerization of transforming DNAs (Harrington et al., Nature genetics 15: 345-355, 1997, Ikeno et al., Nature Biotechnol. 16: 431-439, 1998; Henning et al., Proc. Natl. Acad. Sci. USA 96: 592-597, 1999; Ebersole et al., Hum. Mol. Genet, 9: 1623-1631, 2000). Based on indirect measuring, the size of HACs in transfected cells varied between 2 Mb and 10 Mb. We failed to determine the size of HACs generated by the Y chromosome alphoid DNA array by separation of genomic DNA by CHEF followed blot-hybridization. The most reasonable explanation of that is a heterogenetity in HAC size in cell population. While we did not estimate the HAC size by a direct method, the following observations suggest that the HACs generated from the Y chromosome are maintained in human cells without a significant amplification. 1) The HACs generated by these constructs were poor visible on metaphase plates after DAPI staining. 2) Based on quantitative hybridization, vector-specific sequences, NeoR, URA3 and HIS3 are present in HAC-positive cell lines in 3-8 copies per genome. Because these lines also contain 1-2 integrated copies of the input BAC DNA, there should be no significant amplification of sequences in HAC. 3 The original input DNAs can be rescued from HAC-positive transfectants as BACs or YACs. It is known that megabase-size DNAs do not transform E. coli cells.

Additional experiments are required to confirm that in contrast to alphoid DNA arrays from chromosome 17 and 21, the Y chromosome alphoid DNA array generates HACs with a lower level of amplification of the input DNA.

Stable propagation of HACs in HT1080 cells suggests that the HACs not only segregate properly during cell divisions but also replicate in S-phase. It is unlikely that vector sequences (i.e. YAC and BAC cassettes) initiate DNA replication. Since no exogenous non-alphoid mammalian genomic DNA is contained in the YAC, it is more likely that DNA replication is initiated within the block of alphoid DNA. If this is a true, each alphoid DNA unit has a chance to initiate DNA replication similar to that observed for block of rDNA genes (Kouprina and Larionov, Current genetics 7: 433-438, 1983). This suggestion could explain a paradox of replication of large blocks of monotonic repeats in a mammalian centromeres.

The utility of an alphoid DNA construct for analysis of the kinetohore structure and gene expression depends on how easily the construct can be modified before transfection and how easily the HAC can be isolated from mammalian cells. The disclosed constructs contain both YAC and BAC cassettes. The presence of the two cassettes gives many advantages: a HAC construct can be easily modified in yeast by homologous recombination as a YAC and isolated as a BAC DNA from bacterial cells for transfection experiments. At the same time HAC sequences can be rescued from human cells by E. coli or yeast spheroplast transformation to analyze HAC rearrangements during its propagation. The opportunity to re-isolate HAC sequences both as a YAC or a BAC is important because both cloning systems have limitations and the sequences clonable in yeast can be unclonable in E. coli cells and vice versa.

### 2. Example 2

### A Strategy for Isolating of Human Centromeric DNA from Rodent/Human Cells by TAR Cloning

Centromeric regions are composed of different types of repetitive sequences and represent approximately 10% of human genome. Despite their importance for kinetohore study and for the construction of Human Artificial Chromosomes (HACs), these regions remain poorly characterized by prior efforts. The main reason for this is that long stretches of tandemly repeated centromere-specific DNA sequences could not be cloned by a standard YAC or BAC cloning technique.

A TAR (Transformation-Associated Recombination) cloning technology has been disclosed for the direct isolation of genes and chromosomal fragments of hundred kilobases in size from euchromatic regions of mammalian genomes. The approach is based on transformation of the yeast spheroplasts by a gently isolated total genomic DNA along with a TAR vector containing sequences homologous to a region of interest. The high selectivity of gene isolation by TAR is due to the omitting of a yeast origin of replication (ARS-like sequence) from a vector. As a consequence, a propagation of the TAR vector in yeast cells absolutely depends on acquisition of human DNA fragments with ARS-like sequences that can function as an origin of replication in yeast. These sequences are common in euchromatic regions (approximately one ARS-like sequence per 30 kb) that allows rescue of a region as a 50 kb or bigger size fragment.

In contrast, the isolation of specific fragments from heterochromatic regions (including centromeres and telomeres) cannot be accomplished by a routine TAR technique. These regions contain large blocks of repetitive sequences lacking an ARS consensus sequence. Disclosed is a new TAR-based cloning system that allows direct isolation of large fragments of genomic DNA from heterochromatic chromosomal regions lacking ARS-like sequences. FIG. 1 shows a scheme for the isolation of centromeric regions by a new cloning system. In the new system an ARS element is included into a TAR vector. To avoid a high background resulting from re-circularization of an ARS-containing vector during yeast transformation (Noskov et al., Nucl. Acids Res. 29: e32, s (2001)), a counter-selectable marker, SUP11, was included between specific targeting sequences in the vector. SUP11 encodes an ochre suppresser tRNA and even one copy of the gene is highly toxic for a prion-containing (psi-plus) yeast strain. As a consequence, autonomously replicating plasmids carrying SUP11 transform yeast cells very poorly. In addition, SUP11 suppresses an ade2-101 mutation in a host strain. Ade2-101 cells are red while in the presence of SUP11 they are white.

These two phenotypes (toxicity and color of the colony) provide selectivity of cloning. Simple vector re-circularization restores the SUP11 gene that would lead to a high level of cell lethality and change the color of the colonies to white. Recombination between targeting sequences in the vector and genomic DNA fragments (a centromeric fragment as shown in FIG. 1) deletes SUP11 sequences from the vector. Such colonies will be red.

To demonstrate the utility of a new technique for cloning of heterochromatic chromosomal regions, alphoid DNA arrays from five human chromosomes (11, 13, 15, 22 and Y) were isolated as DNA fragments of hundred kilobases in size and physically characterized. Table 1 summarizes size of isolates and their mapping by FISH. More detailed analysis was carried out for alphoid DNA arrays isolated from human chromosome 22 and the Y chromosome (DYq74). This array was isolated as a set of YAC/BAC clones from 100 kb to 250 kb. The inserts are composed by alphoid DNA only as can be seen after digestion by EcoRI. The digestion produces two main fragments 2.8 and 2.9 kb in size. Sequencing of the alphoid DNA array has shown that the array consists of direct repeats of a 5.7 kb unit (each unit contains thirty four copies of an about 170 bp monomer) and inverted repeats of a 1.6 kb unit (the unit contains 10 copies of an about 170 bp monomer: seven copies in one direction and three copies in another direction). Comparisons of monomers in 5.7 kb and 1.6 kb units are shown in FIG. 3 and FIG. 4 correspondingly. FIG. 5 summarizes data on sequence homology between different alphoid DNA monomers isolated from the DYq74 derivative of chromosome Y. For this alphoid DNA array we have also shown the formation of HACs after its transfection into human cells. Formation of a HAC by alphoid DNA arrays isolated from the Y human mini-chromosome has been shown. 170 kb BAC was transfected into HT1080 human cells. Co-localization of centromere-binding proteins and alphoid DNA probe to HACs has been shown. Based on these results, the disclosed system allows a direct isolation of centromeric (as well as other heterochromatic) regions from a mammalian genome for further structural/functional analysis and construction of a new generation of HACs. These general methods are

Selective cloning of human-specific alphoid DNA arrays from a rodent/human hybrid cell line as circular YACs is based on in vivo recombination in yeast. A mixture of DNA from hybrid cells and a linearized vector is presented to yeast spheroplasts. The vector contains a yeast selectable marker (HIS3), a yeast centromere (CEN), a yeast origin of replication (ARS) and alphoid DNA repeats at each end. Homologous recombination between alphoid DNA sequences in the vector and a human centromeric region leads to establishment of a circular YAC. Since rodent DNA does not contain human-specific alphoid DNA repeats, there should be no recombination of the vector with rodent DNA fragments. As a result, most of the yeast transformants contain circular YACs with human DNA inserts.

This TAR cloning system allows for isolation of centromeric regions that can not be cloned by standard techniques. A one day yeast transformation experiment may generate several hundred clones containing circular YACs with alphoid DNA inserts which represents a library of a specific centromere alphoid sequences. Isolation of alphoid DNA by TAR cloning from hybrid cell lines is highly specific. The size of alphoid DNA arrays isolated by TAR cloning can be varied, from about 80 kb to more than 500 kb.

a) Preparation of TAR Vector

TAR vector pVC-sat was purified by CsCl-ethidium bromide centrifugation and linearized by SmaI prior to transformation. The linearization yields molecules bounded by alpha-satellite sequences.

(1) Preparation of Chromosome-Sized DNA in Solid Agarose Plugs for TAR Cloning

Low-melting-point agarose plugs (each containing ˜5 μg of genomic DNA) were prepared from normal human leucocytes or from rodent or chicken somatic hybrid cells carrying either human chromosome 5, chromosome 16, chromosome 22, chromosome Y, or a mini-chromosome derived from Y. The cultured cells (˜5×10⁷) were harvested by centrifugation, resuspended in 4.0 ml of EDTA mix (50 mM EDTA; 10 mM Tris-HCl, pH 7.5) and placed in a 42° C. tempblock as 0.5 ml aliquots. An equal volume (0.5 ml) of 42° C. 1% melted agarose (BRL LMP agarose), prepared in 125 mM EDTA pH 7.5, was mixed by vortexing with each sample. (The final concentration of agarose should be equal to 0.5%.) 60-100 μl of the mixture was then gently placed in Ultra Micro tips (Fisherbrand, #21-197-2E). The tips were kept for 10-15 min. at 4° C. until the agarose had completely solidified. Each tip was placed into a 6 cc syringe lure and the plugs were released into a 50 ml coming tube by applying gentle pressure. The cells were lysed in NDS [500 mM EDTA; 10 mM Tris-HCl, pH 7.5; 1% N-lauroyl sarcosine pH 9.5; 5 mg/ml proteinase K (PK, BDH)] at 50° C. for 48 hours (all plugs were covered completely during incubation). To remove traces of the proteinase K, the agarose plugs were extensively washed with TE containing 50 mM EDTA and 10 mM Tris-HCl, pH 7.5. [One time during an hour at 50° C., then cooled to room temperature and washed at least 5-10 times (1 hour each wash)]. Chromosomal size DNAs were stored in TE solution at 4° C. Transverse Alternating Field Electrophoresis (TAFE) was used for analyzing DNA size. Agarose plugs (each ˜100 μl) were treated with 1-2 units of agarase prior to spheroplast transformation.

(2) TAR Cloning of Centromeric Regions

Spheroplasts, that enable efficient transformation, were prepared using a modified method previously described for standard YAC cloning (Kouprina and Larionov, Current Protocols in Human Genetics 1: 5.17.1-5.17.21 (1999)). An individual colony of a host yeast strain was inoculated in 50 ml of supplemented YPD broth (in a 500 ml flask) and grown overnight at 30° C. with vigorous shaking to assure good aeration until an OD₆₆₀ of ˜1.0 was achieved (the actual measurement is from 0.09 to 0.13 after diluting 1/10 in water). Cells were collected by centrifugation at 3,100×g for 3 min. at 5° C. and then washed once with 20 ml of sterile water followed by an additional washing with 20 ml of 1.0 M sorbitol. The cells were resuspended in 20 ml of SPEM (1.0 M sorbitol; 0.01 M Na phosphate, pH 7.5) containing 20 ul of zymolyase (20T) (10 mg/ml), 40 μl of beta-mercaptoethanol (14 M) and incubated at 30° C. for ˜20 min. with slow shaking. (The treatment time conditions varied depending on the zymolyase stock). The cells were checked for percent spheroplasts. (Zymolyase treated cells were diluted 1/10 in 1.0 M sorbitol and 1/10 in 2% SDS. The spheroplasts were determined to be ready when the difference between the two OD₆₆₀ readings is 3 to 7 fold). The cells were collected by a low centrifugation at 300-800×g for 10 min., washed gently 2-3 times in 20 ml of 1.0 M sorbitol and resuspended gently in 2.0 ml of STC (1.0 M sorbitol; 10 mM Tris, pH 7.5; 10 mM CaCl₂). The spheroplasts are stable at room temperature for at least one hour. Agarose plugs were placed in DMSF (1:100 in 25 mM NaCl), incubated for 60 min. at room temperature and then washed twice in 25 mM NaCl for 60 min. at room temperature before transformation. One microgram of the linearized pVC-sat TAR vector (1-10 μl) and one agarose plug containing ˜5 μg of genomic DNA were mixed, incubated at 68° C. for 5-10 min. in order to melt agarose and then placed at 42° C. for 10 min. The mixture was incubated with one unit of agarase [10 μl of ten-fold diluted enzyme (Boehringer Mannheim) in 25 mM NaCl] at 42° C. for 15 min. 450 μl of competent yeast spheroplasts were gently added to the DNA mixture and incubated for 10 min. at room temperature. Subsequently, 4.5 ml of PEG solution (20% PEG 8000; 10 mM Tris, pH 7.5; 10 mM CaCl₂) was gently added to the mixture, incubated for 10 min. at room temperature and centrifuged for 10 min. at 600×g at 5° C. The settled transformed spheroplasts were gently resuspended in 2.0 ml of SOS (1.0 M sorbitol; 6.5 mM CaCl₂; 0.25% yeast extract; 0.5% bactopeptone), incubated for 40 min. at 30° C. without shaking, then gently mixed with 8.0 ml of melted TOP agar (48° C.) and quickly plated. The plates were kept at 30° C. for 5-8 days until the transformants were visible.

(3) Characterization of YAC Clones

TAR cloning experiments were carried out with genomic DNAs prepared five different monochromosomal hybrid cell lines. Approximately 1,000 His⁺ colonies were obtained for each DNA. To identify transformants containing centromeric DNA, the transformants were combined into 40 pools and examined by PCR. A pair of primers was utilized that identifies an alphoid DNA sequence that is not present in a TAR vector. From five to twelve pools were identified that yielded PCR products specific to alphoid DNA for each genomic DNA. Individual clones containing alphoid DNA arrays were isolated from each pool for further analysis. To estimate the size of circular YAC isolates, agarose DNA plugs were prepared from individual transformants and exposed to a low dose of γ-rays (5 Krad) before TAFE analysis. A specific alphoid DNA probe for detection of human YACs generated by TAR cloning vectors was used. The probe is a 120 bp fragment from the 3′ end of the alphoid DNA monomere sequence that is omitted in the TAR vector described above. The alphoid probe was labeled with ³²P dCTP using PCR. Clones with a large blocks of alphoid DNA were also analyzed by endonuclease restriction.

(4) Transfer of Retrofitted YAC/BACs into E. coli Cells

YAC isolates were retrofitted into BACs with a mammalian selectable marker using BRV1 vector. Low-melting-point agarose plugs were prepared from yeast transformants using a standard method (Kouprina and Larionov Current Protocols in Human Genetics 1: 5.17.1-5.17.21 (1999).

Before electroporation into E. coli cells, the plugs were treated as follows. The plugs were washed 6 times in 1× TE (1 mM EDTA, 10 mM Tris-HCl, pH 8.0), for at least an hour the first 5 washes, and then overnight in 0.5× TE for the final wash. Then the plug (approximately 100 μl) was melted at 68° C. for 15 min., cooled to 45° C. for 10 min., treated with 1.5 unit of agarase for 1 hour at 45° C. and chilled on ice for 10 min. The treated plug was diluted 1:1 with 0.5× TE. One microliter of the mixture was electroporated into 20 μl of the E. coli DH10B competent cells (Gibco BRL) using a Bio-Rad Gene Pulser with the settings 2.5 kV, 200 oms, and 25 uF. Colonies were selected on LB plates containing chloramphenicol at a concentration of 12.5 ug/ml.

(5) Preparation of BAC DNA from E. coli Cells

TB medium (100 ml) containing 12.5 μg/ml chloramphenicol was inoculated with an individual bacterial colony containing a BAC and grown overnight. The cells were collected at 4,000× g for 20 min. at 4° C., resuspended in 10 ml of solution I (50 mM glucose; 25 mM Tris-HCl, pH 8.0; 10 mM EDTA) and lysed with 2.0 ml of freshly prepared solution of lysozyme (10 mg/ml in 10 mM Tris, pH 8.0). The lysed cells were mixed thoroughly by gently inverting the bottle several times with 20 ml of freshly prepared alkaline solution (0.2 N NaOH, 1.0% SDS) and stored at room temperature for 10 min. Then 20 ml of ice-cold acetic acid-containing solution (3.0 M potassium acetate; 5.0 M glacial acetic acid) was added and mixed by shaking the bottle several times before placing the sample on ice for 10 min. The bacterial lysate was centrifuged at 4,000×g for 30 min. at 4° C. The supernatant was filtered through four layers of cheesecloth and mixed with 0.6 volume of isopropanol and stored for 10 min. at room temperature. The DNA was recovered by centrifugation at 5,000×g for 20 min. at room temperature. The DNA pellet was dissolved in 3.0 ml of TE (pH 8.0) and purified by a QIAGEN column. The BAC DNA was ethanol precipitated and resuspended in 200 μl of TE. 20 μl of DNA solution was usually used for physical analysis. General TAR procedures can be found in Kouprina, N. and Larionov V. Selective isolation of mammalian genes by TAR cloning, Current Protocols in Human Genetics 1: 5.17.1-5.17.21 (1999) which is herein incorporated by reference.

### 3. Example 3

### Vector for TAR Cloning of Centromeric DNA

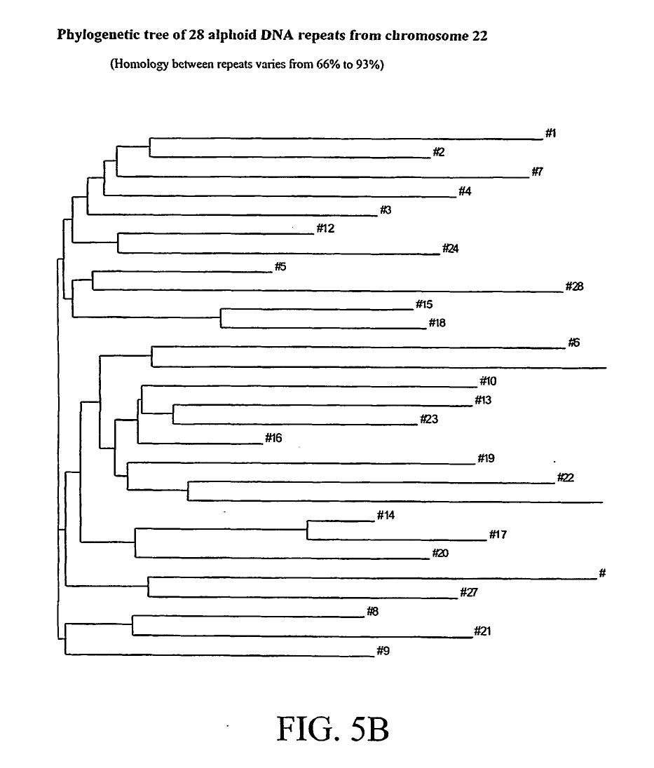

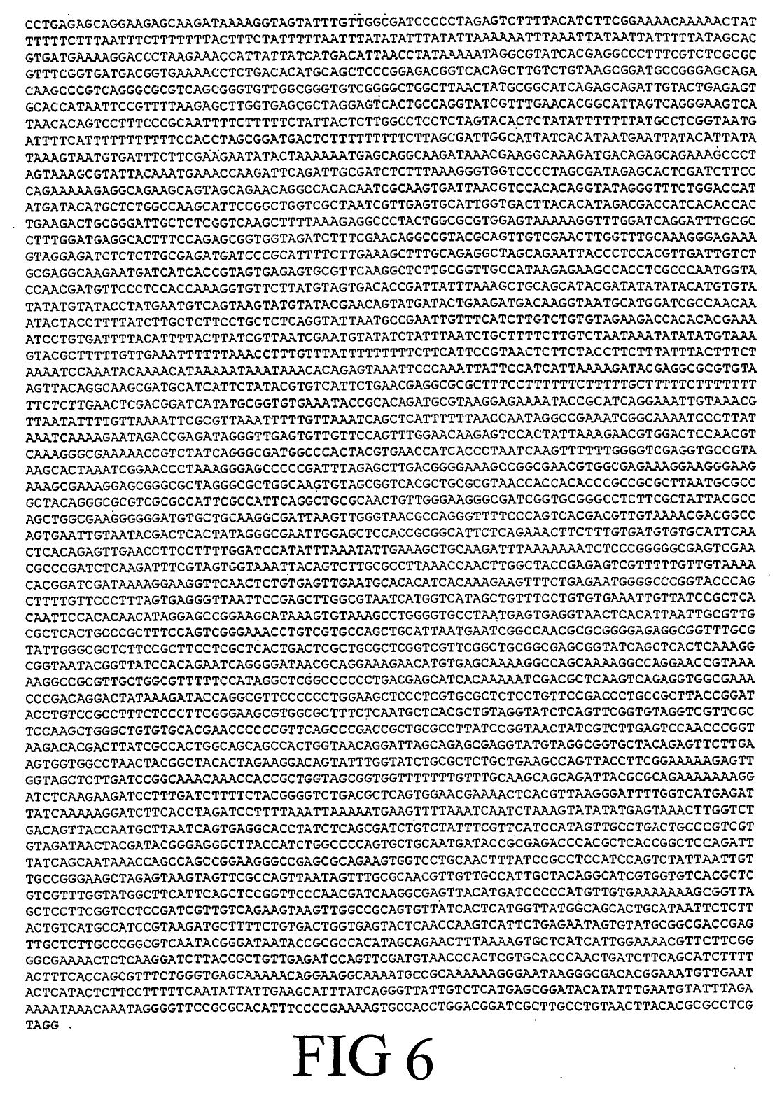

The vector, pVC-sat, was constructed using the TAR vector pVC604 described in Noskov et al., Nucleic Acids. Res., 29(6):e32 (2001). The pVC604 vector contains yeast centromere (CEN) and yeast selectable marker (HS 3). The vector also contains a ColE1 bacterial origin of replication and Amp resistance gene. To generate the pVC-sat vector capable of cloning blocks of centromeric repeats the following steps were carried out: a) ˜150 bp yeast ARS sequence, ARSH4, was cloned into a unique NsiI site of pVC604 (position 1530); b) 60 bp alphoid DNA sequence was synthesized based on published alphoid DNA monomer consensus sequence; c) two copies of the 60 bp sequence corresponding to 5′ end of an about 170 bp alphoid DNA consensus were cloned into a polylinker of pVC604+ARSH4 as ApaI-ClaI and BamHI-SacII fragments. The alphoid targeting sequences were cloned in a vector in opposite orientation because we previously demonstrated that if two identical targeting sequences are cloned as a direct repeat in a TAR vector there would be no capture of genomic DNA. Instead there is an efficient circularization of the vector by intramolecular recombination (Larionov et al., Proc. Natl. Acad. Sci. USA 93: 13925-13930, 1996); d) A 140 bp fragment containing SUP11 gene was PCR amplified from yeast genomic DNA and cloned as a ClaI-Bam HI fragment between the two satellite targeting sequences. There is an unique SmaI site in SUP11. This site was used for linearization of the vector before TAR cloning. The schematic of this vector is shown in FIG. 1 and the sequence of this vector is shown in FIG. 6.

### 4. Example 4

### Isolation of Genomic Regions Containing Blocks of Satellite Repeats By Tar Cloning

TAR cloning provides a unique opportunity to selectively isolate any region of human DNA. We have adopted TAR cloning for isolation of blocks of alphoid DNA from human centromeres. A series of circular TAR vectors containing different parts of the consensus satellite unit as targeting sequences in direct and inverted orientations were constructed as described herein in Examples 1 and 2. Homologous recombination between satellite sequences in the vector and a human centromere should lead to establishment of circular YACs with inserts of different size (FIG. 1).

Genomic DNA was gently prepared from the MRC-5 human fibroblasts and presented to yeast spheroplasts along with FseI-linearized TAR vectors (SAT-CEN6-HIS3-SAT-Sup11) as described in Examples 1 and 2. Utilizing 5 μg of genomic DNA, 1 μg of the vector and 2×10⁹ spheroplasts, there were approximately 20-30 transformants per experiment. In 5 independent transformation experiments, 130 His⁺ transformants were obtained. All the transformants were checked for the presence of alphoid DNA by dot-hybridization using a Sat-probe as described in Larionov V., Kouprina N., Graves J., and Resnick M. A. Specific cloning of human DNA as YACs by transformation-associated recombination. Proc. Natl. Acad. Sci. USA 93: 491-496, 1996. Since the Sat-probe has no homology to the TAR vector and targeting satellite sequences, it was indicative for the presence of alphoid DNA in TAR-YACs. Among 130 transformants, nearly 75% (98/130) contained alphoid DNA, suggesting a high selectivity of cloning of centromere DNA. Intensity of the radioactive signal was different for different isolates, indicating the different number of satellite units in the inserts. For further analysis we chose the 60 His⁺ isolates with the biggest number of satellite units (based on the strongest radioactive signals). First, to assure that recombination occurred between satellite sequences present in the TAR vector and satellite units of human centromere, the YAC ends were rescued in E. coli and sequenced. Sequence analysis showed that YAC ends consist exclusively of alphoid DNA units. Isolation of YAC ends by plasmid rescue: the YAC ends were isolated as decsribed in (Methods in Molecilar Biology Volume 54, YAC protocols, edited by David Markie, p. 139-144); the DNA isolated from the yeast transformants containing YACs was digested by EcoRI; after ligation and electroporation into E. coli, the rescued plasmids (AmpR) were checked for the absence of inserts and then isolated for further sequence analysis. Secondly, to assign each isolate to a certain centromere, fluorescence in situ hybridization (FISH) analysis was carried out with yeast DNA prepared from each independent transformant. FISH analysis showed that the satellite-positive isolates map to or near human centromeres, but in most cases we observed more than one signal which is consistent with a previous observation that some satellite sequences cross hybridize with different centromeres (FIG. 13, 15 and Table 1). To determine the size of the inserts, the YACs were characterized by CHEF separation of chromosome size DNAs followed by probing with the Sat-probe. The size varied from 50 kb to 400 kb (Table 1). Some isolates contained more than one band that is in agreement with previous observations that blocks of satellite DNA are unstable in wild type yeast host strains. To determine if the inserts derive from different regions of centromere, the DNAs from yeast isolates were digested by HindIII, EcoRI or XbaI, gel separated and hybridized with Alu-, LINE- and Sat-probes. Nine isolates from sixty were Alu and/or LINE positive (Table 1), suggesting that these isolates are likely from pericentromeric regions of centromere. Indeed, analysis of the unique sequences from the Alu and LINE positive fragments of clone 25 mapped on centromere 2 revealed that this clone derives from the 2p11.1 pericentromeric region (contig NT_{—}022171.6; positions 1665802-1665119, for example). For further analysis, to be certain what centromere the clones derive from, we TAR-cloned alphoid blocks from genomic DNA prepared from a monochromosomal hybrid cell line containing a single human chromosome 22 and characterized them in more detail (see below). Among 100 transformants analyzed, nearly 40% (39/100) contained alphoid DNA. The size of inserts varied from 50 kb to 200 kb. FISH analysis assigned each isolate to the centromere of chromosome 22. Seven BACs were Alu-positive, suggesting that they derive from the pericentromeric region of centromere 22.

Thus, we concluded that TAR cloning is very effective in isolation of human centromere regions.

a) Rescue of Blocks of Satellite Repeats of Chromosome Y from Minichromosome ΔYq74

We also isolated an alphoid DNA array from a ΔYq74 hybrid cell line containing a fragment of the Y human mini-chromosome (Brown et al., 1994; Heller et al., 1996). This mini-chromosome was generated by two rounds of telomere-directed chromosome breakage (Barnett et al., 1993). One of the breakages that occurred within the centromeric array of alphoid satellite DNA deleted the entire long arm of the chromosome and thus generated a short arm acrocentric derivative, ΔYq74, composed of only 140 kb of alphoid DNA and the breakage construct. The resulting mini-chromosome was linear and sized at approximately 12 Mb.

Two different strategies were used to isolate the alphoid DNA array from genomic DNA of the ΔYq74 hybrid cell line. The first strategy was based on our observation that a targeted chromosomal region can be rescued directly (Kouprina et al., 1998). Briefly, if a targeted chromosomal region contains the minimum requirements for its propagation in yeast cells (CEN, ARS and a selectable marker) it can be rescued as a YAC simply by transformation of the total genomic DNA into yeast spheroplasts and following selection for the marker. Because truncation of the chromosome Y was done with the vector containing a yeast cassette, we proposed that selection for the URA3 marker would result in isolation of the chromosome region(s) containing a 140 kb block of alphoid DNA plus a flanking region in the form of linear or circular YACs. Two different scenarios for the rescue of this targeted region may be considered. The presence of multiple (TG)n telomere-like sequences that are frequent in human DNA (approximately once per 40 kb) and the human telomere at the end of the mini-chromosome would provide an opportunity for circularization through homologous recombination and lead to generation of circular YACs. Alternatively, healing only one broken end of the rescued chromosome fragment(s) in yeast by yeast-like telomeric repeats would lead to establishment of linear YACs. After transformation of yeast spheroplasts by genomic DNA isolated from the hybrid cell line ΔYq74 and following selection for the URA3 marker, we obtained 20 Ura⁺ transformants containing linear YACs of different size from 100 kb to 250 kb that proved the second mechanism of rescue of the targeted region. The alphoid DNA array of ΔYq74 has been also isolated by a TAR cloning system allowing the cloning of genomic regions containing only monotonic repeats. A new TAR vector includes a yeast selectable marker (HIS3), a yeast centromere sequence (CEN6), a yeast origin of replication (ARSH4) and alphoid DNAs as targeting sequences. To eliminate a plasmid background during a TAR cloning, a counter-selectable marker (SUP11) was incorporated between the alphoid DNA targeting sequences. Co-transformation of the vector and genomic DNA isolated from the ΔYq74 cell line resulted in rescue of the alphoid DNA array as circular 50-250 kb YACs.

To prove that the rescued YACs originated from the centromere of chromosome Y, we have used fluorescence in situ hybridization, which provides a quick and direct method for localization of the YACs. Three YACs, 100 kb, 150 kb and 250 kb, chosen for this experiment exhibited one strong signal on the centromere of the chromosome Y under stringent conditions. FISH analysis was conducted, briefly as follows. FISH was carried out according to the method desrcibed in Yang J W, Pendon C, Yang J, Haywood N, Chand A, Brown W R. Human mini-chromosomes with minimal centromeres. Hum Mol Genet 2000 9:1891-1902. Cells were cultured as above, cultured to mid-log phase and colcemid added to 0.1 μg/ml. Cells were cultured for a further 2-3 h and then harvested, swollen in hypotonic solution (40 mM KCl, 0.5 mM Na2EDTA, 20 mM HEPES, pH 7.4) for 10 min at 37° C., pelleted and fixed in methanol/acetic acid at −20° C. The nuclei were dropped onto microscope slides, dehydrated in ethanol, and denatured in 70% formamide, 2×SSC for 5 min at 70° C. Probes for hybridization were nick-translated with biotin-16-dUTP (Roche) and hybridized in 50% formamide, 10% dextran sulphate, 2×SSC, 40 mM sodium phosphate pH 7.0, 1× Denhardt's solution, 0.5 mM Na2EDTA, 120 μg/ml sonicated salmon sperm DNA at 42° C. overnight. Biotin-labelled probe was detected with Cy3-conjugated avidin (Amersham Pharmacia Biotech, Little Chalfont, UK) and the signal was amplified with biotin-conjugated goat anti-avidin (Vector Laboratories, Peterborough, UK) and a second round of Cy3-conjugated avidin. Chromosomes and nuclei were counterstained with DAPI at 0.5 μg/ml.

b) Physical Characterization of YAC/BACs Containing Blocks of Satellite Repeats from Centromere of Chromosome 22 and Y

BACs have advantages versus YACs because they can be easily isolated by alkaline method for further analysis. Therefore, three circular YAC isolates containing alphoid DNA arrays from chromosome Y and eleven isolates from chromosome 22 were retrofitted by recombination in yeast with the vector BRV1 that contains sequences that would enable subsequent propagation in E. coli as BACs. These YAC/BACs were then transferred to E. coli by electroporation, as described herein. BAC DNAs from 10 independent E coli transformants for each YAC/BAC were isolated, digested with NotI and CHEFgel separated to determine the size of BAC inserts after electroporation. Analysis has shown that for most clones the alphoid DNA BACs kept the same size as original YACs and were reasonably stable in bacterial cells. Digested BAC DNAs gave one major predicted size band. The fraction of deleted BAC forms (visible as minor bands on electrophoregrams) did not exceed 5% in DNA preparations.

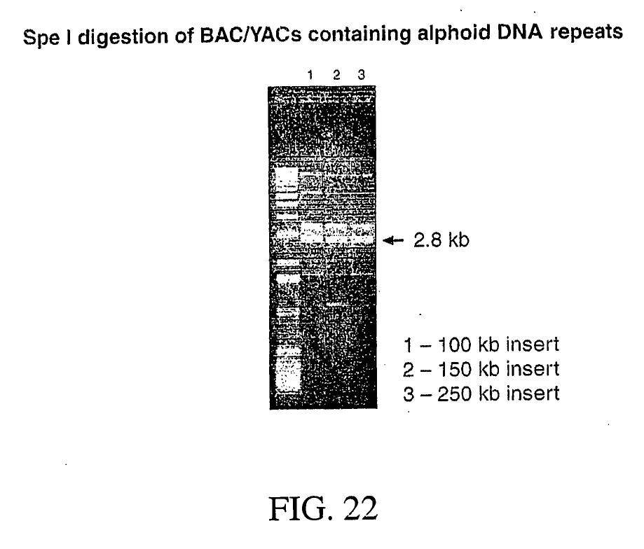

The alphoid DNA within the main block of chromosome Y is organized into tandemly repeating units, most of which are about 5.7 kb long. Each unit consists of 34 tandemly repeated 171 bp monomers of alphoid DNA and contains a single EcoRI site and a pair of XbaI sites (McDermid. In order to determine whether the isolated alphoid DNA arrays from ΔYq74 have the same organization, the BACs were digested with either EcoRI or XbaI, separated by gel electrophoresis and blot hybridization using a 5.7 kb alphoid DNA fragment as a probe. The analysis has shown that inserts of 100 kb, 120 kb and 140 kb BACs consist exclusively of alphoid DNA. EcoRI digestions generated a main 5.7 kb fragment corresponding to alphoid DNA. The intensity of other fragments corresponding to a vector and junction between a vector and an insert was much less. Similar results were obtained with XbaI BAC digestions. During restriction analyses of the BACs we found that the alphoid 5.7 kb DNA unit contains two SpeI recognition sites. Digestion of the BACs by SpeI produced two fragments with size 2.8 kb and 2.9 kb (FIG. 22). Because SpeI is a rare cutter enzyme, we supposed that SpeI digestion could be used to detect the chromosome Y-specific higher order alphoid sequences in genomic DNAs. Indeed, we observed only 2.8 kb and 2.9 kb fragments seen on electrophoregrams of the SpeI digests of male genomic DNA. To conclude, our data indicate that in general the organization of alphoid DNA arrays in TAR YAC/BAC isolates are similar to that on centromere of chromosome Y.

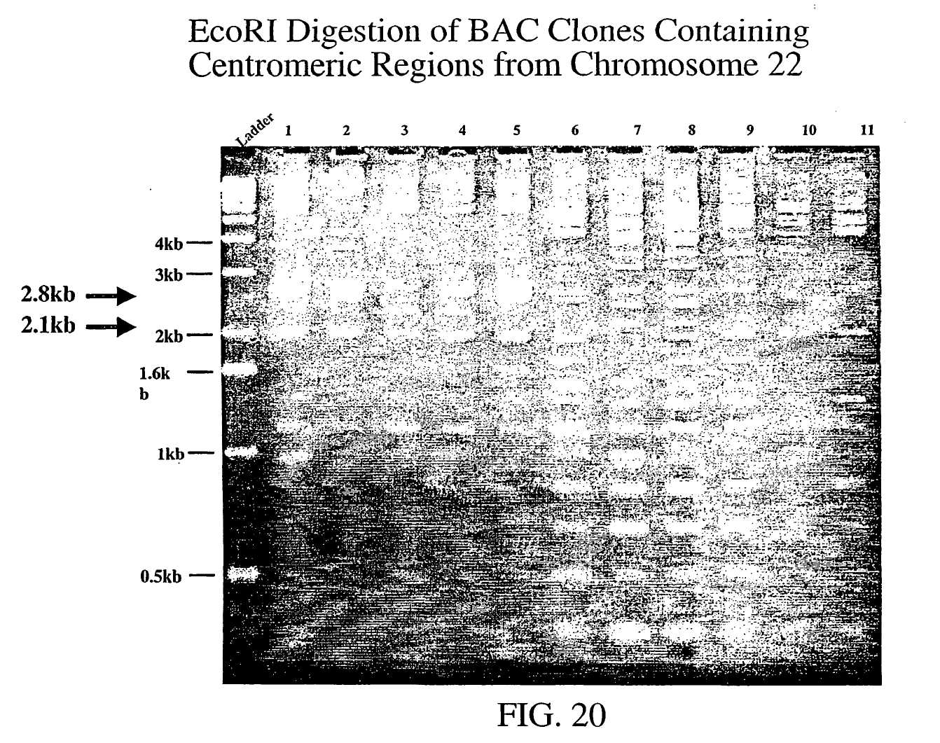

The alphoid DNA within the main block of chromosome 22 is organized into tandemly repeating units, most of which are about 2.1 kb and 2.8 kb long. Each unit consists of 12 and 16 tandemly repeated 171 bp monomers of alphoid DNA, respectively, and contains a single EcoRI site. The complete DNA sequences of 12 and 16 tandemly repeated units are shown in SEQ ID NO:53 and SEQ ID NO:54. The positions of the repeats in the 2.1 kb fragment are 1, 172, 342, 512, 683, 854, 1025, 1196, 1366, 1537, 1708 and 1888. The positions of the repeats in the 2.8 kb fragment are 1, 172, 342, 507, 678, 848, 1019, 1189, 1360, 1531, 1702, 1872, 2043, 2214, 2382 and 2553. The percent divergence between units was 78%. The structure of each repeating unit is readily discernable in the disclosed sequences. In order to determine whether the TAR-isolated alphoid DNA arrays have the same organization as on chromosome, the BACs were digested with EcoRI, separated by gel electrophoresis and blot-hybridized with a Sat-probe. The analysis has shown that inserts of most of the BACs consist exclusively of alphoid DNA but the restriction profiles are different. For BACs 9, 11, 14, 19 and 35, EcoRI digestion generated two main fragments, 2.1 kb and 2.8 kb (FIG. 14), suggesting that these alphoid DNAs derive from a very monogenic array characteristic for higher order structure. For BACs 3, 5, 6, 10, 15 and 20, EcoRI digestion generated multiple bands with periodicity of 171 bp, suggesting more diversity between satellite units (FIG. 20). Fluorecence in situ hybridization performed with BAC clones 14 and 5 showed hybridization signals on chromosome 22 only by metaphase FISH. Co-localization to the centromeric region suggested a possible overlap. To further define their relative physical position, a fiber FISH high resolution mapping was performed (FIG. 13). The result demonstrates some overlap of BACs 14 and 5 detecting one or probably two regions of hybridization for the BAC 14 (Spectrum Orange) within the long stretch of BAC 5 (Spectrum Green) that has a homology to the extended area of the centromere, most likely due to a presence of the chromosome 22 specific repeat(s).

c) Alphoid DNA Contains ARS-Like Sequences that can Function as Origin of Replication in Yeast

ARS-like elements that act as an origin of replication in yeast are short (approximately 50 bp) AT-rich sequences containing a non-conserved 17 bp core consensus (Theis and Newlon 1997). Random clones with inserts from euchromatic genomic regions carry on average one ARS-like sequence in 20-40 kb (Stincomb et al., 1980) as detected by ability to transform yeast cells with a high efficiency. In contrast genomic regions corresponding to a large block of repeats such as alphoid DNA repeats in the centromere may not contain ARS-like sequences. To investigate the presence of ARS-like sequence in alphoid DNA arrays, alphoid DNA from TAR BAC clone 11 (chromosome 22) was digested by Sau3A and cloned into a URA3-CEN6 yeast vector, lacking an origin of replication. Two thousand randomly selected recombinant plasmids were purified from E. coli and transformed into yeast spheroplasts. Forty-eight clones exhibited a high transformation efficiency comparable to that for a yeast ARS/CEN vector, suggesting that these inserts contain an yeast origin of replication sequence(s). Indeed sequence analysis of these clones revealed several ARS-like elements corresponding to the published ARS consensus sequence WWWTTTAYRTTTWDTT (Theis and Newlon 1997). All these sequences were located in positions 126-141 of an about 171 bp alphoid DNA monomer (FIG. 23 & SEQ ID NO:52). Because we did not find good matches to the ARS consensus sequence in each satellite unit, we conclude that presence of ARS-like elements is unlikely a general property of human alpha satellite DNA. In agreement with such conclusion, we failed to detect ARS-like sequences in alphoid DNA arrays isolated from Y human chromosome and ΔYq74 minichromosome.

d) Sequence Analysis of Alphoid DNA Arrays

The complete sequence of a 5.7 kb alphoid DNA unit from chromosome Y was not available. Therefore, we subcloned the 2.8 kb and 2.9 kb SpeI fragments and determined nucleotide sequence of the entire unit The sequences were divided into 171 bp monomers and aligned to maximize monomer similarity. Values of divergence were calculated for pair wise comparisons of all 34 monomers. The 5.7 kb unit contains type A monomers (pJα sites only), which is not surprising because the centromere of chromosome Y does not contain CENP-B binding sites (Table 2) (Cooper et al. 1993; Tyler-Smith et al., Nat. Genet. 5:368-375, 1993). These monomers are highly diverged: the average divergence from the consensus sequence is 0.116 (32% divergence). This is an example of absence of frequent homogenization events suggesting that they are not subject to concerted evolution (Nei et al., Proc Natl Acad Sci USA 97:10866-10871, 2000). A neighbor-joining phylogenetic tree (FIG. 5? Yes this is correct) shows that only a few monomers may have been duplicated relatively recently (e.g. pairs sat19-sat22 and sat20-sat23). A high level of divergence (between 12% and 30% for different monomers) explains why these blocks of alphoid DNA quite stably propagate both in yeast and E. coli hosts.

Sequence analysis of 2.1 kb and 2.8 kb units cloned from BAC11 containing alphoid DNA from chromosome 22 revealed that they also primarily contain type A monomers; there are only a few highly diverged B monomers (having CENP-B binding sites) found (Table 3). In contrast, satellite units from BAC5 that, based on restriction analysis, are not organized in higher order structure contain a mixture of A and B monomers (Table 3); this is a typical situation for autosomal alpha satellite DNA (reviewed by Alexandrov et al. 2001).

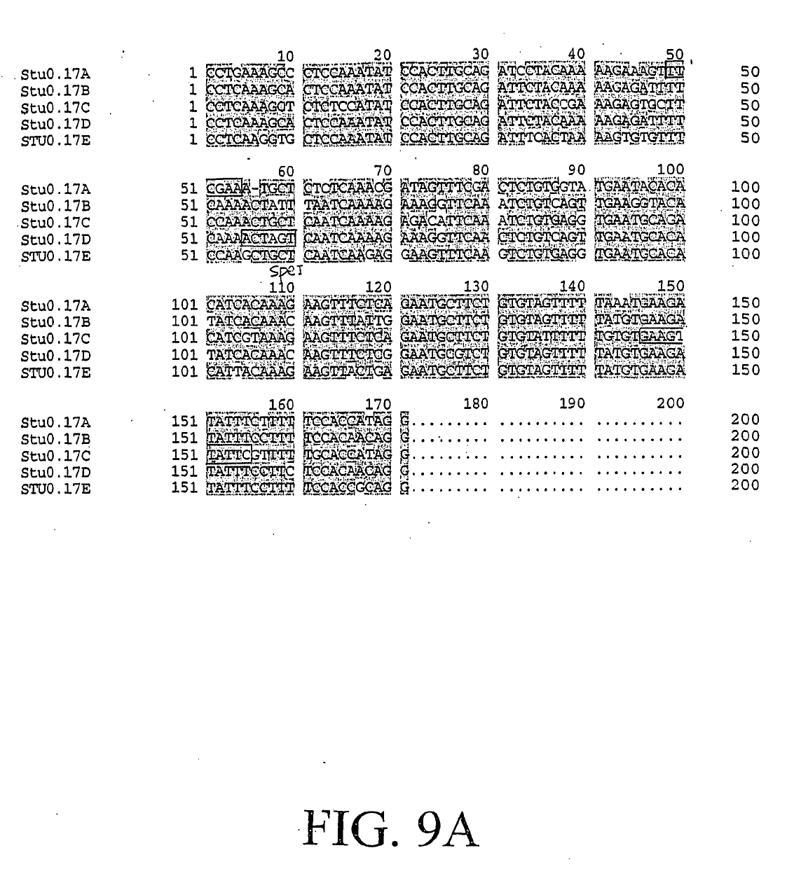

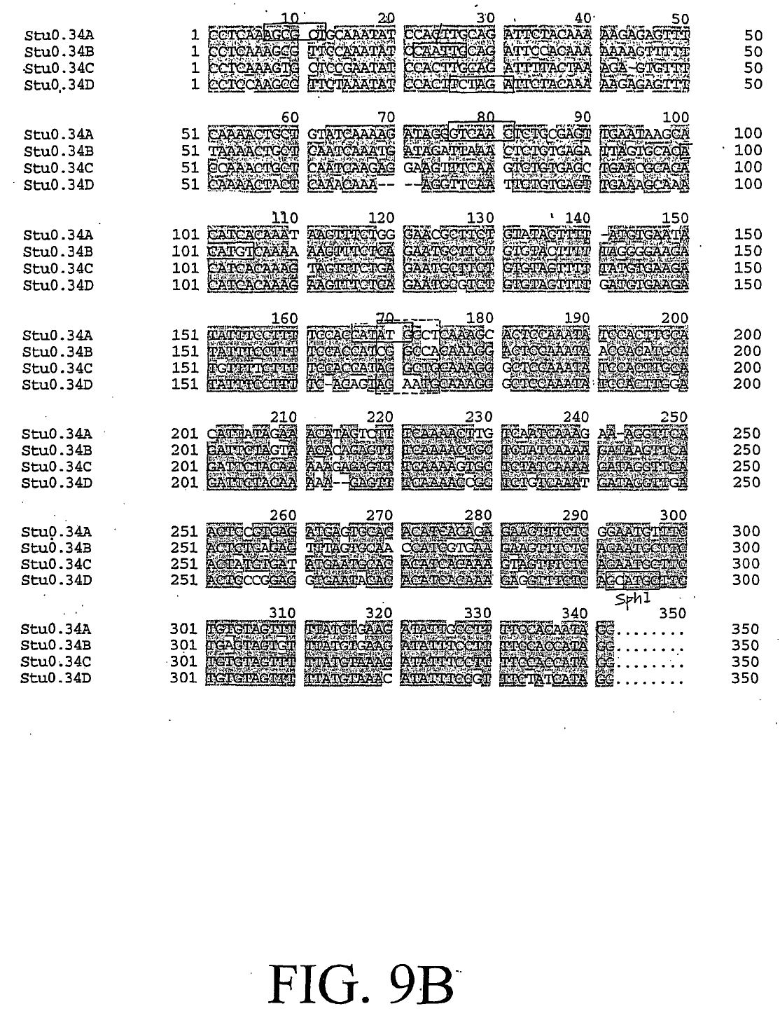

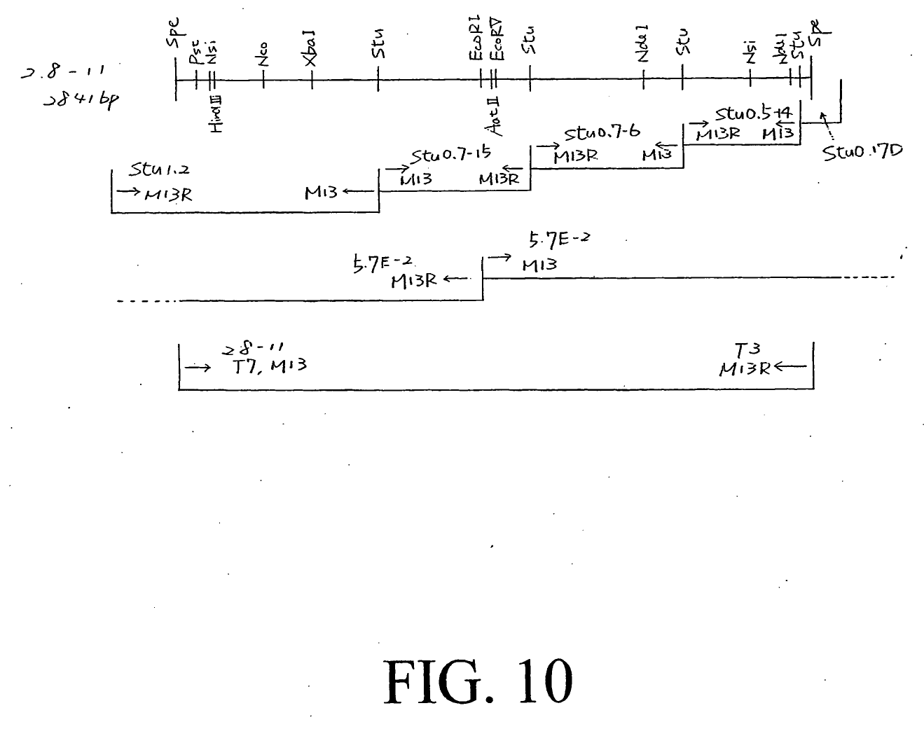

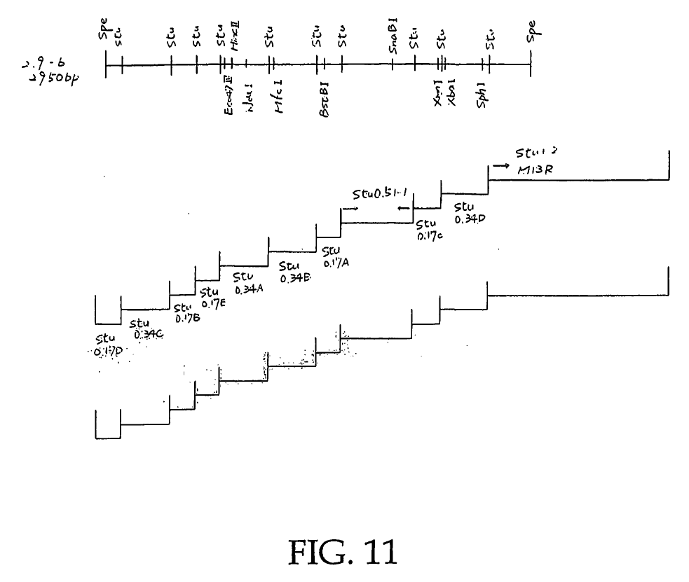

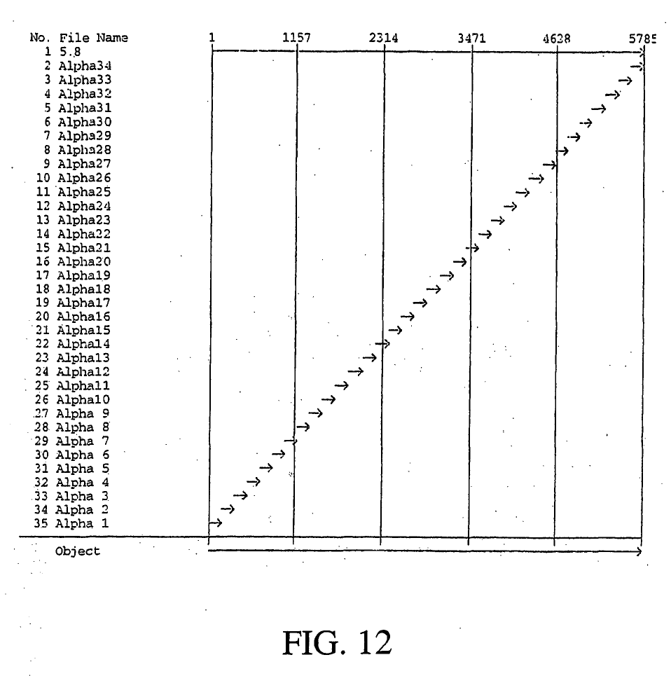

The BioEdit program was used for reconstruction of an entropy plot for monomers from the 5.7 kb alphoid DNA unit; in this plot smaller values of Hx correspond to a lower variability of a position. Interestingly, the CENP-B box (which is located at the very end of the alignment) does not have the lowest Hx: value. The ARS-like element in positions 126-141 also has a number of highly variable positions (FIG. 9?).

e) Formation of a de novo Centromere in Human Cells Using the Present HAC.

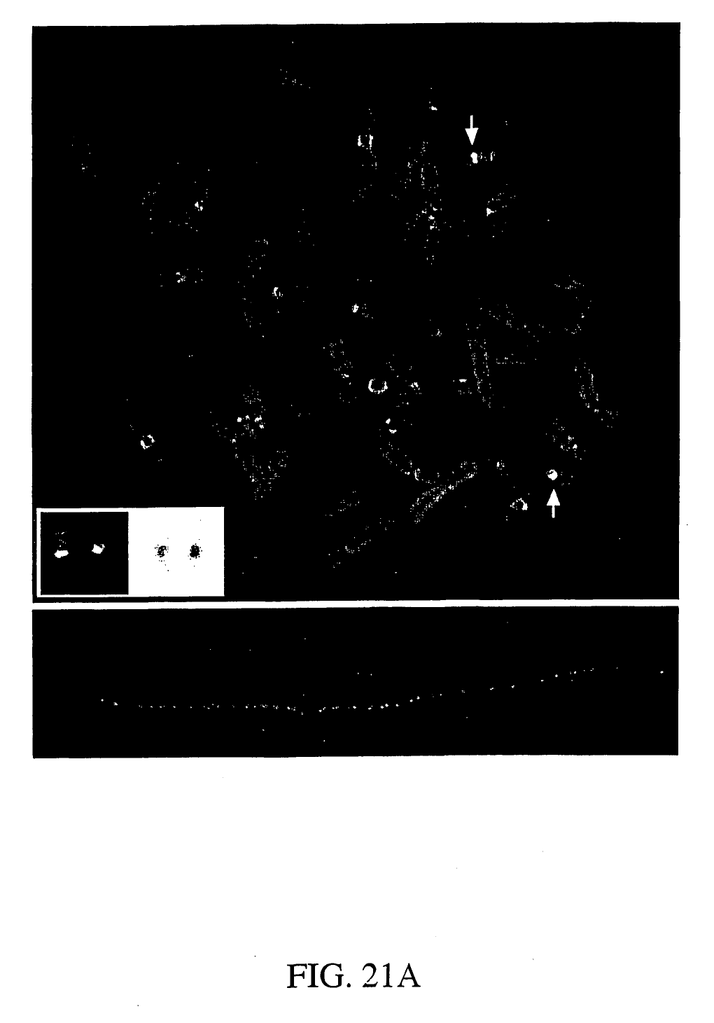

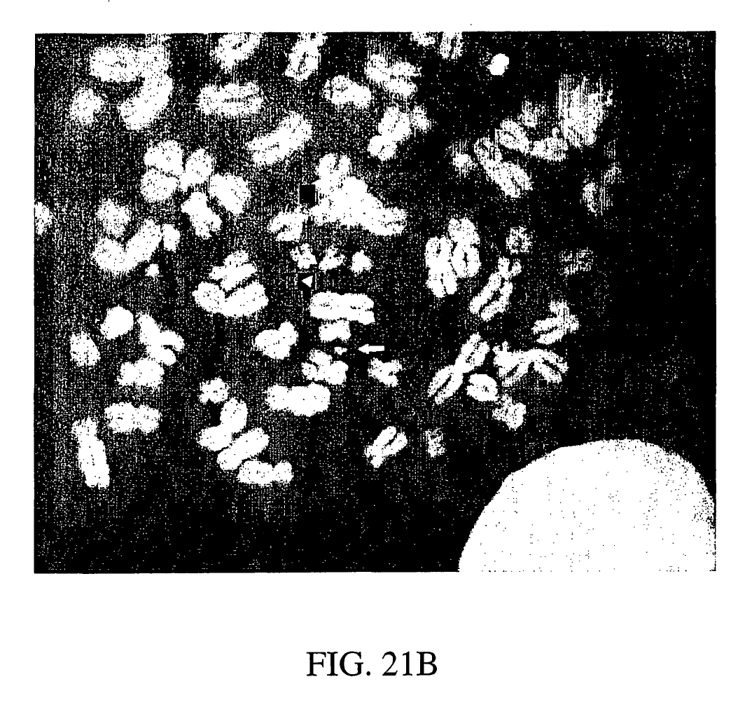

A 140 kb insert from a TAR isolate containing the chromosome 22 alphoid DNA array lacking CENP-B boxes was retrofitted by a mammalian selectable marker (Neo) and was transfected into human HT1080 cells to evaluate formation of human artificial chromosomes. Artificial chromosomes containing the chromosome 22 alphoid DNA array were generated in approximately 30% of clones, similar to that observed for other HAC constructs with alphoid DNA isolated from human chromosome 21 (Ebersole et al., Hum. Mol. Genet., 9:1623-1632, 2000), chromosome 17 (Mejia et al., Genomics 79:297-304, 2002) and chromosome X (Schueler et al., Science 294:109-115, 2001). Analysis of five such artificial chromosomes has shown that the HACs are mitotically stable in the absence of drug selection and each recruited a centromere protein, CENP-E that is associated with active centromere (FIG. 21). Minichromosome frequency in positive cell lines varied between 12 and 85% of metaphase spreads, and copy number was consistently low at one or rarely two minichromosomes per positive spread. We did not observe integration of input DNA into the natural chromosomes. These data indicate that blocks of alphoid DNA from chromosome 22 lacking CENP-B boxes and containing a yeast ARS sequence are highly competent to form a de novo centromere. FISH analyses of the artificial chromosomes did not detect any non-alphoid DNA sequences, suggesting that HAC formation took place without an acquisition of the host DNA.

Throughout this application, various publications are referenced. The disclosures of these publications in their entireties are hereby incorporated by reference into this application in order to more fully describe the state of the art to which this invention pertains, even if the reference is not specifically incorporated

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

### 5. Summary of Sequences

List of sequences SEQ ID NO: 1 is a 1.6 kb fragment of the Y chromosome; SEQ ID NO:2 is a 2.8 kb major Spe I fragment of ΔYq74; SEQ ID NO:3 is a 2.9 kb major Spe I fragment of ΔYq74; SEQ ID NOs:4-37 are approximately 170 base alpha satellites of the Y Chromosome; SEQ ID NOs:38-42 are approximately 170 base alpha satellite repeats of a1.6 fragment of ΔYq74; SEQ ID NOs: 43-46 are inverted repeats from a 1.6 kb fragment of ΔYq74; SEQ ID NOs:47-50 are PCR primers from Example1; SEQ ID NO: 51 is the sequence of TAR cloning vector as shown in FIG. 6; SEQ ID NO:52 is the sequence of the ARS of chromosome 22 as shown in FIG. 23; SEQ ID NO:53 is a 2.1 kb fragment of chromosome 22; and SEQ ID NO: 54 is a 2.8 kb fragment of chromosome 22.

1. A mammalian artificial chromosome comprising the structure Y-X-Z-Y, wherein Z comprises a sequence less than about 250 kb and which is capable of correctly segregating the mammalian artificial chromosome.

2. A mammalian artificial chromosome comprising the structure Y-X-Z-Y, wherein the mammalian artificial chromosome can be shuttled between bacteria, yeast, and mammalian cells without alteration of the mammalian chromosome.

3. A mammalian artificial chromosome comprising the structure Y-X-Z-Y, wherein Z comprises an inverted repeat sequence.

4. The mammalian artificial chromosome of claims claim 1, wherein Z further comprises a sequence less than about 150 kb.

5. The mammalian artificial chromosome of claim 1, wherein Z further comprises a sequence less than about 100 kb.

7. The mammalian artificial chromosome of claim 1, wherein Z further comprises a nucleic acid sequence that lacks a functional CENP-B box sequence.

8. The mammalian artificial chromosome of claim 1, wherein Z further comprises alphoid DNA.

9. The mammalian artificial chromosome of claim 8, wherein the alphoid DNA consists of 34 repeats.

10. The mammalian artificial chromosome of claim 8, wherein the alphoid DNA is derived from the Y-chromosome centromere.

11. The mammalian artificial chromosome of claim 1, wherein Z comprises a repeat structure of about 2.1 kilobases.

12. The mammalian artificial chromosome of claim 1, wherein Z further comprises a repeat structure of about 2.8 kilobases.

13. The mammalian artificial chromosome of claim 1, wherein the Z comprises a sequence having at least 70% homology to SEQ ID NO:53 and a sequence having at least 70% homology to SEQ ID NO:54.

14. The mammalian artificial chromosome of claim 1, wherein the Z comprises a sequence having at least 80% homology to SEQ ID NO:53 and a sequence having at least 80% homology to SEQ ID NO:54.

15. The mammalian artificial chromosome of claim 1, wherein the Z comprises a sequence having at least 90% homology to SEQ ID NO:53 and a sequence having at least 90% homology to SEQ ID NO:54.

16. The mammalian artificial chromosome of claim 1, wherein the Z comprises a sequence having at least 95% homology to SEQ ID NO:53 and a sequence having at least 95% homology to SEQ ID NO:54.

17. The mammalian artificial chromosome of claim 1, wherein the DNA further comprises alphoid DNA derived from the 22-chromosome centromere.

18. The mammalian chromosome of claim 1, wherein the chromosome is less than or equal to 10 MB.

19. The mammalian chromosome of claim 1, wherein the chromosome is less than or equal to 5 MB.

20. The mammalian chromosome of claim 1, wherein the chromosome is less than or equal to 1 MB.

21. The mammalian chromosome of claim 1, wherein the chromosome is less than or equal to 750 kb.

22. The mammalian chromosome of claim 1, wherein the chromosome is less than or equal to 300 kb.

23. The mammalian chromosome of claim 1, wherein the chromosome is less than or equal to 100 kb.

24. The mammalian chromosome of claim 1, further comprising a yeast origin of replication.

25. The mammalian chromosome of claim 1, wherein the chromosome is derived from a human chromosome.

26. A method of using the chromosome of claim 1, comprising transfecting the chromosome into a mammalian cell producing a transfected cell.

27. The method of claim 26, further comprising culturing the transfected cell.

28. The method of claim 27, further comprising isolating the chromosome from the transfected cell.

29. The method of claim 28, further comprising transfecting the cell into a yeast cell.

30. The method of claim 28, further comprising transfecting the cell into a bacterial cell.

31. A method of using the chromosome of claim 1, comprising transfecting the chromosome into a yeast cell producing a transfected cell.

32. The method of claim 31, further comprising culturing the transfected cell.

33. The method of claim 32, further comprising isolating the chromosome from the transfected cell.

34. The method of claim 33, further comprising transfecting the cell into a mammalian cell.

35. The method of claim 33, further comprising transfecting the cell into a bacterial cell.

36. A method of using the chromosome of claim 1, comprising transfecting the chromosome into a bacterial cell producing a transfected cell.

37. The method of claim 36, further comprising culturing the transfected cell.

38. The method of claim 37, further comprising isolating the chromosome from the transfected cell.

39. The method of claim 38, further comprising transfecting the cell into a yeast cell.

40. The method of claim 38, further comprising transfecting the cell into a mammalian cell.

41. A shuttle vector comprising the mammalian artificial chromosome of claim 1.

42. A cloning vector having the sequence set forth in SEQ ID NO:53.

43. A cloning vector having the sequence set forth in SEQ ID NO:54.


SEQUENCE LISTING (54 sequences)

SEQ ID NO: 1 - DNA, 1594 bp, Artificial Sequence
  Description of Artificial Sequence; Note = Synthetic Construct
actagtttctcagaatgtttctgcctggttctcatgcgaagatagttcctttttcaccataggccgcaatgtactccaaatatccacctgcagattctacaaaagtgagtttcaaaactgctctatcaaaagatcagttcgtctctgtgagttgaatgcatacatcaaaaagaagcttctcaaaatgcttctgtgtggtttttcggtgaagatagttctttttctaccataggtctcaaaccactccaaatatccacttgtagattctataaaaaggaatgttcaaaattgctcaataaaaataaagtttcaacaccgtgagatgagtgcacaaatcacaaaggagtttctcaaaatgcttctgggtagtttttctgtgaagatagttccttttctaccatgggccacaaagggctccaaatacccacttgcagattctacaaaaagagagtttcacaactgctctatcaaacaatatgttcaactttgtgggttgaacacaaatatcacaagaattttctcccaatgcttctgtgtagtttttatgtgaagacatttcttttccctccatagtccacaaagtgctccaaatatccacttacatattctagaaaaagattgcttggaaactgcacaatgaaaagaaaggttcaaatatatgagatgaatgcacacatcacaaagaagtttctcagaatctctctgtgtaatttttatgtgaagatatttcctttcccaccttaggtcttaaaacgctccaaatatccacttgcagatactacaagaagattgtttcaaaactgcacaaaaaaagaaatgttcaattctgtttgatgaatgcacacatcacaaagaagtttctcagaatgcttctctgtagtttttatgtgaagatatttccttttccacaataggcctcaaagggctccaaatatccacttccagattctatgaaaagaatatttccaaactgctcaatcataggaaatgttcaactctgtgagatatgtaagtggatatttggagcactttgtggactatggagggaaaagaaatgtcttcacataaaaactacacagaagcattgggagaaaattcttgtgatatttgtgttcaacccacaaagttgaacatattgtttgatagagcagttgtgaaactctctttttgtagaatctgcaagtgggtatttggagccctttgtggcccatggtagaaaaggaactatcttcacagaaaaactacccagaagcattttgagaaactcctttgtgatttgtgcactcatctcacggtgttgaaactttatttttattgagcaattttgaacattcctttttatagaatctacaagtggatatttggagtggtttgagacctatggtagaaaaagaactatcttcaccgaaaaaccacacagaagcattttgagaagcttctttttgatgtatgcattcaactcacagagacgaactgatcttttgatagagcagttttgaaactcacttttgtagaatctgcaggtggatatttggagtacattgcggcctatggtgaaaaaggaactatcttcgcatgagaaccaggcagaaac

SEQ ID NO: 2 - DNA, 2847 bp, Artificial Sequence
  Description of Artificial Sequence; Note = Synthetic Construct
actagtttctcagaatgtttctgcctggttctcatgcgaagatagttcctttttcaccataggccgcaatgtactccaaatatccacctgcagattctacaaaagtgagtttcaaaactgctctatcaaaagatcagttcgtctctgtgagttgaatgcatacatcaaaaagaagcttctcaaaatgcttctgtgtggtttttcggtgaagatagttctttttctaccataggtctcaaaccactccaaatatccacttgtagattctataaaaaggaatgttcaaaattgctcaataaaaataaagtttcaacaccgtgagatgagtgcacaaatcacaaaggagtttctcaaaatgcttctgggtagtttttctgtgaagatagttccttttctaccatgggccacaaagggctccaaatacccacttgcagattctacaaaaagagagtttcacaactgctctatcaaacaatatgttcaactttgtgggttgaacacaaatatcacaagaattttctcccaatgcttctgtgtagtttttatgtgaagacatttcttttccctccatagtccacaaagtgctccaaatatccacttacatattctagaaaaagattgcttggaaactgcacaatgaaaagaaaggttcaaatatatgagatgaatgcacacatcacaaagaagtttctcagaatctctctgtgtaatttttatgtgaagatatttcctttcccaccttaggtcttaaaacgctccaaatatccacttgcagatactacaagaagattgtttcaaaactgcacaaaaaaagaaatgttcaattctgtttgatgaatgcacacatcacaaagaagtttctcagaatgcttctctgtagtttttatgtgaagatatttccttttccacaataggcctcaaagggctccaaatatccacttccagattctatgaaaagaatatttccaaactgctcaatcataggaaatgttcaactctgtgagatgaatgcacacatcacaagaaatttctcagaatccttcagtgtaggttttatgagaagataattccttttccacaatagttctcaaagcactcaaaatatccacttgcagattctacaaaaggagtatttcaaaactgctcaatcaaaagaaaggttcaactctgtgagatgaatggacacatcacaaagaagtttctcagaatgcttctgtgtagtatttttgtgaagatatttcttttccaccatagaccgccaggggacacaaatatccactttcagattctacaacaagagaggttcaaaactactcgatcaagagatggtttcaactatgtgagttgaatgcacacatcacaaagaactatgtcggaattcttctgtgtagtttttatgtgaagatatttccttttccacaatagacgtcaaagtgatccagatatccacttgcagattccacaaaaagagtgtttcaaaagtgcacaaccaaaagaaaggttcaactaggtgagatgaatgcacacatcagaaggaagtttctcagaatgcttctgcatagcttttaagggaagatacttccttttccaacataggcctcaaagcactccaaatatcctcctggagataccacaaaaagagtgtttgcaaactgctcaatcaaaagaaagatttaactctgtgagatgaatccacacatgacaaagaagtttctcagaatgcttctgtgtagtttttatgtgaagatatttccttttccacaataagacccaaaaggctccaaatattcacttgcagattctaaaaaaaacagtgtttcaaaactgctcaatcaaaagatagttcaactctgtgagaagaatgctcacatcactgagaagtttctcagaatgcttctgtgtagtttttatatgaagatatttcctttcccaccgtaggccacaaaaggctccaaatatccacttgcagatactatgaaaagagagtttcaaaactgctcattcaaaagataggttcaactctgtggtttgaatgcacacagcacaaagaagtttcacagaatgtgtctgtgtagtttttatgtgcggatgtttccttttccaccatatgcctaaatatttcccaatttccacttgcagattctacaagaagagtgtttcaaaactgctgtatcaaataaagttgaactctgtgaggtgaatgcacacagcacaaaatggtttctcagaatgcttccttgttgtttttatatgaagatgtttccttttcaacaataggcctcaaagtgcttcaaatgtccacttgcagattctacaaaaagagtgtttcaaaactgctcaatcaaaagaaaggttcgactctgggaaattaatgcacacatcacaaagaagtttctcagcttctgtgtagttttcatgtgaagttatttccttttccacaataggccgcaaagggctccaaatatcaacttacagattctaggaaaagagagtttcaaaactgctctacgaaaagataggttgaactctgtgagatgaatgcacacatcacaaagaagtttctcagaatgcatctgtgtagtttttacgggaagacatttccttttccaccatcttccacaaaggtctccaagtaaccacttgcagattctacagaaagacactttaaaaactgctctatcaaaagatcagttcaagtctgtggtttgaatgcacacatcacaaagaattttctcagaatgcttctgtgtagttttcatatgaagatatttccttttccaccataggcctcaaagcactccaaatatccacttgcagattctacaaaaagagattttcaaaactagt

SEQ ID NO: 3 - DNA, 2950 bp, Artificial Sequence
  Description of Artificial Sequence; Note = Synthetic Construct
actagtcaatcaaaagaaaggttcaactctgtcagttgaatgcacatatcacaaacaagtttctcggaatgcgtctgtgtagtttttatgtgaagatatttccttctccacaacaggcctcaaagtgctccgaatatccacttgcagattttactaaagagtgtttccaaactgctcaatcaagaggaagtttcaagtctgtgagctgaacgcacacatcacaaagtagtttctgagaatgcttctgtgtagtttttatgtgaagatgttttcttttccaccataggctgcaaagggctccaaatatccacttgcagattctacaaaaagagagtttcaaaagtgctctatcaaaagataggttcaactatgtgatatgaatgcacacatcacaaagtagtttctcagaatgcttctgtgtagtttttatgtaaagatatttccttttccaccataggcctcaaagcactccaaatatccacttgcagattctacaaaaagagattttcaaaactatttaatcaaaagaaaggttcaaatctgtcagttgaaggtacatatcacaaacaagtttattggaatgcttctgtgtagtttttatgtgaagatatttccttttccacaacaggcctcaaggtgctccaaatatccacttgcagatttcactaaaagtgtgtttccaagctgctcaatcaagaggaagtttcaagtctgtgaggtgaatgcacacattacaaagaagttactgagaatgcttctgtgtagtttttatgtgaagatatttccttttccaccgcaggcctcaaagcgctgcaaatatccacttgcagattctacaaaaagagagtttcaaaactgctgtatcaaaagatagggtcaactctgcgagttgaataagcacatcacaaataagtttctgggaacgcttctgtatagttttatgtgaatatatttccttttccaccatatgcctcaaagcactccaaatatccacttgcacattatagaaacatagtctttcaaaacttgtcaatcaaagaaaggttcaactccgtgagatgagtgcacacatcacagagaagtttctcggaatgtttctgtgtagtttttatgtgaagatattgccttttccacaataggcctcaaagcgttccaaatatccaattgcagattccacaaaaaaagttttttaaaactgctcaatcaaatgatagattaaactctgtgagattagtgcacacatgtcaaaaaagtttctcagaatgcttctgtgtactttttaggggaagatatttccttttccaccatcggccacaaaggactccaaataaccacatgcagattctagtaacacagagtttcaaaactgctctatcaaaagataagttcaactctgagagtttagtgcaaccatcgtgaagaagtttctcagaatgcttctgagtagtgtttatgtgaagatatttccttttccaccataggcctgaaagccctccaaatatccacttgcagatcctacaaaaagaaagtttcgaaatgctctctcaaacgatagtttcgactctgtggtatgaatacacacatcacaaagaagtttctcagaatgcttctgtgtagtttttaaatgaagatatttctttttccaccataggcctcaaagcactccaaatatgcacttccagattctacaaaaagagtgtttcagaactgctcaatcaaaaggaaggttccagtctgagacaaatacacacatcaaaaggtagtttctcagaatgcttctgtgtagtttttatgtgaagatattttcctttccaccataggccacaaatggctctaaatacccacttacattttccacaaaaagagagtttcaaaactgctctaccaaaggtaagtttaacgctgtgagttaagaacatcacaaagaagtttctcagaatgcttctgtgtagttcttacgtaaagatatttccttttacacaataggcagaaaagtgctccaaatatccacttgaagattctacagaaaccgtgtttcaaaactgccgaatcaaaagaaaggttcaactctgtgagatgaatgcacacataacaaaggagtttctcagaatgcttctgtgtagcttttatatgaagacatttagttttccacaacaggcctcaaagctctctccatatccacttgcagattctaccgaaagagtgcttccaaactgctcaatcaaaagagacattcaaatctgtgaggtgaatgcagacatcgtaaagaagtttctcagaatgcttctgtgtattttttgtgtgaagttattcgtttttgcaccataggcctccaagcgttctaaatatccacttctagattctacaaaaagagagtttcaaaactactcaaacaaaaggttcaattctgtgagttgaaagcaaacatcacaaagaagtttctcagaatgcgtctgtgtagttttgatgtgaagatatttccttttcacagtagaatgcaaagggctccaaatatccacttggagattctacaaaaagagtttcaaaaccgctctgtcaaatgataggttgaactcccggaggtgaatacacacatcacaaagaggtttctcagcatgcttctgtgtagtttttatgtaaacatatttccgtttctatcataggcctcaaagtgctccaaatattcacttgtacattctaccaaacgagtatttcaaaactgctcaatcaaatggaaggttcaaaaccgtgacatgaatgcccacatcacaaagtagtttctcagaatgcttctgtgtagtttttatgtgaagatatttccttttccacaacagcgtgcaaaacgcttcaaatatgcccttagagattccacaaaaagagtgtttccaaactactcaaatcaaaaaatgatttcaactctgtgagatgaatgcacacatcacaaactagt

SEQ ID NO: 4 - DNA, 171 bp, Artificial Sequence
  Description of Artificial Sequence; Note = Synthetic Construct
aggcctcaaagtgctccaaatattcacttgtacattctaccaaacgagtatttcaaaactgctcaatcaaatggaaggttcaaaaccgtgacatgaatgcccacatcacaaagtagtttctcagaatgcttctgtgtagtttttatgtgaagatatttccttttccacaac

SEQ ID NO: 5 - DNA, 172 bp, Artificial Sequence
  Description of Artificial Sequence; Note = Synthetic Construct
agcgtgcaaaacgcttcaaatatgcccttagagattccacaaaaagagtgtttccaaactactcaaatcaaaaaatgatttcaactctgtgagatgaatgcacacatcacaaactagtttctcagaatgtttctgcctggttctcatgcgaagatagttcctttttcaccat

SEQ ID NO: 6 - DNA, 170 bp, Artificial Sequence
  Description of Artificial Sequence; Note = Synthetic Construct
aggccgcaatgtactccaaatatccacctgcagattctacaaaagtgagtttcaaaactgctctatcaaaagatcagttcgtctctgtgagttgaatgcatacatcaaaaagaagcttctcaaaatgcttctgtgtggtttttcggtgaagatagttctttttctaccat

SEQ ID NO: 7 - DNA, 171 bp, Artificial Sequence
  Description of Artificial Sequence; Note = Synthetic Construct
aggtctcaaaccactccaaatatccacttgtagattctataaaaaggaatgttcaaaattgctcaataaaaataaagtttcaacaccgtgagatgagtgcacaaatcacaaaggagtttctcaaaatgcttctgggtagtttttctgtgaagatagttccttttctaccat

SEQ ID NO: 8 - DNA, 170 bp, Artificial Sequence
  Description of Artificial Sequence; Note = Synthetic Construct
gggccacaaagggctccaaatacccacttgcagattctacaaaaagagagtttcacaactgctctatcaaacaatatgttcaactttgtgggttgaacacaaatatcacaagaattttctcccaatgcttctgtgtagtttttatgtgaagacatttcttttccctccat

SEQ ID NO: 9 - DNA, 171 bp, Artificial Sequence
  Description of Artificial Sequence; Note = Synthetic Construct
agtccacaaagtgctccaaatatccacttacatattctagaaaaagattgcttggaaactgcacaatgaaaagaaaggttcaaatatatgagatgaatgcacagatcacaaagaagtttctcagaatctctctgtgtaatttttatgtgaagatatttcctttcccacctt

SEQ ID NO: 10 - DNA, 170 bp, Artificial Sequence
  Description of Artificial Sequence; Note = Synthetic Construct
aggtcttaaaacgctccaaatatccacttgcagatactacaagaagattgtttcaaaactgcacaaaaaaagaaatgttcaattctgtttgatgaatgcacacatcacaaagaagtttctcagaatgcttctctgtagtttttatgtgaagatatttccttttccacaat

SEQ ID NO: 11 - DNA, 170 bp, Artificial Sequence
  Description of Artificial Sequence; Note = Synthetic Construct
aggcctcaaagggctccaaatatccacttccagattctatgaaaagaatatttccaaactgctcaatcataggaaatgttcaactctgtgagatgaatgcacacatcacaagaaatttctcagaatccttcagtgtaggttttatgagaagataattccttttccacaat

SEQ ID NO: 12 - DNA, 170 bp, Artificial Sequence
  Description of Artificial Sequence; Note = Synthetic Construct
agttctcaaagcactcaaaatatccacttgcagattctacaaaaggagtatttcaaaactgctcaatcaaaagaaaggttcaactctgtgagatgaatggacacatcacaaagaagtttctcagaatgcttctgtgtagtatttttgtgaagatatttcttttccaccat

SEQ ID NO: 13 - DNA, 171 bp, Artificial Sequence
  Description of Artificial Sequence; Note = Synthetic Construct
agaccgccaggggacacaaatatccactttcagattctacaacaagagaggttcaaaactactcgatcaagagatggtttcaactatgtgagttgaatgcacacatcacaaagaactatgtcggaattcttctgtgtagtttttatgtgaagatatttccttttccacaat

SEQ ID NO: 14 - DNA, 171 bp, Artificial Sequence
  Description of Artificial Sequence; Note = Synthetic Construct
agacgtcaaagtgatccagatatccacttgcagattccacaaaaagagtgtttcaaaagtgcacaaccaaaagaaaggttcaactaggtgagatgaatgcacacatcagaaggaagtttctcagaatgcttctgcatagcttttaagggaagatacttccttttccaacat

SEQ ID NO: 15 - DNA, 171 bp, Artificial Sequence
  Description of Artificial Sequence; Note = Synthetic Construct
aggcctcaaaccactccaaatatcctcctggagataccacaaaaagagtgtttgcaaactgctcaatcaaaagaaagatttaactctgtgagatgaatccacacatgacaaagaagtttctcagaatgcttctgtgtagtttttatgtgaagatatttccttttccacaat

SEQ ID NO: 16 - DNA, 171 bp, Artificial Sequence
  Description of Artificial Sequence; Note = Synthetic Construct
aagacccaaaaggctccaaatattcacttgcagattctaaaaaaaacagtgtttcaaaactgctcaatcaaaagatagttcaactctgtgagaagaatgctcacatcactgagaagtttctcagaatgcttctgtgtagtttttatatgaagatatttcctttcccaccgt

SEQ ID NO: 17 - DNA, 171 bp, Artificial Sequence
  Description of Artificial Sequence; Note = Synthetic Construct
aggccacaaaaggctccaaatatccacttgcagatactatgaaaagagagtttcaaaactgctcattcaaaagatacgttcaactctgtggtttgaatgcacacagcacaaagaagtttcacagaatgtgtctgtgtagtttttatctgcggatgtttccttttccaccat

SEQ ID NO: 18 - DNA, 168 bp, Artificial Sequence
  Description of Artificial Sequence; Note = Synthetic Construct
atgcctaaatatttcccaatttccacttgcagattctacaagaagagtgtttcaaaactgctgtatcaaataaagttgaactctgtgaggtgaatgcacacagcacaaaatggtttctcagaatgcttccttgttgtttttatatcaagatgtttccttttcaacaat

SEQ ID NO: 19 - DNA, 167 bp, Artificial Sequence
  Description of Artificial Sequence; Note = Synthetic Construct
aggcctcaaagtgcttcaaatgtccacttgcagattctacaaaaagagtgtttcaaaactgctcaatcaaaagaaaggttcgactctgggaaattaatgcacacatcacaaagaagtttctcagcttctgtgtagttttcatgtgaagttatttccttttccacaat

SEQ ID NO: 20 - DNA, 171 bp, Artificial Sequence
  Description of Artificial Sequence; Note = Synthetic Construct
aggccgcaaagggctccaaatatcaacttacagattctaggaaaagagagtttcaaaactgctctacgaaaagataggttgaactctgtgagatgaatgcacacatcacaaagaagtttctcagaatgcatctgtgtagtttttacgggaagacatttccttttccaccat

SEQ ID NO: 21 - DNA, 171 bp, Artificial Sequence
  Description of Artificial Sequence; Note = Synthetic Construct
cttccacaaaggtctccaagtaaccacttgcagattctacagaaagacactttaaaaactgctctatcaaaagatcagttcaagtctgtggtttgaatgcacacatcacaaagaattttctcagaatgcttctgtgtagttttcatatgaagatatttccttttccaccat

SEQ ID NO: 22 - DNA, 171 bp, Artificial Sequence
  Description of Artificial Sequence; Note = Synthetic Construct
aggcctcaaagcactccaaatatccacttgcagattctacaaaaagagattttcaaaactagtcaatcaaaagaaaggttcaactctgtcagttgaatgcacatatcacaaacaagtttctcggaatgcgtctgtgtagtttttatgtgaagatatttccttctccacaac

SEQ ID NO: 23 - DNA, 170 bp, Artificial Sequence
  Description of Artificial Sequence; Note = Synthetic Construct
aggcctcaaagtgctccgaatatccacttgcagattttactaaagagtgtttccaaactgctcaatcaagaggaagtttcaagtctgtgagctgaacgcacacatcacaaagtagtttctgagaatgcttctgtgtagtttttatgtgaagatgtttycttttccaccat

SEQ ID NO: 24 - DNA, 171 bp, Artificial Sequence
  Description of Artificial Sequence; Note = Synthetic Construct
aggctgcaaagggctccaaatatccacttgcagattctacaaaaagagagtttcaaaagtgctctatcaaaagataccttcaactatgtgatatgaatgcacacatcacaaagtagtttctcacaatgcttctgtgtagtttttatgtaaagatatttccttttccaccat

SEQ ID NO: 25 - DNA, 171 bp, Artificial Sequence
  Description of Artificial Sequence; Note = Synthetic Construct
aggcctcaaagcactccaaatatccacttgcagattctacaaaaagagattttcaaaactatttaatcaaaagaaaggttcaaatctgtcagttgaaggtacatatcacaaacaagtttattggaatgcttctgtgtagtttttatgtgaagatatttccttttccacaac

SEQ ID NO: 26 - DNA, 171 bp, Artificial Sequence
  Description of Artificial Sequence; Note = Synthetic Construct
aggcctcaaggtgctccaaatatccacttgcagatttcactaaaagtgtgtttccaagctgctcaatcaagaggaagtttcaagtctgtgaggtgaatgcacacattacaaagaagttactgagaatgcttctgtgtagtttttatgtgaagatatttccttttccaccgc

SEQ ID NO: 27 - DNA, 170 bp, Artificial Sequence
  Description of Artificial Sequence; Note = Synthetic Construct
aggcctcaaagcgctgcaaatatccacttgcagattctacaaaaagagagtttcaaaactgctgtatcaaaagatagggtcaactctgcgagttgaataagcacatcacaaataagtttctgggaacgcttctgtatagttttatgtgaatatatttccttttccaccat

SEQ ID NO: 28 - DNA, 170 bp, Artificial Sequence
  Description of Artificial Sequence; Note = Synthetic Construct
atgcctcaaagcactccaaatatccacttgcacattatagaaacatagtctttcaaaacttgtcaatcaaagaaaggttcaactccgtgagatgagtgcacacatcacagagaagtttctcggaatgtttctgtgtagtttttatgtgaagatattgccttttccacaat

SEQ ID NO: 29 - DNA, 170 bp, Artificial Sequence
  Description of Artificial Sequence; Note = Synthetic Construct
aggcctcaaagcgttccaaatatccaattgcagattccacaaaaaaagttttttaaaactgctcaatcaaatgatagattaaactctgtgagattagtgcacacatgtcaaaaagtttctcagaatgcttctgtgtactttttaggggaagatatttccttttccaccat

SEQ ID NO: 30 - DNA, 171 bp, Artificial Sequence
  Description of Artificial Sequence; Note = Synthetic Construct
cggccacaaaggactccaaataaccacatgcagattctagtaacacagagtttcaaaactgctgtatcaaaagataagttcaactctgagagtttagtgcaaccatcgtgaagaagtttctcagaatgcttctgagtagtgtttatgtgaacatatttccttttccaccat

SEQ ID NO: 31 - DNA, 170 bp, Artificial Sequence
  Description of Artificial Sequence; Note = Synthetic Construct
aggcctgaaagccctccaaatatccacttgcagatcctacaaaaagaaagtttcgaaatgctctctcaaacgatagtttcgactctgtggtatgaatacacacatcacaaagaagtttctcagaatgcttctgtgtagtttttaaatgaagatatttctttttccaccat

SEQ ID NO: 32 - DNA, 169 bp, Artificial Sequence
  Description of Artificial Sequence; Note = Synthetic Construct
aggcctcaaagcactccaaatatgcacttccagattctacaaaaagagtgtttcagaactgctcaatcaaaaggaaggttccagtctgagacaaatacacacatcaaaaggtagtttctcagaatgcttctgtgtagtttttatgtgaagatattttcctttccaccat

SEQ ID NO: 33 - DNA, 166 bp, Artificial Sequence
  Description of Artificial Sequence; Note = Synthetic Construct
aggccacaaatggctctaaatacccacttacattttccacaaaaagagagtttcaaaactgctctaccaaaggtaagtttaacgctgtgagttaagaacatcacaaagaagtttctcagaatgcttctgtctagttcttacgtaaagatatttccttttacacaat

SEQ ID NO: 34 - DNA, 171 bp, Artificial Sequence
  Description of Artificial Sequence; Note = Synthetic Construct
aggcagaaaagtgctccaaatatccacttgaagattctacagaaaccgtgtttcaaaactgccgaatcaaaagaaaggttcaactctgtgagatgaatgcacacataacaaaggagtttctcagaatgcttctgtgtagcttttatatgaagacatttagttttccacaac

SEQ ID NO: 35 - DNA, 171 bp, Artificial Sequence
  Description of Artificial Sequence; Note = Synthetic Construct
aggcctcaaagctctctccatatccacttgcagattctaccgaaagagtgcttccaaactgctcaatcaaaagagacattcaaatctgtgaggtgaatgcagacatcgtaaagaagtttctcagaatgcttctgtgtattttttgtgtgaagttattcgtttttgcaccat

SEQ ID NO: 36 - DNA, 166 bp, Artificial Sequence
  Description of Artificial Sequence; Note = Synthetic Construct
aggcctccaagcgttctaaatatccacttctagattctacaaaaagagagtttcaaaactactcaaacaaaaggttcaattctgtgagttgaaagcaaacatcacaaagaagtttctcagaatgcgtctgtgtagttttgatgtgaagatatttccttttcacagt

SEQ ID NO: 37 - DNA, 169 bp, Artificial Sequence
  Description of Artificial Sequence; Note = Synthetic Construct
agaatgcaaagggctccaaatatccacttggagattctacaaaaagagtttcaaaaccgctctgtcaaatgataggttgaactcccggaggtgaatacacacatcacaaagaggtttctcagcatgcttctgtgtagtttttatgtaaacatatttccgtttctatcat

SEQ ID NO: 38 - DNA, 170 bp, Artificial Sequence
  Description of Artificial Sequence; Note = Synthetic Construct
cctgaaagccctccaaatatccacttgcagatcctacaaaaagaaagtttcgaaatgctctctcaaacgatagtttcgactctgtggtatgaatacacacatcacaaagaagtttctcagaatgcttctgtgtagtttttaaatgaagatatttctttttccaccatagg

SEQ ID NO: 39 - DNA, 171 bp, Artificial Sequence
  Description of Artificial Sequence; Note = Synthetic Construct
cctcaaagcactccaaatatccacttgcagattctacaaaaagagattttcaaaactatttaatcaaaagaaaggttcaaatctgtcagttgaaggtacatatcacaaacaagtttattggaatgcttctgtgtagtttttatgtgaagatatttccttttccacaacagg

SEQ ID NO: 40 - DNA, 171 bp, Artificial Sequence
  Description of Artificial Sequence; Note = Synthetic Construct
cctcaaagctctctccatatccacttgcagattctaccgaaagagtgcttccaaactgctcaatcaaaagagacattcaaatctgtgaggtgaatgcagacatcgtaaagaagtttctcagaatgcttctgtgtattttttgtgtgaagttattcgtttttgcaccatagg

SEQ ID NO: 41 - DNA, 171 bp, Artificial Sequence
  Description of Artificial Sequence; Note = Synthetic Construct
cctcaaagcactccaaatatccacttgcagattctacaaaaagagattttcaaaactagtcaatcaaaagaaaggttcaactctgtcagttgaatgcacatatcacaaacaagtttctcggaatgcgtctgtgtagtttttatgtgaagatatttccttctccacaacagg

SEQ ID NO: 42 - DNA, 171 bp, Artificial Sequence
  Description of Artificial Sequence; Note = Synthetic Construct
cctcaaggtgctccaaatatccacttgcagatttcactaaaagtgtgtttccaagctgctcaatcaagaggaagtttcaagtctgtgaggtgaatgcacacattacaaagaagttactgagaatgcttctgtgtagtttttatgtgaagatatttccttttccaccgcagg

SEQ ID NO: 43 - DNA, 340 bp, Artificial Sequence
  Description of Artificial Sequence; Note = Synthetic Construct
cctcaaagcgctgcaaatatccacttgcagattctacaaaaagagagtttcaaaactgctgtatcaaaagatagggtcaactctgcgagttgaataagcacatcacaaataagtttctgggaacgcttctgtatagttttatgtgaatatatttccttttccaccatatgcctcaaagcactccaaatatccacttgcacattatagaaacatagtctttcaaaacttgtcaatcaaagaaaggttcaactccgtgagatgagtgcacacatcacagagaagtttctcggaatgtttctgtgtagtttttatgtgaagatattgccttttccacaatagg

SEQ ID NO: 44 - DNA, 342 bp, Artificial Sequence
  Description of Artificial Sequence; Note = Synthetic Construct
cctcaaagcgttccaaatatccaattgcagattccacaaaaaaagttttttaaaactgctcaatcaaatgatagattaaactctgtgagattagtgcacacatgtcaaaaaagtttctcagaatgcttctgtgtactttttaggggaagatatttccttttccaccatcggccacaaaggactccaaataaccacatgcagattctagtaacacagagtttcaaaactgctctatcaaaagataagttcaactctgagagtttagtgcaaccatcgtgaagaagtttctcagaatgcttctgagtagtgtttatgtgaagatatttccttttccaccatagg

SEQ ID NO: 45 - DNA, 341 bp, Artificial Sequence
  Description of Artificial Sequence; Note = Synthetic Construct
cctcaaagtgctccgaatatccacttgcagattttactaaagagtgtttccaaactgctcaatcaagaggaagtttcaagtctgtgagctgaacgcacacatcacaaagtagtttctgagaatgcttctgtgtagtttttatgtgaagatgttttcttttccaccataggctgcaaagggctccaaatatccacttgcagattctacaaaaagagagtttcaaaagtgctctatcaaaagataggttcaactatgtgatatgaatgcacacatcacaaagtagtttctcagaatgcttctgtgtagtttttatgtaaagatatttccttttccaccatagg

SEQ ID NO: 46 - DNA, 335 bp, Artificial Sequence
  Description of Artificial Sequence; Note = Synthetic Construct
cctccaagcgttctaaatatccacttctagattctacaaaaagagagtttcaaaactactcaaacaaaaggttcaattctgtgagttgaaagcaaacatcacaaagaagtttctcagaatgcgtctgtgtagttttgatgtgaagatatttccttttcacagtagaatgcaaagggctccaaatatccacttggagattctacaaaaagagtttcaaaaccgctctgtcaaatgataggttgaactcccggaggtgaatacacacatcacaaagaggtttctcagcatgcttctgtgtagtttttatgtaaacatatttccgtttctatcatagg

SEQ ID NO: 47 - DNA, 22 bp, Artificial Sequence
  Description of Artificial Sequence; Note = Synthetic Construct
accgtcgactcacagagttgaa

SEQ ID NO: 48 - DNA, 20 bp, Artificial Sequence
  Description of Artificial Sequence; Note = Synthetic Construct
attcccgtttccaacgaagg

SEQ ID NO: 49 - DNA, 24 bp, Artificial Sequence
  Description of Artificial Sequence; Note = Synthetic Construct
gcggatgaatggcagaaattcgat

SEQ ID NO: 50 - DNA, 33 bp, Artificial Sequence
  Description of Artificial Sequence; Note = Synthetic Construct
ccggctcgagctgtggaatgtgtgtcagttagg

SEQ ID NO: 51 - DNA, 5250 bp, Artificial Sequence
  Description of Artificial Sequence; Note = Synthetic Construct
cctgagagcaggaagagcaagataaaaggtagtatttgttggcgatccccctagagtcttttacatcttcggaaaacaaaaactattttttctttaatttctttttttactttctatttttaatttatatatttatattaaaaaatttaaattataattatttttatagcacgtgatgaaaaggaccctaagaaaccattattatcatgacattaacctataaaaataggcgtatcacgaggccctttcgtctcgcgcgtttcggtgatgacggtgaaaacctctgacacatgcagctcccggagacggtcacagcttgtctgtaagcggatgccgggagcagacaagcccgtcagggcgcgtcagcgggtgttggcgggtgtcggggctggcttaactatgcggcatcagagcagattgtactgagagtgcaccataattccgttttaagagcttggtgagcgctaggagtcactgccaggtatcgtttgaacacggcattagtcagggaagtcataacacagtcctttcccgcaattttctttttctattactcttggcctcctctagtacactctatatttttttatgcctcggtaatgattttcatttttttttttccacctagcggatgactctttttttttcttagcgattggcattatcacataatgaattatacattatataaagtaatgtgatttcttcgaagaatatactaaaaaatgagcaggcaagataaacgaaggcaaagatgacagagcagaaagccctagtaaagcgtattacaaatgaaaccaagattcagattgcgatctctttaaagggtggtcccctagcgatagagcactcgatcttcccagaaaaagaggcagaagcagtagcagaacaggccacacaatcgcaagtgattaacgtccacacaggtatagggtttctggaccatatgatacatgctctggccaagcattccggctggtcgctaatcgttgagtgcattggtgacttacacatagacgaccatcacaccactgaagactgcgggattgctctcggtcaagcttttaaagaggccctactggcgcgtggagtaaaaaggtttggatcaggatttgcgcctttggatgaggcactttccagagcggtggtagatctttcgaacaggccgtacgcagttgtcgaacttggtttgcaaagggagaaagtaggagatctctcttgcgagatgatcccgcattttcttgaaagctttgcagaggctagcagaattaccctccacgttgattgtctgcgaggcaagaatgatcatcaccgtagtgagagtgcgttcaaggctcttgcggttgccataagagaagccacctcgcccaatggtaccaacgatgttccctccaccaaaggtgttcttatgtagtgacaccgattatttaaagctgcagcatacgatatatatacatgtgtatatatgtatacctatgaatgtcagtaagtatgtatacgaacagtatgatactgaagatgacaaggtaatgcatggatcgccaacaaatactaccttttatcttgctcttcctgctctcaggtattaatgccgaattgtttcatcttgtctgtgtagaagaccacacacgaaaatcctgtgattttacattttacttatcgttaatcgaatgtatatctatttaatctgcttttcttgtctaataaatatatatgtaaagtacgctttttgttgaaattttttaaacctttgtttatttttttttcttcattccgtaactcttctaccttctttatttactttctaaaatccaaatacaaaacataaaaataaataaacacagagtaaattcccaaattattccatcattaaaagatacgaggcgcgtgtaagttacaggcaagcgatgcatcattctatacgtgtcattctgaacgaggcgcgctttccttttttctttttgctttttctttttttttctcttgaactcgacggatcatatgcggtgtgaaataccgcacagatgcgtaaggagaaaataccgcatcaggaaattgtaaacgttaatattttgttaaaattcgcgttaaatttttgttaaatcagctcattttttaaccaataggccgaaatcggcaaaatcccttataaatcaaaagaatagaccgagatagggttgagtgttgttccagtttggaacaagagtccactattaaagaacgtggactccaacgtcaaagggcgaaaaaccgtctatcagggcgatggcccactacgtgaaccatcaccctaatcaagttttttggggtcgaggtgccgtaaagcactaaatcggaaccctaaagggagcccccgatttagagcttgacggggaaagccggcgaacgtggcgagaaaggaagggaagaaagcgaaaggagcgggcgctagggcgctggcaagtgtagcggtcacgctgcgcgtaaccaccacacccgccgcgcttaatgcgccgctacagggcgcgtcgcgccattcgccattcaggctgcgcaactgttgggaagggcgatcggtgcgggcctcttcgctattacgccagctggcgaaggggggatgtgctgcaaggcgattaagttgggtaacgccagggttttcccagtcacgacgttgtaaaacgacggccagtgaattgtaatacgactcactatagggcgaattggagctccaccgcggcattctcagaaacttctttgtgatgtgtgcattcaactcacagagttgaaccttccttttggatccatatttaaatattgaaagctgcaagatttaaaaaaatctcccgggggcgagtcgaacgcccgatctcaagatttcgtagtggtaaattacagtcttgcgccttaaaccaacttggctaccgagagtcgtttttgttgtaaaacacggatcgataaaaggaaggttcaactctgtgagttgaatgcacacatcacaaagaagtttctgagaatggggcccggtacccagcttttgttccctttagtgagggttaattccgagcttggcgtaatcatggtcatagctgtttcctgtgtgaaattgttatccgctcacaattccacacaacataggagccggaagcataaagtgtaaagcctggggtgcctaatgagtgaggtaactcacattaattgcgttgcgctcactgcccgctttccagtcgggaaacctgtcgtgccagctgcattaatgaatcggccaacgcgcggggagaggcggtttgcgtattgggcgctcttccgcttcctcgctcactgactcgctgcgctcggtcgttcggctgcggcgagcggtatcagctcactcaaaggcggtaatacggttatccacagaatcaggggataacgcaggaaagaacatgtgagcaaaaggccagcaaaaggccaggaaccgtaaaaaggccgcgttgctggcgtttttccataggctcggcccccctgacgagcatcacaaaaatcgacgctcaagtcagaggtggcgaaacccgacaggactataaagataccaggcgttcccccctggaagctccctcgtgcgctctcctgttccgaccctgccgcttaccggatacctgtccgcctttctcccttcgggaagcgtggcgctttctcaatgctcacgctgtaggtatctcagttcggtgtaggtcgttcgctccaagctgggctgtgtgcacgaaccccccgttcagcccgaccgctgcgccttatccggtaactatcgtcttgagtccaacccggtaagacacgacttatcgccactggcagcagccactggtaacaggattagcagagcgaggtatgtaggcggtgctacagagttcttgaagtggtggcctaactacggctacactagaaggacagtatttggtatctgcgctctgctgaagccagttaccttcggaaaaagagttggtagctcttgatccggcaaacaaaccaccgctggtagcggtggtttttttgtttgcaagcagcagattacgcgcagaaaaaaaggatctcaagaagatcctttgatcttttctacggggtctgacgctcagtggaacgaaaactcacgttaagggattttggtcatgagattatcaaaaaggatcttcacctagatccttttaaattaaaaatgaagttttaaatcaatctaaagtatatatgagtaaacttggtctgacagttaccaatgcttaatcagtgaggcacctatctcagcgatctgtctatttcgttcatccatagttgcctgactgcccgtcgtgtagataactacgatacgggagggcttaccatctggccccagtgctgcaatgataccgcgagacccacgctcaccggctccagatttatcagcaataaaccagccagccggaagggccgagcgcagaagtggtcctgcaactttatccgcctccatccagtctattaattgttgccgggaagctagagtaagtagttcgccagttaatagtttgcgcaacgttgttgccattgctacaggcatcgtggtgtcacgctcgtcgtttggtatggcttcattcagctccggttcccaacgatcaaggcgagttacatgatcccccatgttgtgaaaaaaagcggttagctccttcggtcctccgatcgttgtcagaagtaagttggccgcagtgttatcactcatggttatggcagcactgcataattctcttactgtcatgccatccgtaagatgcttttctgtgactggtgagtactcaaccaagtcattctgagaatagtgtatgcggcgaccgagttgctcttgcccggcgtcaatacgggataataccgcgccacatagcagaactttaaaagtgctcatcattggaaaacgttcttcggggcgaaaactctcaaggatcttaccgctgttgagatccagttcgatgtaacccactcgtgcacccaactgatcttcagcatcttttactttcaccagcgtttctgggtgagcaaaaacaggaaggcaaaatgccgcaaaaaagggaataagggcgacacggaaatgttgaatactcatactcttcctttttcaatattattgaagcatttatcagggttattgtctcatgagcggatacatatttgaatgtatttagaaaaataaacaaataggggttccgcgcacatttccccgaaaagtgccacctggacggatcgcttgcctgtaacttacacgcgcctcgtagg

SEQ ID NO: 52 - DNA, 483 bp, Artificial Sequence
  Description of Artificial Sequence; Note = Synthetic Construct
tctttgccttcgtttatcttgcctgctcattttttaatatattcttcaaataaatcacattactttataaaagtagtttctcagaatgcttctgagtagttttttatgtgaagatatttccttttccacaataggccttgcaatgngngcattcaactcacaagagttgaacctatcttttgattgaagattttgaatctttctttttattcttcgaagaaatcacattactttatataatgtataattcattatgtgataatgccaatcgctaagtctatttaatctgcttttcttggctaataaaaatatatgtaaagtacccttttttgttgaaaatttttaataatttgggaatttactctggggttatttatttttatggtttggatttggattttagaaagtaaataatcccccgggctgcaggaattcttctgtgtaatttttatctgaagatatttccttttccaccataggaca

SEQ ID NO: 53 - DNA, 2056 bp, Artificial Sequence
  Description of Artificial Sequence; Note = Synthetic Construct
attctgagaaacttctttgtgtcgtgtgcattcaactcacagagttgaacatatgtcctctttgagcagttttgcgtctctctttttgtagaatgtacaagtggatatttggagcccattgtgtcctatggtggaaaaggaaatatcttcagataaaaattacacagaagcattctgagatacttctttttgatgtttgcattcatctcacagtgttgaaactttcttttgattgagcagttttgaaacactctttttgtagaatctgcaagtgaataattggagccctttgagggctatggtagaaaaggaaatatcttcaaataagaactacaaagaacattctcagaaacttatttgtgatgtgtgcattcaactcacagggctgaacatatcttttgatttagcagttttgaatttctcttttggcagaatctgcaaggggatgtttggagagctttcaggcatattgtggaaagggaaatattttcacataaaaactacacagaacattctgagaaacttcttagtgatgtgtgcattcgtctcacagagttgaaactttcctttgattgagcagttttgaaacactctttttgtagaatctgcaactggatatttggagccctttgaggaatattgtggaaaaggaaatatcttcacataaaaactacacagaagcattctgagaaacttctttatgaggagtccattcaacccacagagttaaacttttcttctcattgagcagttttgaatctctctatttgtagaatcttgcaagtggatatttgctgcctttgaggcatactgaggaaaagcaaatatcttcatataaaaactacacagaagcattctgagaaacttctttgtgatatgtgcatttatctcacaggtttgaacctaccgttttattgagcagttttgaaacactgtttttgtagaatctgcaagtggatatttagagggaattgaggcctaccgtggaaaagcatatacctacaaacaaaaactaaacagaagcattctgagaaacttcttagtgatgtgtgcattcgtctcacagagttgaaactttcctttgattgagcagttttgaaacactctttttgtagaatctgcaactggatatttggagccctttgaggaatattgtggaaaaggaaatatcttcacataaaaactacacagaagcattctgagaaacttctttatgaggagtccattcaacccacagagttaaacttttcttctcattgagcagttttgaatctctctatttgtagaatctgcaagtggatatttgctgcctttgaggcatactgaggaaaagcaaatatcttcatataaaaactacacagaagcattctgagaaacttctttgtgatatgtgcatttatctcacaggtttgaacctaccgttttattgagcagttttgaaacactgtttttgtagaatctgcaagtggatatttagagggaattgaggcctaccgtggaaaagcatatacctacaaacaaaaactaaacagaagcattctgagaaacttctttgtgtcgtgtgcattcaactcacagagttgaacatatgtcctctttgagcagttttgcgtctctctttttgtagaatgtacaagtggatatttggagcccattgtgtcctatggtggaaaaggaaatatcttcagataaaaattacacagaagcattctcagaaacttatttgtgatgtgtgcattcaactcacagggctgaacatatcttttgatttagcagttttgaatttctctttggcagaatctgcaaggggatgtttggagagctttagagggaattgaggcctaccgtggaaaagcatatacctacaaacaaaaactaaacagaagcattctgagaaacttctttgtgatatgtgcatttatctcacaggtttgaacctaccgttttattgagcagttttgaaacactgtttttgtagaatctgcaagtggatatttagagggaattgaggcctaccgtggaaaagcatatacctacaacaaaaactaaacagaag

SEQ ID NO: 54 - DNA, 2723 bp, Artificial Sequence
  Description of Artificial Sequence; Note = Synthetic Construct
cattctgagaaacttctttgtgtcgtgtgcattcaactcacagagttgaacatatgtcctctttgagcagttttgcgtctctctttttgtagaatgtacaagtggatatttggagcccattgtgtcctatggtggaaaaggaaatatcttcagataaaaattacacagaagcattctcagaaacttatttgtgatgtggcattcaactccagggctgaacatatcttttgatttagcagttttgaatttctcttttggcagaatctgcaaggggatgtttggagagctttcaggcatattgtggaaagggaaatattttcacataaaaactacacagaatctgagatacttctttttgatgtttgcattcatctcacagtgttgaaactttcttttgattgagcagttttgaaacactctttttgtagaatctgcaagtgaataattggagccctttgagggctatggtagaaaaggaaatatcttcaaataagaactacaaagaacattctgagaaacttctttgtgtcgtgtgcattcaactcacagagttgaacatatgtcctctttgagcagttttgcgtctctctttttgtagaatgtacaagtggatatttggagcccattgtgtcctatggtggaaaaggaaatatcttcagataaaaattacacagaagcattctgagatacttctttttgatgtttgcattcatctcacagtgttgaaactttcttttgattgagcagttttgaaacactctttttgtagaatctgcaagtgaataattggagccctttgagggctatggtagaaaaggaaatatcttcaaataagaactacaaagaacattctcagaaacttatttgtgatgtgtgcattcaactcacagggctgaacatatcttttgatttagcagttttgaatttctcttttggcagaatctgcaaggggatgtttggagagctttcaggcatattgtggaaagggaaatattttcacataaaaactacacagaacattctgagaaacttcttagtgatgtgtgcattcgtctcacagagttgaaactttcctttgattgagcagttttgaaacactctttttgtagaatctgcaactggatatttggagccctttgaggaatattgtggaaaaggaaatatcttcacataaaaactacacagaagcattctgagaaacttctttatgaggagtccattcaacccacagagttaaacttttcttctcattgagcagttttgaatctctctatttgtagaatcttgcaagtggatatttgctgcctttgaggcatactgaggaaaagcaaatatcttcatataaaaactacacagaagcattctgagaaacttctttgtgatatgtgcatttatctcacaggtttgaacctaccgttttattgagcagttttgaaacactgtttttgtagaatctgcaagtggatatttagagggaattgaggcctaccgtggaaaagcatatacctacaaacaaaaactaaacagaagcattctgagaaacttcttagtgatgtgtgcattcgtctcacagagttgaaactttcctttgattgagcagttttgaaacactctttttgtagaatctgcaactggatatttggagccctttgaggaatattgtggaaaaggaaatatcttcacataaaaactacacagaagcattctgagaaacttctttatgaggagtccattcaacccacagagttaaacttttcttctcattgagcagttttgaatctctctatttgtagaatctgcaagtggatatttgctgcctttgaggcatactgaggaaaagcaaatatcttcatataaaaactacacagaagcattctgagaaacttctttgtgatatgtgcatttatctcacaggtttgaacctaccgttttattgagcagttttgaaacactgtttttgtagaatctgcaagtggatatttagagggaattgaggcctaccgtggaaaagcatatacctacaaacaaaaactaaacagaagcattctgagaaacttctttgtgtcgtgtgcattcaactcacagagttgaacatatgtcctctttgagcagttttgcgtctctctttttgtagaatgtacaagtggatatttggagcccattgtgtcctatggtggaaaaggaaatatcttcagataaaaattacacagaagcattctcagaaacttatttgtgatgtgtgcattcaactcacagggctgaacatatcttttgatttagcagttttgaatttctctttggcagaatctgcaaggggatgtttggagagctttcaggcatattgtggaaagggaaatattttcacataaaaactacacagacattctgagaaacttctttgtgtcgtgtgcattcaactcagagagttgaacatatgtcctctttgagcagttttgcgtctctctttttgtagaatgtacaagtggatatttggagcccattgtgtcctatggtggaaaaggaaatatcttcagataaaaattacacagaagcattctgagaaacttcttagtgatgtgtgcattcgtctcacagagttgaaactttcctttgattgagcagttttgaaacactctttttgtagaatctgcaactggatatttggagccctttgaggaatattgtggaaaaggaaatatcttcacataaaaactacacagaag